(19) United States
(12) Patent Application Publication
(10) Pub. No.: US 2026/0356264 A1
(43) Pub. Date: Nov. 12, 2026

(54) SEAT BACK FRAME

(71) Applicant: TS TECH CO., LTD., Asaka-shi, Saitama (JP)

(72) Inventors: Takayuki INOSE, Shioya-gun, Tochigi (JP); Takahiro INABA, Shioya-gun, Tochigi (JP); Shuhei WAKAYAMA, Shioya-gun, Tochigi (JP); Naomichi FUKUDA, Shioya-gun, Tochigi (JP)

(21) Appl. No.: 19/111,874

(22) PCT Filed: Nov. 22, 2023
(86) PCT No.: PCT/JP2023/041927

§ 371 Date: Mar. 14, 2025

Related U.S. Application Data
(60) Provisional application No. 63/386,578, filed on Dec. 8, 2022.
(60) Provisional application No. 63/476,451, filed on Dec. 21, 2022.
(60) Provisional application No. 63/477,011, filed on Dec. 23, 2022.

(30) Foreign Application Priority Data
Feb. 27, 2023 (JP) 2023-027957
Mar. 20, 2023 (JP) 2023-044255
Mar. 27, 2023 (JP) 2023-027886
Mar. 31, 2023 (JP) 2023-057246

(51) Int. Cl. B60N 2/68; B60R 22/34

(52) U.S. Cl. CPC B60N 2/688; B60R 22/34

(57) ABSTRACT

Please replace the abstract on the last page of the specification with the following replacement abstract.

A seat back frame includes a first belt guide and a second belt guide. A seat belt reeled out from a seat belt retractor is inserted through the first belt guide. The seat belt reeled out from the seat belt retractor is inserted through the second belt guide which is separate from the first belt guide.

### CROSS-REFERENCE TO RELATED APPLICATIONS

This application is the U.S. National Stage entry of International Application No. PCT/JP2023/041927, filed on Nov. 22, 2023, which, in turn, claims priority to U.S. Patent Application No. 63/386,578, filed on Dec. 8, 2022; U.S. Patent Application No. 63/476,451, filed on Dec. 21, 2022; U.S. Patent Application No. 63/477,011, filed on Dec. 23, 2022; JP Patent Application No. 2023-027957, filed on Feb. 27, 2023; JP Patent Application No. 2023-027886, filed on Feb. 27, 2023; JP Patent Application No. 2023-044255, filed on Mar. 20, 2023; and JP Patent Application No. 2023-057246, filed on Mar. 31, 2023, all of which are hereby incorporated herein by reference in their entireties for all purposes.

### TECHNICAL FIELD

The present invention relates to a seat back frame.

### BACKGROUND ART

According to JP 2018-184037, a guide wire that guides a seat belt is provided in an upper center of a pipe frame constituting a seat back frame of a vehicle seat. The guide wire passes through from below a seat belt which is reeled out from a belt winding mechanism provided below the guide wire. The guide wire guides the seat belt so as to fold it downward and forward (see Patent Document 1).

In addition, in JP 2017-226376, a seat back frame is composed of a panel frame and a pipe frame, and a seat belt is passed through a gap between an upper part of the pipe frame and the panel frame (see Patent Document 2).

### CITATION LIST

### Patent Literature

Patent Document 1: JP 2018-184037

Patent Document 2: JP 2017-226376

### SUMMARY OF INVENTION

### Technical Problem

The seat back frame of Patent Document 1 supports the seat belt with the guide wire. This made it difficult to ensure sufficient support strength against a large load applied by the seat belt.

Moreover, the seat back frame according to Patent Document 2 includes a structure in which a seat belt is passed through a gap between a pipe frame and a panel frame. Therefore, to prevent the seat belt from directly sliding against the pipe frame and the panel frame, the seat back required resin protective parts on both the pipe frame side and the panel frame side. This caused a problem of complexity of the structure supporting the seat belt.

The present invention has been made in view of the above situations, and an object of the present invention is to support with high rigidity a seat belt using a simple structure.

### Solution to Problem

In order to solve the above problems, the invention described in claim 1 provides a seat back frame, including:
a first belt guide through which a seat belt reeled out from a seat belt retractor is inserted; and
a second belt guide which is separate from the first belt guide, and through which the seat belt reeled out from the seat belt retractor is inserted.

The invention described in claim 2 is the seat back frame according to claim 1,
further including a pipe frame,
wherein the first belt guide and the second belt guide are attached along a pipe peripheral surface of the pipe frame.

The invention described in claim 3 is the seat back frame according to claim 2, wherein,
the first belt guide and the second belt guide are both made of a U-shaped wire,
the first belt guide and the second belt guide are both attached such that one end and the other end of the wire are attached along a pipe peripheral surface of the pipe frame, and
in a case that one side of the seat back frame is to be front and the other side is to be rear, an insertion part of the seat belt of the first belt guide extends to a front side than a center of the seat belt retractor, and the insertion part of the seat belt of the second belt guide does not extend to the front side than the center of the seat belt retractor.

The invention described in claim 4 is the seat back frame according to claim 2, wherein,
the first belt guide and the second belt guide are both made of a U-shaped wire,
in a case that one side of the seat back frame is to be front and the other side is to be rear, the first belt guide and the second belt guide are both attached such that one end and the other end of the wire are attached along a pipe peripheral surface of the pipe frame, and
an end of the first belt guide on a side of the insertion part of the seat belt extends to a front side from an upper part of the pipe peripheral surface of the pipe frame, and an end of the second belt guide on the side of the insertion part of the seat belt extends to a front side from a lower part of the pipe peripheral surface of the pipe frame.

The invention described in claim 5 is the seat back frame according to claim 4, wherein the first belt guide and the second belt guide are made of members having the same shape.

The invention described in claim 6 is the seat back frame according to claim 2, wherein,
the pipe frame is provided along an outer edge of the seat back frame,
connecting member is disposed along an up-down direction on an inner side of the pipe frame, and
the connecting member is bent so as to bypass the first belt guide or the second belt guide, and an upper end of the connecting member is connected to the pipe frame.

The invention described in claim 7 is the seat back frame according to claim 2, wherein the first belt guide and the second belt guide are formed as a single integrated member.

The invention described in claim 8 is the seat back frame according to claim 2,
further including a panel frame joined to the pipe frame,
wherein the panel frame includes an evacuation part to avoid the first belt guide and the second belt guide with respect to a mounting part of the first belt guide and the second belt guide in the pipe frame.

### Advantageous Effects of Invention

The invention described in claim 1 includes the first belt guide and the second belt guide through which the seat belt reeled out from the seat belt retractor is inserted. Therefore, even if a large load is applied to the seat belt, the load applied from the seat belt can be distributed to the first belt guide and the second belt guide, making it possible to improve the support strength with a simple configuration.

According to the invention described in claim 2, the first belt guide and the second belt guide are attached along the pipe peripheral surface of the pipe frame, so that a wide mounting surface area can be secured and the mounting strength can be improved. Furthermore, by attaching each belt guide along the pipe peripheral surface, when the load is applied to each belt guide in a specific direction, the force is more likely to be applied to the mounting surface with the pipe frame in a direction along the peripheral surface of the mounting surface, rather than in a direction that would cause the mounting surface to peel off. Therefore, each belt guide is less likely to come off the pipe frame, and strength against the load can be improved.

According to the invention described in claim 3, the insertion parts of the first belt guide and the second belt guide are located on the front and rear sides with respect to the center of the seat belt retractor. Therefore, when the seat belt is reeled out from the seat belt retractor to the front side of the seat back frame through the second belt guide and the first belt guide, each belt guide can guide the seat belt satisfactorily.

In addition, when a load is applied from the seat belt to the insertion part of the first belt guide and the insertion part of the second belt guide, it is possible to prevent the load applied to each belt guide from becoming uneven and to appropriately distribute the load. Therefore, it is possible to improve the strength against the load.

Furthermore, since the second belt guide is located rearward of the center of the seat belt retractor, when a large load is applied to the seat belt, the load that would cause the seat belt retractor to separate from its mounting position through the seat belt can be reduced. Therefore, the mounting strength of the seat belt retractor B can be improved.

In the invention described in claim 4, the end of the first belt guide on the side of the seat belt insertion part extends to the front side from the upper part of the pipe peripheral surface of the pipe frame, and the end of the second belt guide on the side of the seat belt insertion part extends to the front side from the lower part of the pipe peripheral surface of the pipe frame.

As a result, when a load is applied to the seat belt, the force applied to each belt guide is less likely to occur in a direction that would encourage peeling off from the pipe peripheral surface of the pipe frame, but can be directed in a direction along the pipe peripheral surface, thereby improving strength against the load.

In the invention as recited in claim 5, since the first belt guide and the second belt guide are made of members having the same shape, it is possible to simplify manufacturing and reduce manufacturing costs by standardizing the parts.

In the invention described in claim 6, the pipe frame is provided along the outer edge of the seat back frame, and a connecting member arranged on the inner side of the pipe frame is bent so as to bypass the first belt guide or the second belt guide, and its upper end is connected to the pipe frame. Therefore, it is possible to properly secure the attachment position of the first belt guide or the second belt guide. Furthermore, regardless of the location of the first belt guide or the second belt guide, the connecting member can be disposed on the inner side of the pipe frame. This makes it possible to improve the strength of the frame.

In the invention described in claim 7, the first belt guide and the second belt guide are formed as the single integrated member. This makes it possible to reduce the number of parts, reduce manufacturing costs, and reduce weight, etc.

In the invention described in claim 8, the panel frame includes the evacuation part for the mounting parts of the first belt guide and the second belt guide on the pipe frame. This makes it possible to avoid interference between each belt guide and the panel frame. In addition, since the panel frame is made of the panel material, it is easy to form the evacuation part due to unevenness, it is easy to secure the mounting parts for each belt guide, and it is also possible to increase the freedom in arranging the mounting parts.

### BRIEF DESCRIPTION OF DRAWINGS

FIG. 1 This is a front view of a seat back frame according to a first embodiment.

FIG. 2 This is a rear view of the seat back frame.

FIG. 3 This is a perspective view of the seat back frame.

FIG. 4 This is a partial perspective view of the upper center of the seat back frame.

FIG. 5 This is an enlarged front view of the upper center part of the seat back frame.

FIG. 6 This is a cross-sectional view taken along line A-A of the seat back frame in FIG. 1.

FIG. 7 This is a front view of the seat back frame according to a second embodiment.

FIG. 8 This is a perspective view of a belt guide according to a third embodiment.

FIG. 9 This is a front view of the seat back frame according to a fourth embodiment.

FIG. 10 This is a front view of the seat back frame according to a fifth embodiment.

FIG. 11 This is a front view of the seat back frame according to a sixth embodiment.

FIG. 12 This is a front view of the seat back frame according to a seventh embodiment.

FIG. 13 This is a front view of the seat back frame according to an eighth embodiment.

FIG. 14 This is a perspective view of an outer appearance of a vehicle seat and a striker according to the present embodiment.

FIG. 15 This is a perspective view of a lock unit and the striker.

FIG. 16 This is a front view of the striker.

FIG. 17A This is a diagram showing how the striker deforms.

FIG. 17B This is a diagram showing how the striker deforms.

FIG. 17C This is a diagram showing how the striker deforms.

FIG. 18A This is a front view showing the striker of modification example 1.

FIG. 18B This is a view of the striker of the modification example 1 as seen from a right side of the vehicle seat.

FIG. 19A This is a front view showing the striker of modification example 2.

FIG. 19B This is a view of the striker of the modification example 2 as seen from a right side of the vehicle seat.

FIG. 20 This is a perspective view of a wheeled vehicle seat including an ottoman related to an embodiment of the wheeled vehicle seat.

FIG. 21 This is a perspective view of the wheeled vehicle seat including an armrest related to the embodiment of the wheeled vehicle seat.

FIG. 22 This is a perspective view of the wheeled vehicle seat including side support related to the embodiment of the wheeled vehicle seat.

FIG. 23 This is a side view of the wheeled vehicle seat shown in FIG. 20.

FIG. 24 This is a diagram showing a seat frame of the wheeled vehicle seat.

FIG. 25 This is a perspective view of first and second members.

FIG. 26 This is a schematic diagram of a lock mechanism.

FIG. 27 This is a front view of the wheeled vehicle seat shown in FIG. 20.

FIG. 28 This is a front view of the wheeled vehicle seat shown in FIG. 21.

FIG. 29 This is a front view of the wheeled vehicle Seat shown in FIG. 22.

FIG. 30 This is a front view of the wheeled vehicle seat shown in FIG. 21.

FIG. 31A This is a schematic diagram of the lock mechanism and indicator in an unlocked state.

FIG. 31B This is a schematic diagram of the lock mechanism and indicator in a locked state.

FIG. 32 This is a diagram showing an arrangement structure of a connecting member.

FIG. 33 This is a cross-sectional view at a cross-section line XIV-XIV shown in FIG. 32.

FIG. 34 This is a cross-sectional view at a cross-section line XV-XV shown in FIG. 32.

FIG. 35 This is a diagram showing another example of the seat frame of the wheeled vehicle seat.

FIG. 36 This is a cross-sectional view at the cross-section line XVII-XVII shown in FIG. 35.

FIG. 37 This is a diagram showing the arrangement structure of the connecting member.

FIG. 38 This is a cross-sectional view at the cross-section line XIX-XIX shown in FIG. 37.

FIG. 39 This is a cross-sectional view at the cross-section line XX-XX shown in FIG. 37.

FIG. 40 This is a view of the wheeled vehicle seat including a mounting part cover seen from above.

FIG. 41A This is an example showing the first or second member.

FIG. 41B This is an example showing the first or second member.

FIG. 41C This is an example showing the first or second member.

FIG. 41D This is an example showing the first or second member.

FIG. 42A This shows an example of the mounting part cover.

FIG. 42B This shows an example of the mounting part cover.

FIG. 42C This shows an example of the mounting part cover.

FIG. 42D This shows an example of the mounting part cover.

FIG. 43 This is a diagram showing an instrument panel including the indicator.

FIG. 44 This is a front view of a first wheeled vehicle seat and a second wheeled vehicle seat.

FIG. 45 This is a front view of the wheeled vehicle seat in an ottoman specification mode.

FIG. 46 This is a side view of the wheeled vehicle seat in an armrest specification mode.

FIG. 47A This is a diagram showing an example of the lock mechanism in the unlocked state and the indicator.

FIG. 47B This is a diagram showing an example of the lock mechanism in the locked state and the indicator.

FIG. 48 This is a perspective view showing a vehicle seat equipped with an armrest.

FIG. 49 This is a perspective view showing the vehicle seat with the armrest deployed.

FIG. 50 This is a perspective view showing a seat back frame and an armrest frame.

FIG. 51 This is an enlarged perspective view showing a periphery of left and right armrest brackets.

FIG. 52 This is an enlarged perspective view that explains positions of deformation parts formed on the left and right armrest brackets.

### DESCRIPTION OF EMBODIMENTS

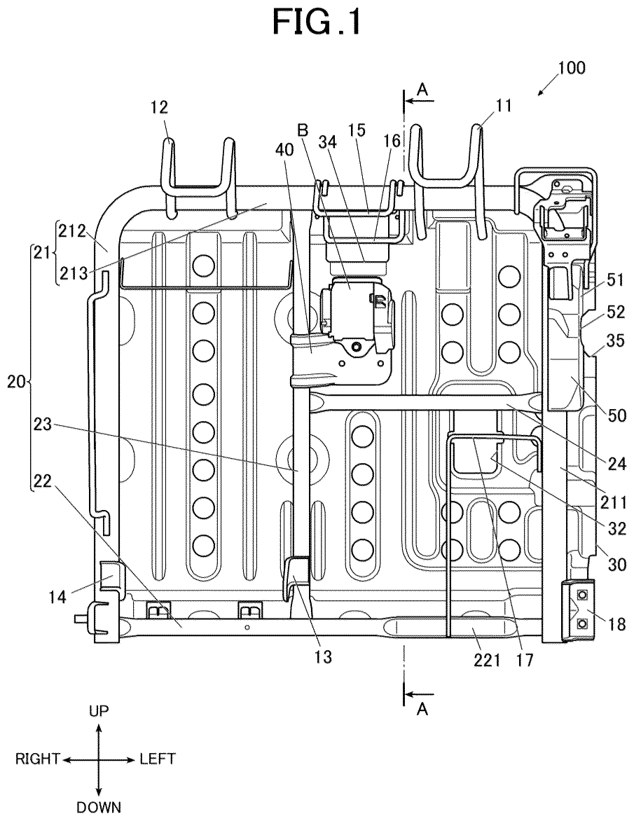

### Embodiments Related to Seat Back Frame

[First Embodiment] An embodiment of a seat back frame will be described with reference to FIG. 1 to FIG. 6.

Various limitations that are technically preferable to implement the present invention are added to the embodiments described below. However, the scope of the present invention is not limited to the embodiments and the illustrated examples described below.

This embodiment is a seat back frame applied to a backrest of a bench seat for a vehicle.

Vehicles equipped with the bench seat to which the seat back frame described below can be applied include any vehicle in which humans board and travel, such as ships, aircrafts, wheeled vehicles, etc., but this embodiment illustrates the application of the seat back frame to the bench seat in a wheeled vehicle, particularly an automobile.

For example, the bench seat for the automobile includes a seat cushion that serves as a seating portion, a seat back that serves as the backrest, and a headrest.

For example, in the case of a three-seater bench seat, the seat back includes a left side seat back including the seat back of a center seat and a left side seat, and the seat back for a right side seat.

Each seat back includes the seat back frame that serves as a skeleton, a padding material including a cushioning material, and a covering material including fabric or the like that covers these.

The following embodiments will be described with reference to the seat back frame used for the left side seat back.

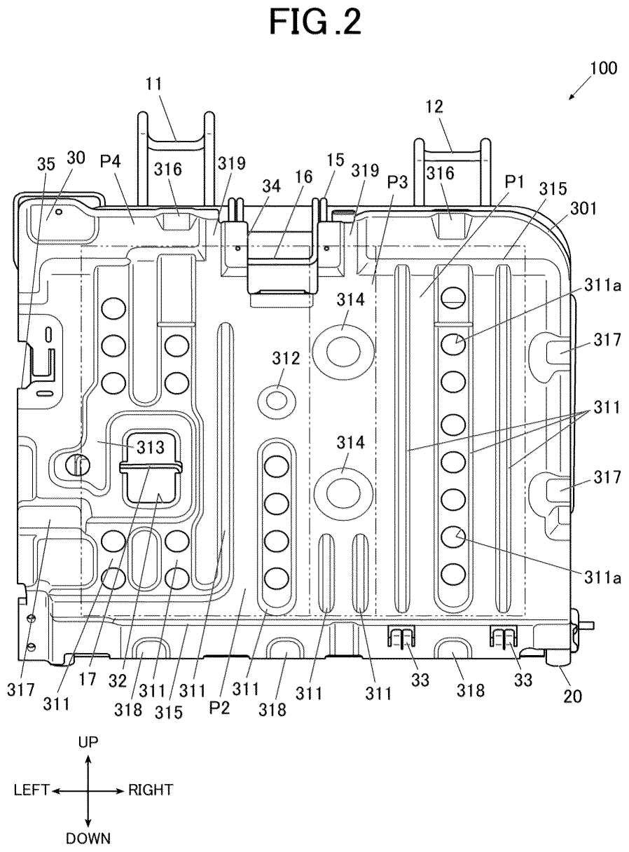

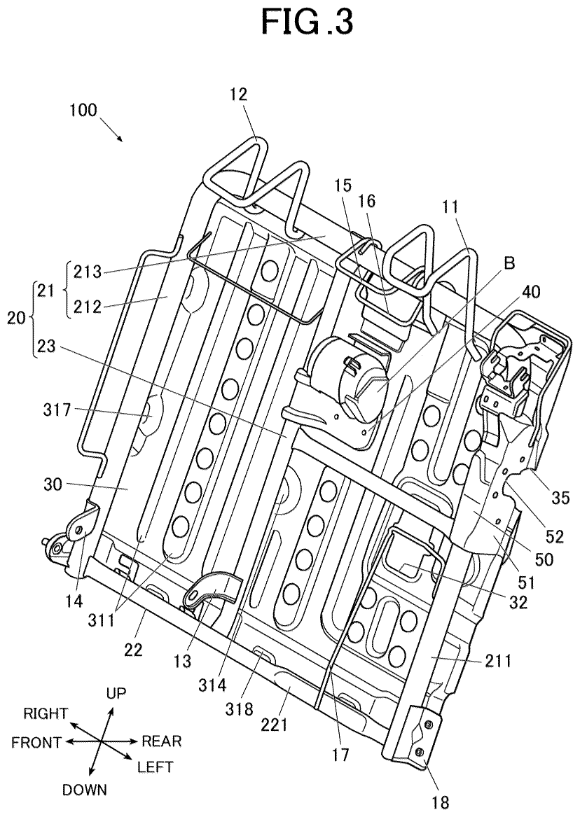

FIG. 1 is a front view of a seat back frame 100 according to the first embodiment, FIG. 2 is a rear view, and FIG. 3 is a perspective view.

In each of the drawings shown in this embodiment, the up, down, left, right, front and rear directions refer to directions in a state attached to the wheeled vehicle. Hereinafter, each part of the seat back frame 100 will be described based on the direction in the above-mentioned mounted state. In FIG. 1, a front side of a page indicates “front” a rear side indicates “rear.” When facing forward, the left hand side is “left” and the right hand side is “right.”

Furthermore, strictly speaking, each seat back frame 100 is attached to the wheeled vehicle with its upper end tilted slightly rearward, but unless otherwise specified, for the convenience of explanation, a plate surface of each seat back frame 100 will be assumed to be along an up-down direction and a left-right direction.

The seat back frame 100 mainly includes a pipe frame 20, a panel frame 30 as a back panel which is a plate-shaped member, a support bracket 40 for a seat belt retractor B, a mounting bracket 50 for a locking device, headrest frames 11 and 12, armrest brackets 13 and 14, a first belt guide 15, a second belt guide 16, a tether member 17, and a set bracket 18.

[Pipe Frame] The pipe frame 20 includes first to fourth pipe members 21 to 24.

The first pipe member 21 includes a left frame part 211, a right frame part 212 and an upper frame part 213. The first pipe member 21 is formed by bending a single pipe material into the left frame part 211, the right frame part 212, and the upper frame part 213. This reduces the number of parts, simplifies a manufacturing process of the pipe frame 20, and reduces costs.

The left frame part 211 and the right frame part 212 are disposed at a left end and a right end of the seat back frame 100, respectively. The left frame part 211 and the right frame part 212 are both oriented parallel to the up-down direction.

The upper frame part 213 connects the upper end of the left frame part 211 and the upper end of the right frame part 212. The upper frame part 213 is disposed at the upper end of the seat back frame 100 and oriented parallel to the left-right direction.

The left frame part 211, the right frame part 212 and the upper frame part 213 each have a circular cross section and are formed by bending a single metal pipe such as a steel pipe into an approximate U-shape. This makes it lighter in weight, easier to manufacture, and less expensive.

In addition, among the first to fourth f pipe members 21 to 24, the second to fourth pipe members 22 to 24 are made of metal pipes having a same outer diameter, and the first pipe member 21 is made of a metal pipe having a larger outer diameter than the second to fourth pipe members 22 to 24.

The first pipe member 21 is located at the upper end and both left and right ends of the seat back frame 100. The lower end of the seat back frame 100 is supported by the vehicle body of the automobile. Therefore, the seat back frame 100 maintains high rigidity throughout the entire seat back frame 100 by disposing the first pipe member 21 with higher rigidity at the upper end, which is separated from the lower end supported by the vehicle body, and both left and right ends.

In addition, since the first pipe member 21 is disposed so as to surround the entire plane of the seat back frame 100, the rigidity of the entire plane of the seat back frame 100 is also increased.

The second pipe member 22 has a circular cross section and is made of a straight metal pipe such as a steel pipe.

The second pipe member 22 is disposed at the lower end of the seat back frame 100 and oriented parallel to the left-right direction. The second pipe member 22 corresponds to a lower frame.

The second pipe member 22 has its left and right ends joined to the lower end of the left frame part 211 and the lower end of the right frame part 212 in the first pipe member 21. As a result, the first pipe member 21 and the second pipe member 22 form a rectangular shape frame that fits along the outer edge of the seat back frame 100.

The second pipe member 22 has both left and right ends compressed and flattened. Correspondingly, the lower ends of the left frame part 211 and the right frame part 212 are also processed so that the rear portions of the pipe peripheral surfaces, which are the outer peripheral surfaces of each of the above, are flat. The second pipe member 22 is joined to the left frame part 211 and the right frame part 212 by welding at their flat surfaces.

In this manner, the first pipe member 21 and the second pipe member 22 are joined with high strength by joining their flat surfaces together.

In the following description, the term “join” refers to joining by welding, and more preferably by laser welding. However, the present invention is not limited to laser welding, and other welding methods including resistance welding such as spot welding, and arc welding may be used, and joining methods other than welding may also be used.

In addition, a portion of the second pipe member 22 between the middle part in the left-right direction and the left end is compressed to form a flat part 221. The flat part 221 is in a flat surface shape and extends in the front-rear and left-right directions. The lower end of the tether member 17, which will be described later, is joined to the front surface of the flat part 221.

The third pipe member 23 has a circular cross section and is made of a straight metal pipe such as a steel pipe. The third pipe member 23 is disposed on the inner side of the pipe frame 20 along the up-down direction.

The upper end of the third pipe member 23 is joined to the upper frame part 213 of the first pipe member 21. The lower end of the third pipe member 23 is joined to the second pipe member 22. The third pipe member 23 corresponds to a connecting member that connects a middle part of the upper frame part 213 and a middle part of the second pipe member 22 serving as a lower frame part.

The third pipe member 23 has both upper and lower ends compressed and flattened. In contrast, a joint site of the upper frame part 213 with the third pipe member 23 is also processed so that the rear portion of the pipe peripheral surface, which is the outer peripheral surface, is flat. Similarly, the joint site of the second pipe member 22 with the third pipe member 23 is also processed so that the rear portion of the pipe peripheral surface, which is the outer peripheral surface, is flat.

As a result, the third pipe member 23 is joined to the first pipe member 21 and the second pipe member 22 with high strength by joining flat surfaces together.

The third pipe member 23 is fixed on the inner side of the pipe frame 20 in a state along the up-down direction. This makes it possible to provide rigidity to the seat back frame 100 in the inner region of the pipe frame 20 against bending stress about an axis in the left-right direction.

In addition, deflection that causes a gap between the upper frame part 213 and the second pipe member 22 in the pipe frame 20 to expand or contract can be suppressed.

The fourth pipe member 24 has a circular cross section and is made of a straight metal pipe such as a steel pipe.

The fourth pipe member 24 is disposed between the left frame part 211 of the first pipe member 21 and the third pipe member 23 and oriented parallel to the left-right direction.

The left end of the fourth pipe member 24 is joined to the middle part of the left frame part 211 in the up-down direction. The right end of the fourth pipe member 24 is joined to the middle part of the third pipe member 23 in the up-down direction. The fourth pipe member 24 corresponds to a cross member that crosses between the connecting member and either the left or right frame (side frame) and connects their respective middle parts.

The fourth pipe member 24 has both left and right ends compressed and flattened. In contrast, the joint site of the left frame part 211 with the fourth pipe member 24 is also processed so that the rear portion of the pipe peripheral surface, which is the outer peripheral surface, is flat. Similarly, the joint site of the third pipe member 23 with the fourth pipe member 24 is also processed so that the rear portion of the pipe peripheral surface, which is the outer peripheral surface, is flat.

As a result, the fourth pipe member 24 is joined to the first pipe member 21 and the third pipe member 23 with high strength by joining flat surfaces together.

The fourth pipe member 24 is fixed on the inner side of the pipe frame 20 to the left side of the third pipe member 23 and in a state along the left-right direction. This makes it possible to provide rigidity to the seat back frame 100 in the left side region of the third pipe member 23 in the inner side of the pipe frame 20 against bending stress about an axis in the up-down direction.

A right side region of the third pipe member 23 on the inner side of the pipe frame 20 has a narrower left-right width than a left side region. Therefore, the upper frame part 213 of the first pipe member 21 and the second pipe member 22 can ensure sufficient rigidity in the right side region against bending stress about the axis in the up-down direction.

On the other hand, the left side region of the pipe frame 20 has a wider left-right width than the right side region. Therefore, high rigidity is ensured by the fourth pipe member 24 in addition to the upper frame part 213 and the second pipe member 22.

In addition, the fourth pipe member 24 can suppress the deflection that causes the gap between the left frame part 211 and the third pipe member 23 in the pipe frame 20 to expand or contract.

[Panel Frame] As shown in FIG. 1 to FIG. 3, the panel frame 30 is disposed on a rear side of the pipe frame 20.

The panel frame 30 is a metal plate made of steel, aluminum alloy, or the like. The panel frame 30 has a generally rectangular plate shape when viewed from the front. The panel frame 30 has approximately the same up-down width and left-right width as the pipe frame 20. Therefore, the panel frame 30 is joined integrally with the pipe frame 20 overlapping with almost no protrusion in the front-rear direction.

As shown in FIG. 2, in the panel frame 30, a low height peripheral wall shaped flange part 301 is formed raised to the front along almost the entire periphery of the outer edge part. It should be noted that a portion of this flange part 301 is removed by a cutout or the like. The flange part 301 provides the panel frame 30 with the rigidity to maintain the entire panel frame 30 in a planar shape.

As shown by the two-dot chain lines in FIG. 2, the flat plate surface of the panel frame 30 can be partitioned into a plurality of regions including a first site P1, a second site P2, a third site P3, and a fourth site P4.

The first site Pl is a region surrounded by the right frame part 212 and the upper frame part 213 of the first pipe member 21, the second pipe member 22, and the third pipe member 23 when the panel frame 30 is viewed from the front. The first site Pl is located behind a seated occupant sitting in the center seat in a state in which the seat back frame 100 is assembled into a three-seater bench seat.

The second site P2 is a region surrounded by the left frame part 211 and the upper frame part 213 of the first pipe member 21, the second pipe member 22, and the third pipe member 23 when the panel frame 30 is viewed from the front. The second site P2 is located behind the seated occupant sitting in the left side seat in a state in which the seat back frame 100 is assembled into the three-seater bench seat.

The third site P3 is a region located behind the third pipe member 23 when the panel frame 30 is viewed from the front.

The fourth site P4 is a site located behind the first pipe member 21 and the second pipe member 22 when the panel frame 30 is viewed from the front. The fourth site P4 corresponds to the entire outer edge of the panel frame 30.

When the rearmost surface of the panel frame 30 is taken as a reference plane, the panel frame 30 includes a plurality of first reinforcing parts 311 within the first to third sites P1 to P3, which are convex parts that bulge forward in a band shape relative to the reference plane. The first reinforcing part 311 is recessed forward when viewed from the rear side.

Among the plurality of first reinforcing parts 311, some have different up-down lengths or different left-right widths, but all are formed in a bead shape along the up-down direction.

By providing the first reinforcing part 311 that bulges forward along the up-down direction in this manner, the panel frame 30 can be provided with high rigidity against bending stress with an axis in the left-right direction perpendicular to a longitudinal direction of the first reinforcing part 311.

In the following description, the term “reinforcing part” refers to a portion or member that has a higher rigidity than a flat plate due to a three-dimensional structure such as a ridge, frame, convex portion, bending part or the like.

Within the first site P1, three first reinforcing parts 311 that are long in the up-down direction are formed side by side in the left-right direction. Of these, the first reinforcing part 311 located in the middle is wider than the first reinforcing parts 311 on both sides. In the first reinforcing part 311 located in the middle, a plurality of circular through holes 311a are formed in the up-down direction and aligned at equal intervals. The plurality of through holes 311a contribute to reducing the weight of the panel frame 30. Furthermore, since each through hole 311a is formed within the plane of a bulging range of the first reinforcing part 311, the first reinforcing part 311 itself reinforces the first reinforcing part 311 so as to prevent a decrease in rigidity due to the through holes 311a.

Within the second site P2, four first reinforcing parts 311 are formed side by side in the left-right direction. The rightmost first reinforcing part 311 is short in height in the up-down direction and is formed below the mounting position of the support bracket 40 of the seat belt retractor B. The first reinforcing part 311 also includes a plurality of through holes 311a formed aligned in the up-down direction. The two first reinforcing parts 311 on the left side are divided into upper and lower portions by an opening 32 which will be described later. Further, each of the two first reinforcing parts 311 also includes the plurality of through holes 311a formed aligned in the up-down direction.

A first joint reinforcing part 312 to which the rear side of the support bracket 40 of the seat belt retractor B is joined is formed on the upper side of the first reinforcing part 311, which is located at the right end within the second site P2 and is positioned at the rightmost position as mentioned above. This first joint reinforcing part 312 is located approximately in the center of the entire plane of the panel frame 30, more precisely, slightly above the center and slightly to the left side of the center, that is, at the left end of the second site P2. In addition, the first joint reinforcing part 312 is located in the up-down direction between two second joint reinforcing parts 314 (described later) that are arranged aligned vertically in the third site P3.

Therefore, the first joint reinforcing part 312 is positioned within the range where rigidity is increased by the two second joint reinforcing parts 314, and the deflection and directional fluctuation of the support bracket 40 of the seat belt retractor B supported by the first joint reinforcing part 312 can be suppressed.

The first joint reinforcing part 312 has a circular shape when viewed from the front and protrudes to the front. The first joint reinforcing part 312 is recessed forward when viewed from the rear side.

The first joint reinforcing part 312 includes a circular flat surface in the center, and this flat surface is located in the most front position. The periphery of the first joint reinforcing part 312 is inclined so that the closer it is to the central flat surface, the greater the forward protrusion amount becomes. The shape of the first joint reinforcing part 312 in a front view is not limited to a circle, and may be a rectangle or a polygon, but a circle is the easiest to process.

The first joint reinforcing part 312 may be formed in a spherical shape. Even in this case, it is preferable to provide the flat surface in the center.

The rear surface of the support bracket 40 of the seat belt retractor B is joined to the central flat surface of the first joint reinforcing part 312.

Since the first joint reinforcing part 312 has an uneven structure relative to the plate surface of the panel frame 30, the rigidity of the first joint reinforcing part 312 and its periphery is high. Therefore, the seat belt retractor B is firmly supported via the support bracket 40. Furthermore, when a load is received from the seat belt B1 through the seat belt retractor B, the first joint reinforcing part 312 can suppress the deflection and deformation around the first joint reinforcing part 312.

The substantially rectangular opening 32 is formed penetrating from front to rear near the left end of the second site P2 and slightly below the middle in the up-down direction. The tether member 17 is provided on the front side of a rim of the opening 32.

The tether member 17 is a member for attaching a child seat to the seat including the seat back frame 100. The tether member 17 includes a rod-shaped portion that can engage with a hook provided on a child seat. The tether member 17 is made of a substantially U-shaped wire having high hardness, and includes a horizontal rod part and a left and right pair of vertical rod parts extending downward from both ends of the horizontal rod part. The left side vertical rod part is shorter in length than the right vertical rod part, and is joined onto the pipe peripheral surface, which is the outer peripheral surface of the left frame part 211 of the first pipe member 21. The right side vertical rod part is long enough to reach the second pipe member 22, and its lower end is joined to the flat part 221 of the second pipe member 22. In addition, the tether member 17 is joined to the front side of the rim of the opening 32, on both the left and right sides of the opening 32.

The tether member 17 is arranged so that the horizontal rod part crosses from left to right the middle part of the opening 32 in the up-down direction in the second site P2 of the panel frame 30 on the front side of the opening 32. That is, the opening 32 is an evacuation hole for preventing the panel frame 30 from interfering with the hook of the child seat when it is engaged.

The opening 32 is located in the middle part of the two first reinforcing parts 311 in the up-down direction so as to divide the two first reinforcing parts 311.

A periphery reinforcing part 313 is formed around the opening 32 and bulges forward so as to surround the opening 32. The periphery reinforcing part 313 is recessed forward when viewed from the rear side.

Therefore, the periphery reinforcing part 313 provides reinforcement so that a decrease in rigidity due to the opening 32 penetrating the plate surface does not occur.

Two first reinforcing parts 311 are formed side by side aligned in the left-right direction at the lower portion of the third site P3.

In addition, on the upper side of the two first reinforcing parts 311 in the third site P3, two second joint reinforcing parts 314 to which the pipe peripheral surface of the third pipe member 23 of the pipe frame 20 is joined are formed aligned one above the other in the up-down direction.

In a plan view, the third pipe member 23 joined to the second joint reinforcing part 314 is disposed so as to pass between the two first reinforcing parts 311. In this case, the forward protruding height of the two first reinforcing parts 311 may be set to the height at which they come into contact with the pipe peripheral surface of the third pipe member 23 and then joined together. This causes the third pipe member 23 to be held between the two first reinforcing parts 311. Therefore, the inclination of the third pipe member 23 is suppressed, and the deflection when a load is applied to the seat back frame 100 can be suppressed.

The upper and lower second joint reinforcing parts 314 both have a circular shape when viewed from the front and protrude to the front. The second joint reinforcing part 314 is recessed forward when viewed from the rear side. Further, each of the second joint reinforcing parts 314 have a larger diameter than the first joint reinforcing parts 312 described above.

Each second joint reinforcing part 314 also includes a circular flat surface in the center, and this flat surface protrudes furthest forward. The periphery of each second joint reinforcing part 314 is inclined so that the closer it is to the central flat surface, the greater the forward protrusion amount becomes. The front view shape of each second joint reinforcing part 314 is not limited to a circular shape, and may be a rectangular or polygonal shape. Additionally, each second joint reinforcing part 314 may also be formed in a spherical shape, but it is preferable to provide a flat surface in the center.

As described above, the central flat surface of each second joint reinforcing part 314 is joined to the rear portion of the pipe peripheral surface at two locations, above and below, of the third pipe member 23. At this time, the joint site at the rear portion of the pipe peripheral surface of the third pipe member 23 may be pressed to form the flat surface. This allows the flat surfaces to be joined together, making it possible to more firmly connect each second joint reinforcing part 314 to the third pipe member 23.

In addition, since the two second joint reinforcing parts 314 are provided in the up-down direction, the third pipe member 23 is held at two locations, above and below. Therefore, the third pipe member 23 can be firmly maintained in the orientation parallel in the up-down direction. As a result, each portion of the pipe frame 20 along the up-down direction or the left-right direction can be effectively prevented from deflecting in the inclined direction.

In addition, each second joint reinforcing part 314 also includes the uneven structure relative to the plate surface of the panel frame 30, thereby increasing the rigidity of each second joint reinforcing part 314 and its peripheries. Therefore, the third pipe member 23 can be firmly supported and the deflection and deformation of the periphery can be suppressed.

The fourth site P4 is a rectangular frame-shaped region surrounding the first to third sites P1 to P3. The plane in the upper part and the plane in the lower part of the fourth site P4 are located forward with respect to the reference plane. For this reason, step reinforcing parts 315 are formed along the left-right direction near the boundary between the upper part of the fourth site P4 and the other sites P1 to P3, and near the boundary between the lower part of the fourth site P4 and the other sites P1 to P3. Since the upper and lower step reinforcing parts 315 are aligned along the left-right direction, the panel frame 30 can be provided with high rigidity against bending stress with the axis in the up-down direction.

Additionally, third joint reinforcing parts 316 are formed on the left and right sides of the upper end of the fourth site P4. The upper end of the fourth site P4 is located forward of the reference plane, but each of the third joint reinforcing parts 316 protrudes further forward therefrom. Additionally, the third joint reinforcing part 316 is recessed forward when viewed from the rear side.

Each third joint reinforcing part 316 has a rectangular shape when viewed from the front and includes an inclined surface that rises diagonally forward and upward from the periphery. The inclined surfaces of each of the third joint reinforcing parts 316 are joined to the pipe peripheral surface, which is the outer peripheral surface of the upper frame part 213 of the first pipe member 21, thereby fixing the first pipe member 21 in place.

Since the third joint reinforcing part 316 has an uneven structure relative to the plate surface of the panel frame 30, the rigidity of the third joint reinforcing part 316 and its periphery is increased. Furthermore, since the third joint reinforcing part 316 has the inclined surface, the vertical movement of the first pipe member 21 can be suppressed.

Additionally, a fourth joint reinforcing part 317 is formed at the lower part of the left end and the upper and lower parts of the right end of the fourth site P4. Each fourth joint reinforcing part 317 protrudes forward. The fourth joint reinforcing part 317 is recessed forward when viewed from the rear side.

The fourth joint reinforcing part 317 includes a generally rectangular flat surface in the center, and the flat surface protrudes furthest forward.

The flat surface of each fourth joint reinforcing part 317 is joined to the pipe peripheral surface, which is the outer peripheral surface of the left frame part 211 or the right frame part 212 of the first pipe member 21. Since the fourth joint reinforcing part 317 has an uneven structure relative to the plate surface of the panel frame 30, the rigidity of the fourth joint reinforcing part 317 and its periphery is increased.

The joint site between the fourth joint reinforcing part 317 and the pipe peripheral surface, which is the outer peripheral surface of the first pipe member 21, may be pressed to form the flat surface. This can increase the mutual joint strength. Accordingly, the mutual deflection of the pipe frame 20 and the panel frame 30 can be suppressed.

Furthermore, fifth joint reinforcing parts 318 are formed in three locations aligned in the left-right direction at the lower end of the fourth site P4. Each of the fifth joint reinforcing parts 318 protrudes forward. The fifth joint reinforcing part 318 is recessed forward when viewed from the rear side.

The fifth joint reinforcing part 318 includes a generally rectangular flat surface in the center, and the flat surface protrudes furthest forward.

The flat surface of each fifth joint reinforcing part 318 is joined to the pipe peripheral surface, which is the outer peripheral surface of the second pipe member 22. Since the fifth joint reinforcing part 318 has an uneven structure relative to the plate surface of the panel frame 30, the rigidity of the fifth joint reinforcing part 318 and its periphery is increased.

The joint site between the fifth joint reinforcing part 318 and the pipe peripheral surface of the second pipe member 22 may be pressed to form the flat surface. This can increase the mutual joint strength. Accordingly, the mutual deflection of the pipe frame 20 and the panel frame 30 can be suppressed.

In addition, in the range directly below the first site P1 at the lower end of the fourth site P4, there are formed undulating connecting parts 33 aligned in two locations in the left-right direction with inverted, roughly U-shaped cutouts, the inner portion of which is raised diagonally upward and forward. Each of the undulating connecting parts 33 has an inclined surface that undulates diagonally upward and forward, joined to the pipe peripheral surface of the second pipe member 22, thereby fixing the second pipe member 22.

A generally rectangular cutout 34 is formed downward from the upper edge at the center in the left-right direction of the upper end of the fourth site P4. The cutout 34 reaches the upper ends of the second site P2 and the third site P3.

The first belt guide 15 and the second belt guide 16 are attached to the upper frame part 213 of the first pipe member 21 in a position in front of this cutout 34.

The approximately rectangular cutout 34 serves as an evacuation part to avoid interference with the upper end of the panel frame 30 when passing the seat belt or a member attached to the seat belt through the first belt guide 15 and the second belt guide 16.

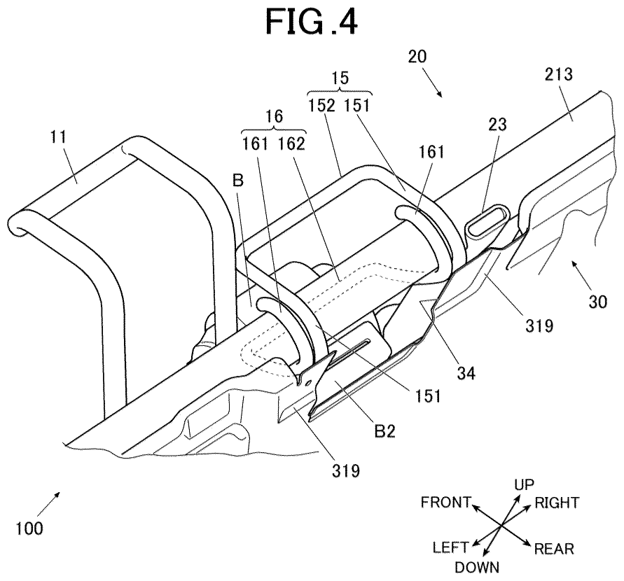

FIG. 4 is a partial perspective view of the upper center of the seat back frame 100.

As described above, the upper plane of the fourth site P4 is located forward relative to the reference plane, and on both the left and right sides of the cutout 34 relative to the upper plane, there are formed second reinforcing parts 319 consisting of convex parts that protrude rearward. The second reinforcing part 319 is recessed rearward when viewed from the front side.

The second reinforcing part 319 maintains high rigidity around the cutout 34 and suppresses a decrease in rigidity due to the cutout 34.

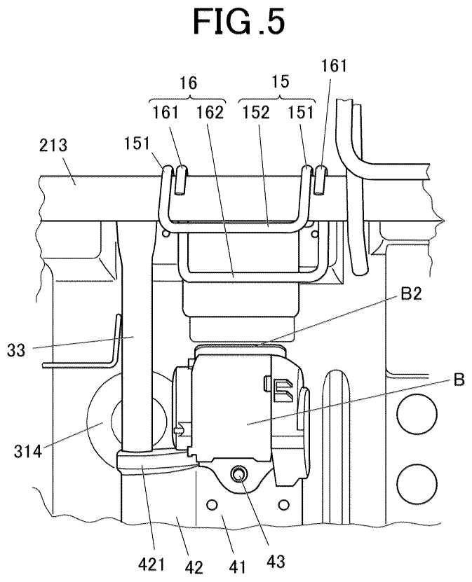

Furthermore, the flat plate surface of the second reinforcing part 319 is located rearward of the upper plane of the fourth site P4. In addition, the cutout 34 and the second reinforcing part 319 are both formed by partially removing the flange part 301 formed on the outer edge part of the panel frame 30. Due to these structures, the flat plate surface of the second reinforcing part 319 is spaced rearward from the pipe peripheral surface of the upper frame part 213 of the first pipe member 21. Furthermore, the second reinforcing part 319 functions as an evacuation part for avoiding interference with the first belt guide 15 and the second belt guide 16 joined to the upper frame part 213 due to its structure spaced rearward.

[Seat Belt Retractor Support Bracket] FIG. 5 is an enlarged front view of the center part of the upper end of the seat back frame 100.

As shown in FIG. 1 to FIG. 5, the support bracket 40 of the seat belt retractor B is provided on the front surface of the panel frame 30 slightly above the center part.

The support bracket 40 is formed by sheet metal processing a metal plate such as a steel or aluminum alloy. The support bracket 40 includes a support part 41 that fixes and supports the seat belt retractor B, and a connecting part 42 that is joined to the third pipe member 23.

The support part 41 is in the shape of a flat plate and an insertion hole for a bolt 43 is formed therein. A head of the bolt 43 is inserted from the rear and fixed to the rear surface side of the support portion 41 by welding. The seat belt retractor B is fixed to the support part 41 by a shaft part of the bolt 43 protruding forward and a nut (not shown).

In addition, the rear surface of the support part 41 is joined to the flat surface of the first joint reinforcing part 312. A gap is formed between the panel frame 30 in a site other than the joint part with the first joint reinforcing part 312 in the support part 41.

The support bracket 40 is located on the left side of the third pipe member 23.

The connecting part 42 extends diagonally forward and to the right from the right end of the support part 41. The extending end of the connecting part 42 embraces the third pipe member 23 so as to wrap around the front side portion of the pipe peripheral surface of the third pipe member 23. The rear surface of the extending end of the connecting part 42 is joined to the third pipe member 23.

Further, at each of the upper and lower ends of the connecting part 42, a bead-shaped reinforcing part 421 is formed which bulges forward along the extending direction. These reinforcing parts 421 can provide high rigidity to the connecting part 42 against bending stress with an axis in the up-down direction perpendicular to the extending direction.

The support bracket 40 not only supports the seat belt retractor B, but also contributes to improving the connection strength between the panel frame 30 and the pipe frame 20 via the connecting part 42. In addition, the connecting part 42 suppresses deflection and tilting of the third pipe member 23, thereby contributing to improving the rigidity of the seat back frame 100.

Furthermore, since the support bracket 40 is supported by the third pipe member 23 via the connecting part 42, it is no longer necessary to support it with a support frame crossing both the left and right ends of the pipe frame 20 as in the conventional case, and the support frame can be omitted. This can eliminate the foreign body sensation which the seated occupant sitting in the bench seat feels due to the existence of the support frame.

In addition, since the first joint reinforcing part 312 that supports the support bracket 40 from behind has a convex structure, it is possible to achieve both support for the support bracket 40 and improved rigidity of the panel frame 30.

The seat belt retractor B is fixed to the support bracket 40 with the cylindrical main body facing horizontally. The seat belt retractor B includes a winding shaft connected to a winding spring inside the main body, and is capable of winding up the seat belt B1. Further, by using the seat belt retractor B, the seat belt B1 can be pulled out from the upper part of the main body, and the winding spring constantly provides tension to the pulled-out seat belt B1, pulling it into the main body. Furthermore, the seat belt retractor B incorporates a blocking mechanism for blocking sudden withdrawal of the seat belt B1.

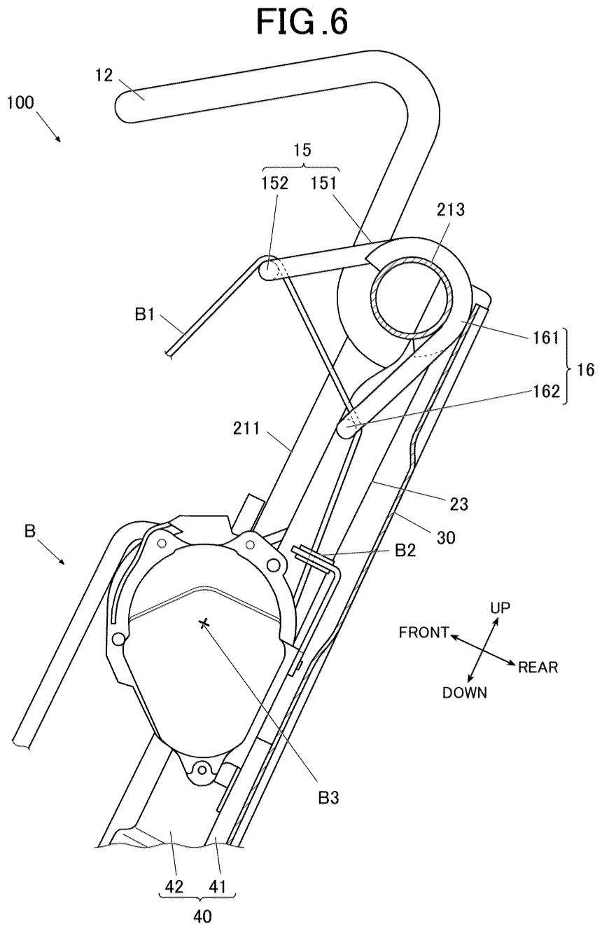

The seat belt retractor B includes a reel-out opening for the seat belt B1 formed in the upper part of its main body, and immediately above the opening, a plate-shaped insertion guide B2 including a slit is provided for the seat belt B1. The insertion guide B2 guides the seat belt B1 reeled out from the reel-out opening of the seat belt retractor B upward.

[First and Second Belt Guides] FIG. 6 is a cross-sectional view taken along line A-A shown in FIG. 1.

As shown in FIG. 4 to FIG. 6, the first belt guide 15 and the second belt guide 16 each pass the seat belt B1 reeled out from the seat belt retractor B and guide it in a predetermined reeling direction.

The first belt guide 15 and the second belt guide 16 are both the same member formed by bending a hard metal wire into the same shape.

The first belt guide 15 and the second belt guide 16 are both attached to the center of the upper frame part 213 of the first pipe member 21 in the left-right direction. As shown in FIG. 5 and FIG. 6, the first belt guide 15 and the second belt guide 16 are arranged so as to substantially coincide with the reel-out opening of the seat belt retractor B in the left-right direction.

The first and second belt guides 15, 16 are made of wires formed in a substantially U-shape.

The first belt guide 15 includes a pair of arm parts 151 formed of one end and the other end of a wire extending in the same direction, and an insertion part 152 connecting the pair of arm parts 151. The insertion part 152 is connected from one arm part 151 to the other arm part 151 and forms a loop portion between them through which the seat belt B1 is inserted.

The second belt guide 16 includes a pair of arm parts 161 formed of one end and the other end of a wire extending in the same direction, and an insertion part 162 connecting the pair of arm parts 161. The insertion part 162 also forms a ring-shaped part between one arm part 161 and the other arm part 161.

A pair of arm parts 151 of the first belt guide 15 and a pair of arm parts 161 of the second belt guide 16 are both curved into concentric arcs. Each of the arm parts 151, 161 is joined to the pipe peripheral surface of the upper frame part 213 of the first pipe member 21 at a middle part in the left-right direction. The inner diameter of each of the arm parts 151, 161 approximately corresponds to the outer diameter of the upper frame part 213. Therefore, the inner periphery of each of the arm parts 151, 161 can abut against the pipe peripheral surface of the upper frame part 213 over a wide range, thereby being firmly joined.

The pair of arm parts 151 of the first belt guide 15 and the pair of arm parts 161 of the second belt guide 16 are joined with a slight offset in the left-right direction so as not to interfere with each other.

The first belt guide 15 is located in the center part of the upper frame part 213 in the left-right direction, with the insertion part 152 side extending forward and slightly downward from the upper part of the pipe peripheral surface of the upper frame part 213.

The second belt guide 16 is located in the center part of the upper frame part 213, with the insertion part 162 side extending forward and downward from the lower part of the pipe peripheral surface of the upper frame part 213. The insertion part 162 of the second belt guide 16 has a greater downward inclination than the insertion part 152 of the first belt guide 15.

As shown in FIG. 6, the extending end of the insertion part 152 of the first belt guide 15 extends forward of a center B3 of the seat belt retractor B.

Further, the extending end of the insertion part 162 of the second belt guide 16 extends forward of the panel frame 30 but does not reach a position forward of the center B3 of the seat belt retractor B.

In addition, the center B3 of the seat belt retractor B indicates the position of a central axis when the seat belt retractor B has a substantially cylindrical outer shape. Further, the position of the center of rotation of the winding shaft of the seat belt B1 may be set as the center B3.

In the case of this embodiment, regardless of which is the center B3, the positional relationship in a front-rear direction between the extending end of the insertion part 152 of the first belt guide 15 and the extending end of the insertion part 162 of the second belt guide 16 described above is established.

When the seat belt retractor B is provided on the seat back frame 100, the seat belt B1 reeled out from the seat belt retractor B must first be guided above a shoulder of the seated occupant and then bend its path so as to be guided diagonally downward and forward.

Since the second belt guide 16 includes the insertion part 162 positioned as described above, it is easy to insert the seat belt B1, which is reeled out upward from the reel-out opening provided at the upper rear end of the seat belt retractor B, from rear to front. The insertion part 162 includes a round rod portion at its tip along the left-right direction, so that the seat belt B1 inserted inside can be guided so as to bend its path forward along the outer peripheral surface of the round rod portion.

The first belt guide 15 also includes a round rod portion at a tip of the insertion part 152 along the left-right direction. Since the insertion part 152 of the first belt guide 15 is disposed as described above, the first belt guide 15 is located above and in front of the insertion part 162 of the second belt guide 16. Therefore, the seat belt B1 guided forward by the insertion part 162 can be guided by the insertion part 152 of the first belt guide 15 so as to bend its path downward along the round rod portion from a position higher than the insertion part 162.

Therefore, the first belt guide 15 and the second belt guide 16 can properly guide the seat belt B1 to the seated occupant.

[Headrest Frame] As shown in FIG. 1 and FIG. 3, the headrest frames 11, 12 are provided on the left side and right side of the upper frame part 213 of the first pipe member 21.

The headrest frames 11, 12 are both formed from metal wire having a relatively large outer diameter. The headrest frames 11, 12 are made of a wire formed in a substantially U-shape, and a pair of rod-shaped portions extending upward are both bent so as to be folded back downward. The headrest frames 11, 12 have their folded rod-shaped portions joined to the front portion of the outer peripheral surface of the upper frame part 213.

The left side headrest frame 11 includes a pair of folded rod-shaped portions each curved rearward near the lower end, and the rear portion above the curved portions is joined to the upper frame part 213. The joint site of the upper frame part 213 with the headrest frame 11 may be processed to be flat so as to fit along the rod-shaped portion of the headrest frame 11.

In a state joined to the upper frame part 213, the lower end of the pair of rod-shaped portions of the headrest frame 11 abut against the front side of the panel frame 30. The lower end of the pair of rod-shaped portions of the headrest frame 11 may be joined to the front surface of the panel frame 30.

The right side headrest frame 12 includes a pair of folded rod-shaped portions, each of whose lower ends is curved rearward in an arc, and the inner side of each of the curved portions formed in the arc is joined to the outer peripheral surface of the upper frame part 213. The inner diameter of the arc-shaped curved portion of the headrest frame 12 is approximately equal to the outer diameter of the upper frame part 213. Therefore, the lower end of the headrest frame 12 can be joined to the outer peripheral surface of the upper frame part 213 over a wide range.

The upper portion of each of the headrest frames 11, 12 is ultimately covered with a padding material made of a cushioning material, which is then covered with a covering material such as fabric. These components constitute the headrest.

Although the headrest frame 11 and the headrest frame 12 have different shapes of the pair of rod-shaped portions, they may have the same shape as either one of them. Further, each headrest frame 11, 12 may be configured to be inserted and attached to a cylindrical supporter joined to the upper frame part 213, rather than being directly joined to the upper frame part 213.

[Armrest Bracket] Each of the armrest brackets 13 and 14 is formed by pressing a single metal plate.

The left side armrest bracket 13 includes a base end joined to the front side of the outer peripheral surface near the lower end of the third pipe member 23, a support arm part extending forward from the base end, and a flange part formed along the outer edges of the base end and the support arm part.

The right side armrest bracket 14 includes a base end joined to the front side of the outer peripheral surface near the lower end of the right frame part 212 of the first pipe member 21, a support arm part extending forward from the base end, and a flange part formed along the outer edges of the base end and the support arm part.

The left and right armrest brackets 13, 14 are each formed at a tip thereof with an armrest support hole at the same position when viewed in the left-right direction. The left and right armrest brackets 13, 14 rotatably support the lower ends of the armrests (not shown) from both the left and right sides.

[Locking Device Mounting Bracket] The mounting bracket 50 supports a locking device (not shown).

The seat back frame 100 includes a lower end supported on the vehicle body so as to be rotatable about an axis extending in the left-right direction. The seat back frame 100 is normally in an upright position and can be tilted forward as required.

The locking device can maintain the seat back frame 100 in a raised state by engaging a striker made of an oval-shaped wire extending rightward from the vehicle body side. In addition, the locking device can switch between engaging and unlocking the striker by external handling.

As shown in FIG. 1 and FIG. 3, the mounting bracket 50 is disposed on the front side of the upper left end of the seat back frame 100. The mounting bracket 50 is joined to the left frame part 211 of the first pipe member 21 of the pipe frame 20 and the front surface of the panel frame 30.

The mounting bracket 50 includes an open cross-sectional structure in which the horizontal cross section is substantially U-shaped, and is joined with the opening side facing toward the front side of the panel frame 30. The mounting bracket 50 is formed by pressing a single metal plate made of steel, aluminum alloy, or the like.

The mounting bracket 50 includes a mounting surface 51 for the locking device on the left side. A cutout 52 is formed in the rear edge of the mounting surface 51 facing forward.

When the seat back frame 100 is rotated rearward to be raised or lowered, a striker provided on the vehicle body side moves relatively forward and is engaged by the locking device. This cutout 52 serves as the evacuation part for the striker that moves relatively forward. A cutout 35 corresponding to the cutout 52 is also formed in the left side edge of the panel frame 30, and this similarly serves as the evacuation part for the striker.

The mounting bracket 50 may be configured to include a flange part including a flat surface facing the front surface of the panel frame 30, and a flange part including a curved surface facing the outer peripheral surface of the left frame part 211. By using these as joint surfaces, the mounting bracket 50 can be joined more firmly to the pipe frame 20 and the panel frame 30.

[Set Bracket] As shown in FIG. 1 and FIG. 3, a set bracket 18 is provided at the left end of the lower front surface of the seat back frame 100.

The set bracket 18 is joined to the lower left corner of the panel frame 30 and to the front side of the outer peripheral surface of the lower end of the left frame part 211 of the first pipe member 21.

The set bracket 18 is formed by pressing a single metal plate.

The set bracket 18 includes a flat surface part which is joined to the panel frame 30 side, and a curved part which rises forward from the flat surface part and is joined to the outer peripheral Surface of the left frame part 211. This allows the set bracket 18 to come into contact with the panel frame 30 and the left frame part 211 over a wide area, making it possible to maintain high joint strength. Additionally, the upper and lower edges of the set bracket 18 are formed with ribs that extend forward from the plate surface as a reinforcing structure.

Two projection nuts are fixedly attached to the front surface of the flat surface part of the set bracket 18 by projection welding, in the up-down direction. Through holes are formed in the flat surface part of the set bracket 18 and in the panel frame 30 in correspondence with the screw holes of these projection nuts. When the seat back frame 100 is fixed to the vehicle body, a fixing bolt is screwed into each projection nut.

[Technical Effect of First Embodiment] The seat back frame 100 includes a first belt guide 15 and a second belt guide 16. Therefore, even if a large load is applied to the seat belt B1, the load applied from the seat belt B1 can be distributed to the first belt guide 15 and the second belt guide 16, making it possible to improve both the support rigidity of each belt guide 15, 16 and the support rigidity of the seat belt B1 with a simple configuration.

In addition, in the seat back frame 100, the first belt guide 15 and the second belt guide 16 are attached along the pipe peripheral surface of the upper frame part 213 of the pipe frame 20. Therefore, the belt guides 15, 16 can be joined to the pipe peripheral surface over a wide area, and a high joining strength can be obtained, enabling the belt guides 15, 16 to withstand a larger load from the seat belt B1.

Furthermore, by attaching each belt guide 15, 16 along the pipe peripheral surface, when a load is applied along the extending direction of the insertion part 152 of each belt guide 15, 16, the force is more likely to be applied to the mounting surface with the upper frame part 213 in a direction along the peripheral surface that is the mounting surface, rather than in a direction that would cause the mounting surface to peel off. Therefore, the belt guides 15, 16 are less likely to peel off from the pipe frame 20, and the strength against loads can be improved.

Furthermore, by forming the arm parts 151, 161 of the belt guides 15, 16 in an arc shape along the pipe peripheral surface, the arm parts 151, 161 themselves also function as hooks. Therefore, it is possible to withstand a larger load from the seat belt B1.

In addition, the seat back frame 100 is arranged so that the extending end of the insertion part 152 of the first belt guide 15 and the extending end of the insertion part 162 of the second belt guide 16 are located in front of and behind the center B3 of the seat belt retractor B, respectively.

Therefore, when the seat belt is reeled out from the seat belt retractor B through the second belt guide 16 and the first belt guide 15 to the front side of the seat back frame, each belt guide 15, 16 can guide the belt satisfactorily.

That is, the seat belt B1 is reeled out upward from the seat belt retractor B, and then folded back and reeled out diagonally downward toward the front. Therefore, the seat belt B1 can be guided so as to change its path in stages from the insertion part 162 of the second belt guide 16 to the insertion part 152 of the first belt guide 15, making it possible to smoothly pull out the seat belt B1.

In addition, due to the above-mentioned arrangement of the insertion parts 152, 162, when a load is applied from the seat belt B1, it is possible to prevent the load applied to each belt guide from becoming uneven and to appropriately distribute the load. Therefore, it is possible to improve the mounting strength and durability of each of the belt guides 15, 16 against loads.

Furthermore, since the insertion part 162 of the second belt guide 16 is located rearward of the center B3 of the seat belt retractor B, when a large load is applied to the seat belt B1, the load that pulls the seat belt retractor B away from the support bracket 40 through the seat belt B1 can be reduced. Therefore, the mounting strength and durability of the seat belt retractor B can be improved.

In addition, in the seat back frame 100, the extending end of the insertion part 152 of the first belt guide 15 extends forward from the upper part of the pipe circumferential surface of the upper frame part 213, and the extending end of the insertion part 162 of the second belt guide 16 extends forward from the lower part of the pipe peripheral surface of the upper frame part 213.

Therefore, when the load is applied to the seat belt B1, the force applied to each belt guide 15, 16 can be directed in a direction along the pipe peripheral surface rather than in a direction that would encourage the upper frame part 213 to peel off from the pipe peripheral surface, thereby improving strength against the load.

Furthermore, since the first belt guide 15 and the second belt guide 16 are made of members having the same shape, the use of common parts can facilitate manufacturing and reduce manufacturing costs.

In addition, the seat back frame 100 includes the second reinforcing part 319 that serves as the evacuation part for the first and second belt guides 15, 16 provided on the upper frame part 213, 1 making it possible to avoid interference between each belt guide 15, 16 and the panel frame 30. The panel material such as the panel frame 30 makes it easy to form evacuation parts by using unevenness, makes it easy to secure the mounting positions of each belt guide 15, 16, and also makes it possible to maintain a high degree of freedom in the arrangement of the mounting positions.

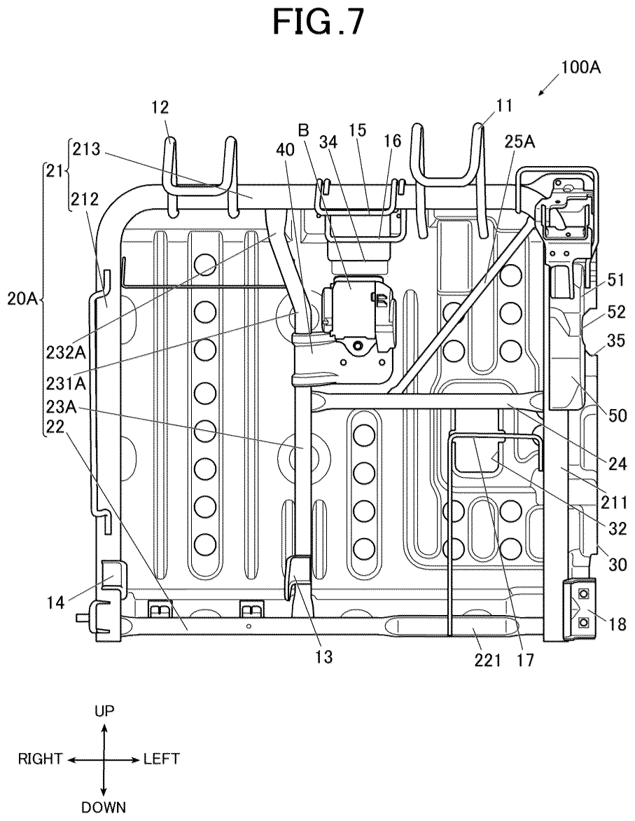

In addition, in the seat back frame 100, the panel frame 30 is joined to the pipe frame 20 at multiple points by the second joint reinforcing part 314, the third joint reinforcing part 316, the fourth joint reinforcing part 317 and the fifth joint reinforcing part 318 that protrude forward. Apart from these forward-protruding joint positions, the panel frame 30 is spaced apart from the pipe frame 20 in the front-rear direction, forming the gap. Therefore, the generation of abnormal noises such as rattle sounds between the panel frame 30 and the pipe frame 20 can be suppressed.

[Second Embodiment] In the second embodiment, a seat back frame 100A including a pipe frame 20A that is partially different in configuration from the pipe frame 20 will be illustrated. FIG. 7 is a front view of the seat back frame 100A.

In addition, for the seat back frame 100A, the configuration the same as that of the above-described seat back frame 100 is denoted by the same reference numeral, and the redundant explanation will be omitted. Regarding the seat back frame 100A, differences from the seat back frame 100 will be mainly described.

The seat back frame 100A includes the panel frame 30 and a pipe frame 20A provided on the front side of the panel frame 30.

The pipe frame 20A differs from the pipe frame 20 in that it includes a third pipe member 23A instead of the third pipe member 23, and in that it newly includes a fifth pipe member 25A.

The third pipe member 23A has a circular cross section and is made of a metal pipe such as a steel pipe. The third pipe member 23A has the same outer diameter as the third pipe member 23. The third pipe member 23A is disposed on the inner side of the pipe frame 20A and extends generally along the up-down direction.

The third pipe member 23A corresponds to a connecting member that connects a middle part of the upper frame part 213 and a middle part of the second pipe member 22 serving as a lower frame.

However, the connecting position of the third pipe member 23A to the upper frame part 213 is different from that of the third pipe member 23 described above. The connecting position of the third pipe member 23A to the upper frame part 213 is located at a position separated to the right from the connecting position so as to avoid the first and second belt guides 15, 16. The connecting position of the third pipe member 23A to the upper frame part 213 is an intermediate position between the connecting position of the first and second belt guides 15, 16 and the connecting position of the headrest frame 12.

The connecting position of the lower end side of the third pipe member 23A to the second pipe member 22 is the same as that of the third pipe member 23. For this reason, the third pipe member 23A includes two bending parts 231A, 232A at its upper part. This allows the connecting position with respect to the upper frame part 213 to be changed.

The lower side bending part 231A is located slightly to the upper side of the joint position between the third pipe member 23A and the upper side second joint reinforcing part 314. The third pipe member 23A has a straight shape in the portion to the lower side than the bending part 231A and is oriented parallel to the up-down direction. The portion on the upper side of the bending part 231A is inclined obliquely upward to the right.

The upper side bending part 232A is located near the upper end of the third pipe member 23A. The portion to the upper side of the upper side bending part 232A is inclined obliquely upward to the left. This bending part 232A is corrected so that the portion to the upper side than the bending part 232A is oriented parallel to the up-down direction.

The upper end of the third pipe member 23A is joined to the upper frame part 213 by two bending parts 231A, 232A at a position spaced to the right from the connecting position thereof, bypassing the first and second belt guides 15, 16.

The upper and lower ends of the third pipe member 23A are also compressed and flattened, and are joined to the upper frame part 213 and the second pipe member 22 with high strength.

In addition, the third pipe member 23A includes two bending parts 231A, 232A, both of which are provided above the upper side second joint reinforcing part 314. Therefore, the third pipe member 23A can be joined to the two second joint reinforcing parts 314 without making any modifications to the panel frame 30. Additionally, the third pipe member 23A can be joined to the connecting part 42 without any modification to the support bracket 40. Furthermore, the third pipe member 23A can be joined to the fourth pipe member 24 without making any modification to the fourth pipe member 24.

Therefore, a high-strength connected state between the pipe frame 20A and the panel frame 30 is maintained, and the effect of improving the rigidity of the seat back frame 100A due to the mutual connection is maintained.

The fifth pipe member 25A has a circular cross section and is made of a metal pipe such as a steel pipe. The fifth pipe member 25A is disposed along an obliquely upward direction on the inner side of the pipe frame 20A.

The fifth pipe member 25A connects a portion of the fourth pipe member 24 slightly to the right of the middle part to an upper left corner of the first pipe member 21, that is, the boundary portion between the left frame part 211 and the upper frame part 213.

The fifth pipe member 25A functions as a diagonal brace frame that connects the vicinity of the corners of the rectangular frame formed by the first pipe member 21, the third pipe member 23, and the fourth pipe member 24 in an approximately diagonal arrangement.

Both ends of the fifth pipe member 25A are compressed and processed flat, and are joined with high strength to the rear part of the outer peripheral surface of the fourth pipe member 24 and the rear part of the outer peripheral surface of the first pipe member 21.

A pipe member having a smaller outer diameter than the fourth pipe member 24 and the like is used as the fifth pipe member 25A. This makes it possible to arrange the fifth pipe member 25A in the narrow space between the pipe frame 20A and the panel frame 30.

In addition, a pipe member having the same outer diameter as the fourth pipe member 24, etc. may be used as the fifth pipe member 25A.

In addition, the fifth pipe member 25A may be disposed on the front side of the pipe frame 20A.

In the seat back frame 100A, the third pipe member 23 is bent so as to bypass the first belt guide 15 and the second belt guide 16 and has an upper end connected to the upper frame part 213. Therefore, it is possible to properly secure the attachment positions of the first belt guide 15 and the second belt guide 16. Furthermore, regardless of the positioning of the first belt guide 15 and the second belt guide 16, it becomes possible to arrange the third pipe member 23A on the inner side of the pipe frame 20A. This makes it possible to improve the frame strength in the same way as the third pipe member 23.

Furthermore, the third pipe member 23A is joined to the upper frame part 213 at a position spaced apart from the first belt guide 15 and the second belt guide 16. This makes it possible to prevent other components from being connected to the upper frame part 213 in a concentrated manner in a narrow range. This makes it possible to prevent the load from being concentrated in the narrow range of the upper frame part 213 when the load is applied to the seat back frame 100A, thereby suppressing deformation, damage, etc. of the upper frame part 213 and improving the durability of the seat back frame 100A.

Furthermore, since the fifth pipe member 25A is arranged in a roughly diagonal brace configuration in the frame-shaped portion of the pipe frame 20A, it is possible to suppress deflection of each configuration in the pipe frame 20A in the tilting direction, thereby improving the rigidity of the pipe frame 20A.

The third pipe member 23A may be formed from a straight pipe material that does not include the bending parts 231A, 232A. In this case, the upper and lower ends may be attached at a slight upward inclined orientation to the right so that they are joined to the connecting position for the upper frame part 213 and the connecting position for the second pipe member 22, respectively. In this case as well, it is possible to obtain substantially the same rigidity as the third pipe member 23A including the bending parts 231A, 232A.

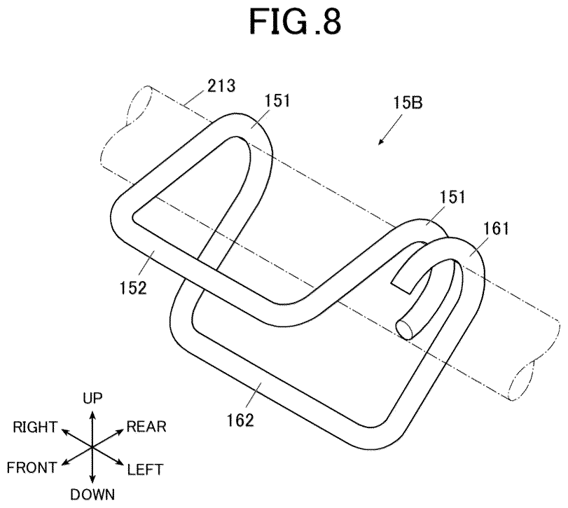

In this case, however, it would be necessary to change the arrangement of the two second joint reinforcing parts 314, change the shape of the joint surface of the connecting part 42 of the support bracket 40, and adjust the length of the fourth pipe member 24.

[Third Embodiment] In the third embodiment, a belt guide 15B different from the first belt guide 15 and the second belt guide 16 is illustrated. FIG. 8 is a perspective view of the belt guide 15B.

The belt guide 15B is a belt guide in which the first belt guide 15 and the second belt guide 16 described above are formed from a single wire and integrated into a single member.

The belt guide 15B includes a configuration so as to have the same shape and the same function as each part of the first belt guide 15 and the second belt guide 16 described above. Therefore, for the belt guide 15B, the same parts as those of the first belt guide 15 and the second belt guide 16 described above are denoted by the same reference numerals.

The belt guide 15B is formed by bending a hard metal wire. The arrangement of the belt guide 15B with respect to the upper frame part 213 coincides with the arrangement of the first belt guide 15 and the second belt guide 16.

The belt guide 15B is formed with two substantially U-shaped portions, and includes two insertion parts 152, 162 formed at the bottom of each U-shaped portion. Further, the right end of the insertion part 152 and the right end of the insertion part 162 are connected by the arm part 151 formed in an arc shape. The inner diameter of the arm part 151 is approximately the same as the outer diameter of the upper frame part 213, and the inner periphery part of the arm part 151 and the outer peripheral surface of the upper frame part 213 are joined together.

The left end of the insertion part 152 extends rearward and is formed into an arc shape to constitute the other arm part 151. This arm part 151 is joined to the upper frame part 213 in the same manner as the arm part 151 described above.

In addition, the left end of the insertion part 162 also extends rearward and is formed in an arc shape to form the arm part 161. The arm part 161 is joined to the upper frame part 213 adjacent to the arm part 151 in the same manner as the arm part 151.

A single arm part 151 functions as both the arm part 151 on the right side of the insertion part 152 in the first belt guide 15 and the arm part 161 on the right side of the insertion part 162 in the second belt guide 16.

Strictly speaking, the insertion part 162 is formed to be slightly longer than the insertion part 162 of the second belt guide 16.

The positioning of the straight site of the insertion part 152 and the straight site of the insertion part 162 in the above-mentioned belt guide 15B relative to the upper frame part 213 respectively corresponds to the positioning of the straight site of the insertion part 152 of the first belt guide 15 and the straight site of the insertion part 162 of the second belt guide 16 described above.

Therefore, the belt guide 15B functions in the same manner as the first belt guide 15 and the second belt guide 16, and achieves the same technical effects.

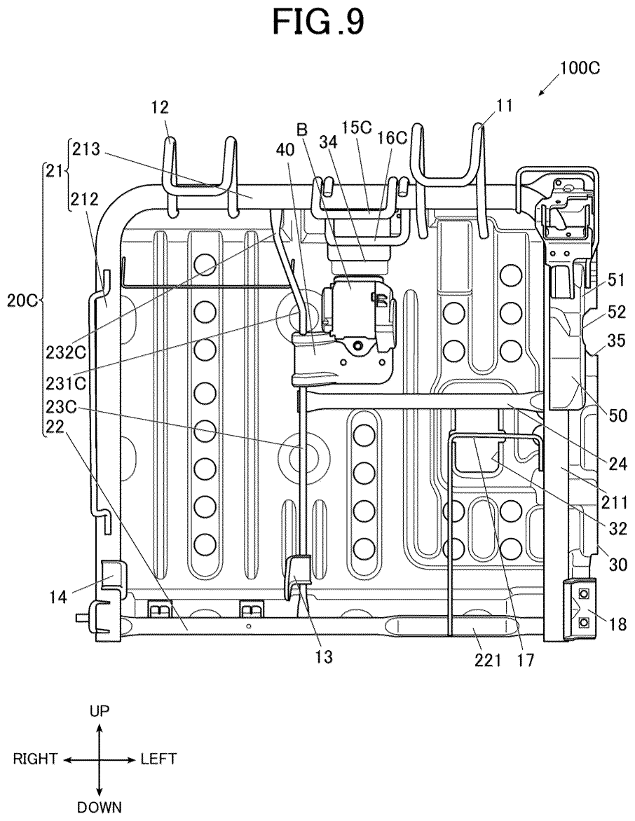

Furthermore, since the belt guide 15B is made of a single, integrated member, it is possible to reduce the number of parts, the manufacturing cost, and the weight.

[Fourth Embodiment] In the fourth embodiment, a seat back frame 100C including a pipe frame 20C that is partially different in configuration from the pipe frame 20 will be illustrated. FIG. 9 is a front view of the seat back frame 100C.

In addition, for the seat back frame 100C, the configuration the same as that of the above-described seat back frame 100A is denoted by the same reference numeral, and the redundant explanation will be omitted. Regarding the seat back frame 100C, differences from the seat back frame 100A will be mainly described.

The seat back frame 100C includes a panel frame 30 and a pipe frame 20C provided on the front side of the panel frame 30.

The pipe frame 20C differs from the pipe frame 20A in that it includes a third pipe member 23C instead of the third pipe member 23A, and in that it includes first and second belt guides 15C, 16C instead of the first and second belt guides 15, 16.

Furthermore, the pipe frame 20C differs from the pipe frame 20A in that it does not include the fifth pipe member 25A The third pipe member 23C is different from the third pipe member 23A in that the outer diameter of the metal pipe used is smaller. Therefore, the joint positions of both ends of the third pipe member 23C in the pipe frame 20C and the bending positions of two bending parts 231C, 232C of the third pipe member 23C are the same as those of the third pipe member 23A.

The first and second belt guides 15C and 16C are different from the first and second belt guides 15 and 16 only in that the outer diameter of the wire used is larger than that of the first and second belt guides 15 and 16. The shape, arrangement, and structure of the first and second belt guides 15C and 16C are the same as those of the first and second belt guides 15 and 16.

The outer diameter of the wires of the first and second belt guides 15C, 16C may be larger than the outer diameter of the metal pipe of the third pipe member 23C.

The seat back frame 100C including the above-described configuration can be made lighter in weight than the seat back frame 100A by reducing the diameter of the third pipe member 23C. Furthermore, by omitting the fifth pipe member 25A, further weight reduction is achieved.

In addition, the first and second belt guides 15C, 16C use wires with a larger outer diameter, which further improves the load resistance against the load from the seat belt B1.

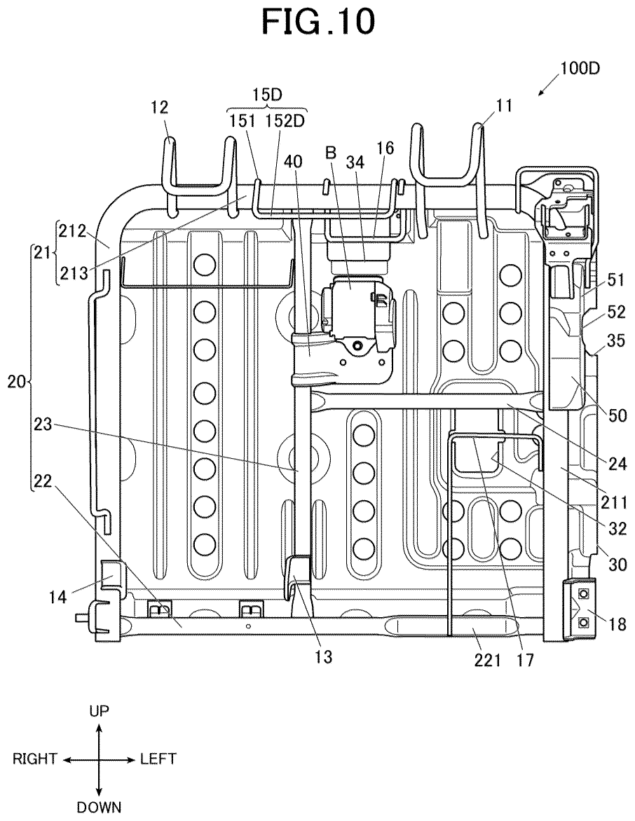

The seat back frame 100C is designed to be lightweight while improving the load resistance from the seat belt B1. However, for example, when focusing on being lightweight, the seat back frame 100C may be configured to include the first and second belt guides 15, 16 described above.

[Fifth Embodiment] In the fifth embodiment, a seat back frame 100D including a first belt guide 15D that is partially different in configuration from the first belt guide 15 will be illustrated. FIG. 10 is a front view of the seat back frame 100D.

In addition, for the seat back frame 100D, the configuration the same as that of the above-described seat back frame 100 is denoted by the same reference numeral, and the redundant explanation will be omitted. Regarding the seat back frame 100D, differences from the seat back frame 100 will be mainly described.

The first belt guide 15D differs from the first belt guide 15 only in that an insertion part 152D is longer in the left-right direction than the insertion part 152 of the first belt guide 15.

The left side arm part 151 of the first belt guide 15D is joined to the upper frame part 213 at the same position as the left side arm part 151 of the first belt guide 15.

On the other hand, the joint position of the right side arm part 151 of the first belt guide 15D to the upper frame part 213 is to the right of the joint position of the right side arm part 151 of the first belt guide 15. More specifically, it is a position to the right of the joint position of the third pipe member 23 in the upper frame part 213 and farther away than the distance between the right side arm part 151 of the first belt guide 15 and the third pipe member 23.

The seat back frame 100D includes the same effect as the seat back frame 100.

Furthermore, since the insertion part 152D of the first belt guide 15D is long in the left-right direction, the operation of inserting the seat belt B1 therethrough is facilitated.

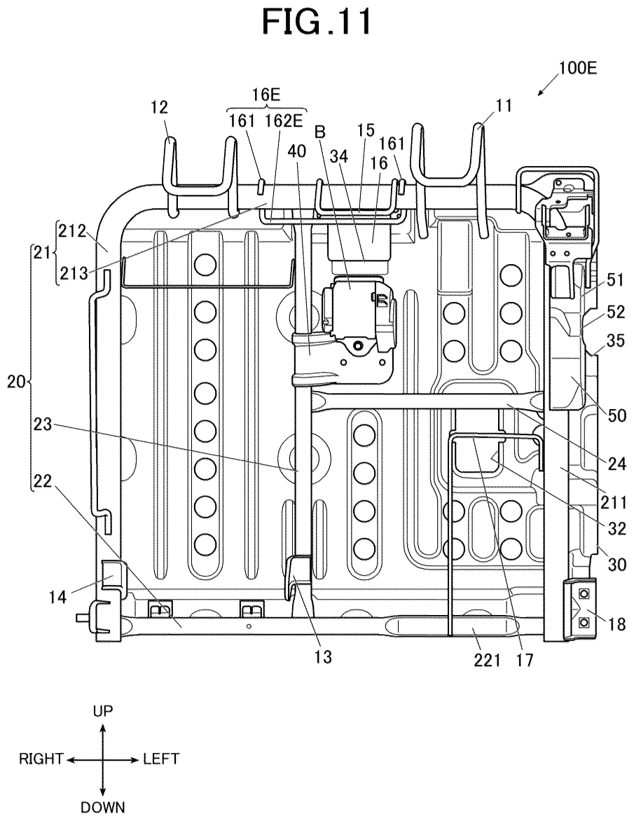

Furthermore, since the insertion part 152D is long in the left-right direction, it is possible to optimize the joint positions of the left and right arm parts 151 to the upper frame part 213. For example, by joining the arm part 151 to a position farther away from the joint position of the third pipe member 23 on the upper frame part 213, it is possible to avoid the components being connected in a concentrated manner in a narrow range. When the load is applied to the seat back frame 100D, it is possible to avoid the load being concentrated in a narrow range of the upper frame part 213. This suppresses deformation, damage, etc. of the upper frame part 213 and improves the durability of the seat back frame 100D.

[Sixth Embodiment] In the sixth embodiment, a seat back frame 100E including a second belt guide 16E having a partially different configuration from that of the first belt guide 15 will be illustrated. FIG. 11 is a front view of the seat back frame 100E.

In addition, for the seat back frame 100E, the configuration the same as that of the above-described seat back frame 100 is denoted by the same reference numeral, and the redundant explanation will be omitted. Regarding the seat back frame 100E, differences from the seat back frame 100 will be mainly described.

The second belt guide 16E is different only in that an insertion part 162E is longer in the left-right direction than the insertion part 162 of the second belt guide 16E.

The left side arm part 161 of the second belt guide 16E is joined to the upper frame part 213 at the same position as the left side arm part 151 of the second belt guide 16. On the other hand, the joint position of the right side arm part 161 of the second belt guide 16E to the upper frame part 213 is to the right of the joint position of the right side arm part 161 of the second belt guide 16. More specifically, it is a position to the right of the joint position of the third pipe member 23 in the upper frame part 213 and farther away than the distance between the right side arm part 161 of the second belt guide 16 and the third pipe member 23.

The seat back frame 100E includes the same effects as the seat back frame 100.

Furthermore, since the insertion part 162e of the second belt guide 16E is long in the left-right direction, the operation of inserting the seat belt B1 therethrough can be facilitated.

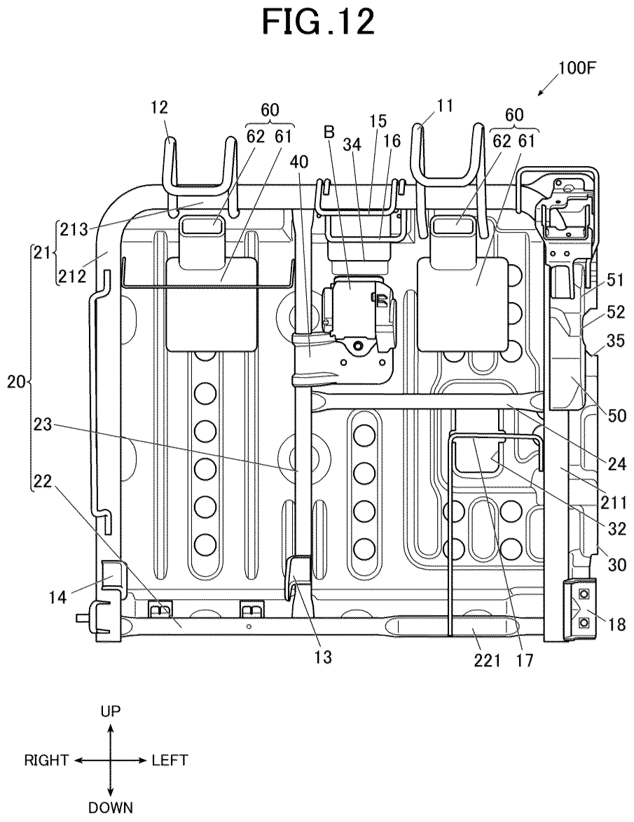

Furthermore, since the insertion part 162E is long in the left-right direction, it is possible to optimize the joint positions of the left and right arm parts 161 to the upper frame part 213. This makes it possible to improve the durability of the seat back frame 100E.

[Seventh Embodiment] In the seventh embodiment, a seat back frame 100F including an air blowing device 60 is illustrated. FIG. 12 is a front view of the seat back frame 100F.

In addition, for the seat back frame 100F, the configuration the same as that of the above-described seat back frame 100 is denoted by the same reference numeral, and the redundant explanation will be omitted. Regarding the seat back frame 100F, differences from the seat back frame 100 will be mainly described.

In the seat back frame 100F, air blowing devices 60 are disposed on the front side of the upper portion of the panel frame 30, one on each of the left and right sides of the seat belt retractor B.

Each air blowing device 60 may be attached by fastening and fixing it to a bracket (not shown) made of a metal plate joined to the front side of the panel frame 30 with a bolt or the like.

Each of the air blowing devices 60 includes a housing 61 that houses a fan and a driving source such as a motor, and a duct 62 that extends upward from the housing 61 and opens to the front side.

The left side air blowing device 60 is disposed within a gap region which is surrounded by the first pipe member 21, the third pipe member 23, and the fourth pipe member 24, and which has ample space in the front-rear direction. Furthermore, the left side air blowing device 60 is positioned so that the duct 62 is located between the ends of the two wires extending downward of the headrest frame 11 so as not to interfere with the headrest frame 11.

The right side air blowing device 60 is disposed within a gap region which is surrounded by the first pipe member 21, the second pipe member 22, and the third pipe member 23, and which has ample space in the front-rear direction. Furthermore, the right side air blowing device 60 is positioned so that the duct 62 extending upward is located between the ends of the two wires extending downward of the headrest frame 12 so as not to interfere with the headrest frame 12.

The seat back frame 100F is provided with air blowing devices 60 on the left and right sides, making it possible to provide an air-blowing function to the seat.

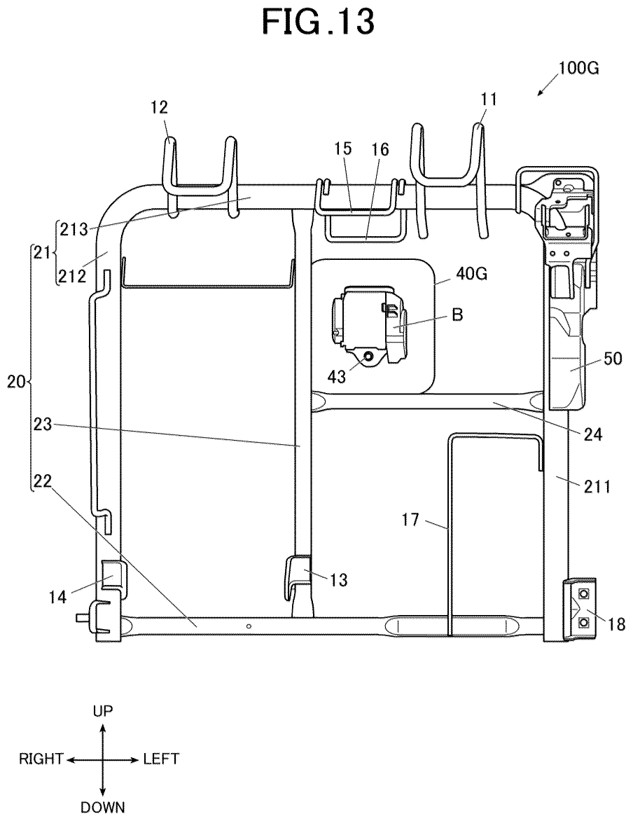

In addition, since each air blowing device 60 is arranged by utilizing the gap space in the seat back frame 100F, it is possible to prevent the seat back frame 100F from becoming large. In addition, since the air blowing device 60 is surrounded by pipe members, it is possible to effectively protect the air blowing device 60 even when the load is applied to the seat.

[Eighth Embodiment] In the eighth embodiment, a seat back frame 100G is illustrated as another example. FIG. 13 is a front view of the seat back frame 100G.

In addition, for the seat back frame 100G, the configuration the same as that of the above-described seat back frame 100 is denoted by the same reference numeral, and the redundant explanation will be omitted. Regarding the seat back frame 100G, differences from the seat back frame 100 will be mainly described.

The seat back frame 100G differs from the seat back frame 100 mainly in that the seat back frame 100G does not include the panel frame 30.

In the seat back frame 100, the support bracket 40 of the seat belt retractor B is supported by the panel frame 30.

In the seat back frame 100G, the support bracket 40G of the seat belt retractor B is supported by the pipe frame 20.

The support bracket 40G is made of a substantially rectangular or square flat metal plate. The support bracket 40G may be approximately one size larger than the seat belt retractor B when viewed from the front. The front surface of the right edge of the support bracket 40G is joined to the rear part of the outer peripheral surface of the third pipe member 23. In addition, the front surface of the lower edge of the bracket 40G is joined to the rear part of the outer peripheral surface of the fourth pipe member 24.

The support bracket 40G also includes an insertion hole for the bolt 43, and the head of the bolt 43 is joined at the rear side. The seat belt retractor B is fixed to the front side of the support bracket 40G by the bolt 43 and a nut (not shown).

It should be noted that the support bracket 40G does not have to be substantially rectangular or square. However, it is preferable that the flat metal plate includes a substantially right-angled portion including an outer edge along the third pipe member 23 and an outer edge along the fourth pipe member 24.

In addition, the left edge of the support bracket 40G may extend to the left frame part 211 and the front surface of the left edge may be joined to the rear part of the outer peripheral surface of the left frame part 211. In this case, the lower edge of the support bracket 40G may or may not be joined to the fourth pipe member 24.

Since the seat back frame 100G does not include the panel frame 30, it is possible to achieve a dramatic reduction in weight. Furthermore, since the panel frame 30, which is the largest component, is not required, it is possible to reduce the number of components and the manufacturing costs.

In addition, since the support bracket 40G of the seat belt retractor B is joined to the rear part of the outer peripheral surfaces of the third pipe member 23 and the fourth pipe member 24 of the pipe frame 20, high support strength can be obtained against the load received from the seat belt B1.

### Others

The embodiment of the present invention has been described above. However, the present invention is not limited to the above embodiments. For example, in the embodiments, components that are integrally formed from a single member may be replaced with components that are divided into multiple members and connected or secured to one another. Furthermore, a component formed by connecting a plurality of members may be replaced with a component integrally formed from a single member. In addition, the details shown in the embodiment can be modified as appropriate without departing from the spirit of the invention.

For example, in the pipe frame 20, the first pipe member 21 constitutes the left and right frames and the upper frame, and the second pipe member 22 constitutes the lower frame, but the configuration is not limited to this. The first pipe member 21 may form the left and right frames and the lower frame, and the second pipe member 22 may form the upper frame.

Furthermore, the first pipe member 21 may be approximately U-shaped, including an upper frame part along the upper edge of the seat back frame 100, a lower frame part along the lower edge of the seat back frame 100, and a left frame part or a right frame part along the left edge or the right edge of the seat back frame 100. In this case, it is preferable that the second pipe member 22 be a right frame part or a left frame part that is parallel to the up-down direction along the right edge or the left edge of the seat back frame 100. It is also preferable that the third pipe member 23 is oriented horizontally and the fourth pipe member 24 is oriented vertically.

In addition, the number of first reinforcing parts 311, third joint reinforcing parts 316, fourth joint reinforcing parts 317, and fifth joint reinforcing parts 318 in the panel frame 30 can be increased or decreased. In addition, the arrangement of the first reinforcing part 311, the third joint reinforcing part 316, the fourth joint reinforcing part 317, and the fifth joint reinforcing part 318 can also be changed.

[Additional Solution 1] A manufacturing method for a seat back frame including:
in a manufacturing method of a seat back frame,
preparing a first belt guide through which a seat belt reeled out from a seat belt retractor is inserted; and
preparing a second belt guide which is separate from the first belt guide, and through which the seat belt reeled out from the seat belt retractor is inserted.

The above-mentioned solution 1 is a method for manufacturing the seat back frame that includes the step of preparing the first belt guide and the step of preparing the second belt guide, so that it is possible to preferably manufacture the seat: frame with high Seat belt supporting rigidity.

[Additional Solution 2] The method for manufacturing a seat back frame according to Solution 1, further including:
preparing a pipe frame; and
attaching the first belt guide and the second belt guide along a pipe peripheral surface of the pipe frame;

The above-mentioned solution 2 is a manufacturing method for the seat back frame that includes the step of preparing the pipe frame and the step of attaching the first belt guide and the second belt guide along the pipe peripheral surface of the pipe frame, so that it is possible to preferably manufacture the seat back frame in which each belt guide has high mounting strength.

For example, in the case of seat back frames 100, 100A, 100C, 100D, 100F, and 100G, the first belt guides 15, 15C, and 15D are prepared, the second belt guides 16, 16C, and 16E are prepared, and the pipe frames 20, 20A, and 20C are prepared. Then, the first belt guide 15 etc. and the second belt guide 16 etc. are joined to the upper frame part 213, thereby manufacturing the seat back frames 100, 100A, 100C, 100D, 100F, and 100G.

The steps of preparing the first belt guide, preparing the second belt guide, and preparing the panel frame may be performed in any order, and two or three of the steps may be performed simultaneously in parallel.

### Embodiments Related to Seat Locking Device

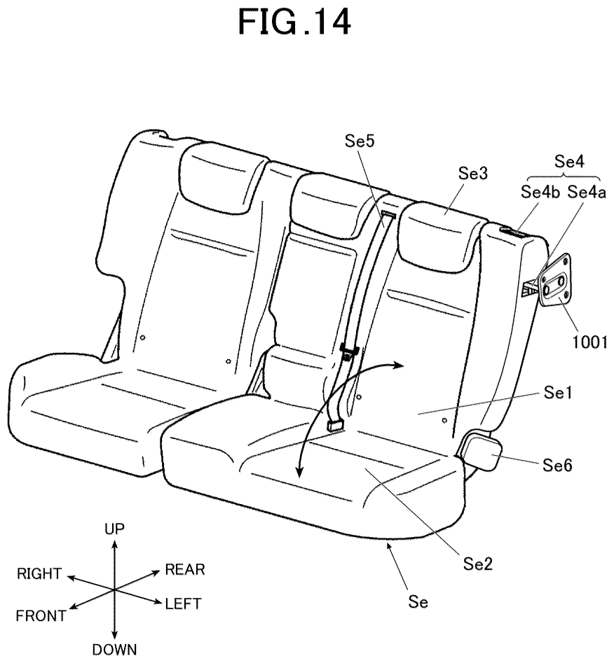

Hereinafter, an embodiment of the seat locking device will be described with reference to FIG. 14 to FIG. 19B. Various limitations that are technically preferable to implement the present invention are added to the embodiments described below. However, the scope of the present invention is not limited to the embodiments and the illustrated examples described below.

The present embodiment has industrial applicability to seat locking devices.

[Background Art of Present Embodiment] Conventionally, a seat locking device that fixes and holds a vehicle seat to a vehicle body is known. The seat locking device includes a striker provided on the vehicle body and a lock unit that is provided on the vehicle seat and that engages the striker. The striker includes a rod that is engaged by the lock unit and a base member that is attached to the vehicle body.

For example, Patent Publication No. 5373535 describes a seat locking device that is provided with a reinforcing member fixed to a surface side of a base member so as to abut against it, and that is provided on a side of a rod that tilts due to load.

In addition, the seat locking device described below is disclosed in Patent Publication No. 7059128.

Specifically, a base bracket (base member) includes a support part that supports an end of a rod. Then, the support part deforms when a load exceeding a predetermined load is input to the rod. Then, by deforming the support part, it allows a movement of the end of the rod supported by the support part relative to the base bracket.

[Problem to be Solved by Present Embodiment] However, in the invention described in Patent Publication No. 5373535 the seat locking device includes the reinforcing member, which increases the number of parts and leads to a rise in costs.

In addition, the invention described in Patent Publication No. 7059128 includes the rod that has an extension shaft part extending in the direction of a rod tip from the fixing part with the base bracket. This causes a problem of the striker becoming larger.

This embodiment has been conceived in light of the circumstances mentioned above, and aims to provide a seat locking device that can absorb shocks without increasing the number of parts or enlarging the size.

[Solution to Problem] To solve the above problems, a seat locking device according to Solution 1 includes,
a striker provided on a vehicle body,
a lock unit that is provided on the vehicle seat and that holds the vehicle seat by engaging the striker,
wherein, the striker includes a base bracket that is attached to the vehicle body and a rod that is engaged by the lock unit,
the rod includes a first shaft part, a second shaft part, and a connecting part that connects the first shaft part and the second shaft part,
the first shaft part includes a deformation part that deforms when a load exceeding a predetermined load is input to the first shaft part, and
the base bracket includes a first support part that supports the first shaft part, and a second support part that supports the second shaft part.

Solution 2 is the seat locking device according to Solution 1,
wherein among the rods, the lock unit is engaged with the first shaft part, and
the first support part is arranged in a forward direction of the vehicle seat than an engagement part, which is a site where the lock unit is engaged with the first shaft part.

Solution 3 is the seat locking device according to solution 1,
wherein among the rods, the lock unit is engaged with the first shaft part, and
a length of the engagement part, which is the site where the lock unit is engaged with the first shaft part, is equal to a length from the deformation part in the first shaft part to a position where contact is made to the first support part.

Solution 4 is the seat locking device according to solution 1,
wherein among the rods, the lock unit is engaged with the first shaft part, and
a length of the engagement part, which is the site where the lock unit is engaged with the first shaft part, is shorter than a length from the deformation part in the first shaft part to a position where contact is made to the first support part.

Solution 5 is the seat locking device according to solution 1,
wherein among the rods, the lock unit is engaged with the first shaft part, and
a length of the engagement part, which is the site where the lock unit is engaged with the first shaft part, is longer than a length from the deformation part in the first shaft part to a position where contact is made to the first support part.

Solution 6 is the seat locking device according to solution 1,
further including the base bracket equipped with a projecting portion,
wherein the projecting portion is arranged in a direction in which the first shaft part or the second shaft part falls when a load exceeding a predetermined load is applied to the first shaft part.

Solution 7 is the seat locking device according to Solution 1,
further including a reinforcing member that covers circumferential surfaces of the first shaft part and the second shaft part,
wherein the reinforcing member is arranged on the base bracket side than the deformation part.

[Effect of Solution] According to solution 1, in the vehicle seat, when a strong force is applied to pull the striker forward from the lock unit due to the load exceeding the predetermined load acting forward, the rod of the striker can deform due to the deformation part, thereby absorbing the load. In other words, it is possible to absorb shocks without increasing or enlarging the parts.

According to solution 2, in a case that the load on the striker is equal to or below the predetermined load, the rod can be efficiently supported by the first support part.

According to solution 3, even in a configuration where the length of the engagement part between the lock unit and the first shaft part is equal to the length from the deformation part in the first shaft part to the position where it contacts the first support part, the rod of the striker can absorb the load by deforming.

According to solution 4, even in a configuration where the length of the engagement part between the lock unit and the first shaft part is shorter than the length from the deformation part in the first shaft part to the position where it contacts the first support part, the rod of the striker can absorb the load by deforming.

According to solution 5, even in a configuration where the length of the engagement part between the lock unit and the first shaft part is longer than the length from the deformation part in the first shaft part to the position where it contacts the first support part, the rod of the striker can absorb the load by deforming.

According to solution 6, when the rod of the striker is deformed, the first or second shaft part can be supported by the projecting portion, thereby improving the strength of the striker.

According to solution 7, while reinforcing the first and second shaft parts with reinforcing members, the rod does not hinder deformation due to the deformation part.

### Contents of Embodiment Related to Seat Locking Device

FIG. 14 is a perspective view of an outer appearance of a vehicle seat Se and a striker 1001 according to the present embodiment.

The side where a seated occupant sits on a seat back Se1 of the vehicle seat Se is a front side (front side of the vehicle body).

The vehicle seat Se is a seat installed in wheeled vehicles such as automobiles.

The vehicle seat Se mainly consists of the seat back Se1, a seat cushion Se2, a headrest Se3, a lock unit Se4, and a seat belt Se5, as shown in FIG. 14.

The seat back Se1 supports a lower back and back of a passenger seated in the seat (hereinafter referred to as the seated occupant).

The seat back Se1 includes a metal frame (not shown) that forms a skeleton of the seat back Se1, a cushion pad (not shown), and a cover.

The frame is covered with a cushion pad made of relatively soft resin foam such as urethane foam.

The cushion pad is covered by a cover made of leather, woven fabric, etc.

The seat cushion Se2 supports buttocks and thighs of the seated occupant.

The seat cushion Se2, like the seat back Se1, is equipped with a metal frame, a cushion pad that covers the frame, and a cover that covers the cushion pad.

The seat belt Se5 restrains the seated occupant to the seat cushion Se2 and the seat back Se1.

In the vehicle seat Se, the seat back Se1 can tilt in a front-rear direction of the vehicle seat Se with respect to the seat cushion Se2 around a tilting axis (not shown) provided at a lower end of the seat back Se1. The tilting axis is fixed to the vehicle body via a fixing bracket Se6.

The vehicle seat Se can be set to a reclining state and an upright state.

The reclining state refers to the state where the seat back Se1 overlaps on top of the seat cushion Se2.

The upright state refers to the condition where the seat back Se1 is upright in relation to the seat cushion Se2.

The lock unit Se4 consists of a device for switching the vehicle seat Se from the upright state to the reclining state, and is attached on an upper part of the seat back Se1.

The lock unit Se4 mainly consists of a lock member Se4a and a lock operation lever Se4b.

The lock member Se4a is detachably engaged with the striker 1001 attached to the vehicle body.

The lock operation lever Se4b switches between a lockable state where the lock member Se4a can be locked to the striker 1001 and a non-lockable state in which the lock is not possible.

The lock unit Se4 and the striker 1001 are the seat locking device.

In the vehicle seat Se, when the passenger handles the lock operation lever Se4b while in the upright state, a locked state of the seat back Se1 is released by the lock unit Se4. With the release of the locked state, the passenger can rotate the seat back Se1 forward and fold it, allowing the vehicle seat Se to switch from the upright state to the reclining state.

If it is desired to return the vehicle seat Se from the reclining state to the upright state, the passenger can lift the seat back Se1 against urging force of an unillustrated coil spring by hand, engage the lock member Se4a with the striker 1001, and switch the seat back Se1 to the locked state.

The striker 1001 is a component for locking the vehicle seat Se in the upright state.

The striker 1001 is arranged at a position facing an outer part in a seat width direction of the vehicle seat Se, on the lateral part of the vehicle body.

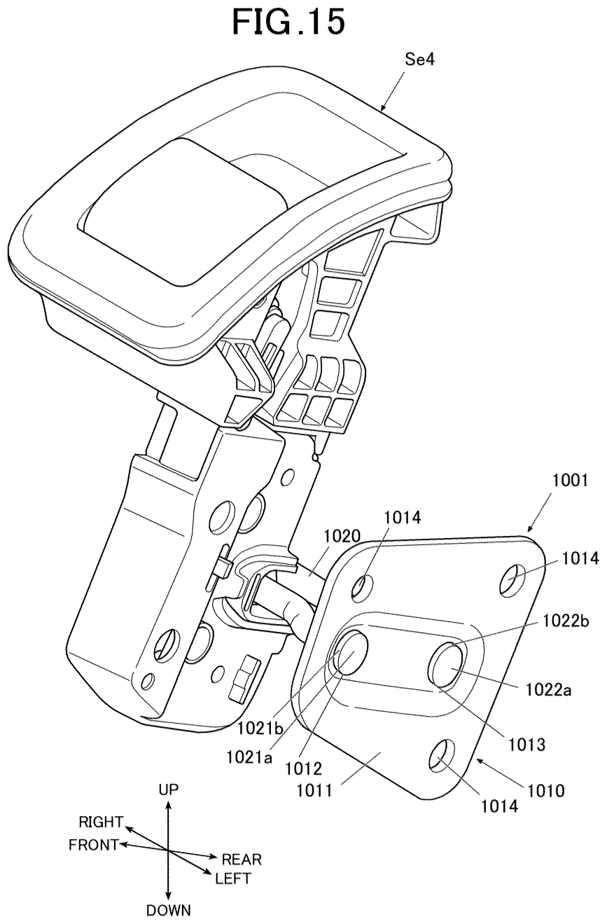

FIG. 15 is a perspective view of the lock unit Se4 and the striker 1001, and FIG. 16 is a front view of the striker 1001.

The striker 1001 is mainly composed of a base bracket 1010 and a rod 1020, as shown in FIG. 15 and FIG. 16.

The base bracket 1010 is a base plate fixed to the vehicle body and is a plate-like member made of metal materials such as steel. In addition, the base bracket 1010 is set to have higher rigidity than the rod 1020.

The base bracket 1010 is mainly composed of a base main body part 1011, a first support part 1012, a second support part 1013, and a mounting part 1014.

The base main body part 1011 has a roughly flat plate shape and is formed so that vertical dimensions gradually shorten toward the front.

The first support part 1012 and the second support part 1013 are formed at approximately a central part of the base bracket 1010 with a space between them in the front-rear direction of the vehicle seat Se.

The first support part 1012 is located on a front side of the vehicle seat Se compared to the second support part 1013.

The first support part 1012 includes a through hole 1012a for fixing a first end part 1021a of the rod 1020 mentioned later.

The second support part 1013 is located on a rear side of the vehicle seat Se compared to the first support part 1012.

The second support part 1013 includes a through hole 1013a for fixing a second end part 1022a of the rod 1020, which will be described later.

In addition, the first support part 1012 and the second support part 1013 include a bulging shape that bulges toward a connecting part 1023 of the rod 1020, as shown in FIG. 16, compared to the base main body part 1011. The first support part 1012 and the second support part 1013 includes a concave shape on the rear surface (side of the vehicle body).

Therefore, it is possible to enhance assembly rigidity with the rod 1020. In addition, the first end part 1021a and the second end part 1022a of the rod 1020 can be configured so as not to protrude from the base bracket 1010 towards the vehicle body side.

A plurality of mounting parts 1014 are formed to surround the first support part 1012 and the second support part 1013, and are used to attach the base bracket 1010 to the vehicle body.

The mounting part 1014 includes a plurality of mounting holes for fixing to the vehicle body and is mounted in contact with the vehicle body using mounting members (mounting bolts, rivets, etc.) not shown in the drawings.

According to the present embodiment, two mounting holes are provided in the upper and lower parts of the rear end of the base main body part 1011, and one is provided in the upper part of the front end of the base main body part 1011. In addition, the mounting hole provided on the lower side of the rear end of the base main body part 1011 is an elongated hole.

The rod 1020 is a U-shaped bent engagement member that is attached on the base bracket 1010 as shown in FIG. 16, extending in a long manner towards the lock member Se4a to engage with the lock member Se4a.

The rod 1020 is a bar-shaped or wire-shaped member made of metal materials such as steel.

The rod 1020 is mainly composed of a first shaft part 1021, a second shaft part 1022, and the connecting part 1023.

The first shaft part 1021 includes a first end part 1021a, a first fixed part 1021b, and a first shaft main body part 1021c.

The first end part 1021a is an end on the base bracket

### 1010 Side of the First Shaft Part 1021.

The first end part 1021a is attached to the first support part 1012 via the through hole 1012a, and is housed in the depressed shape of the first support part 1012, so it does not protrude from the base bracket 1010 to the vehicle body side.

The first fixed part 1021b fixes the first end part 1021a to the first support part 1012 by sandwiching the edge of the through hole 1012a in a plate thickness direction of the base main body part 1011.

The first fixed part 1021b is formed, for example, by crimping.

The first shaft main body part 1021c extends from the base bracket 1010 side towards the vehicle seat Se side. The first shaft main body part 1021c includes a first main body part 1021ca, a second main body part 1021cb, a deformation part 1021cc, and a third main body part 1021cd. The first main body part 1021ca and the third main body part 1021cd extend parallel to the second shaft main body part 1022c, which will be described later. That is, the first main body part 1021ca and the third main body part 1021cd extend parallel to the left-right direction of the vehicle seat Se.

The second main body part 1021cb is provided between the first main body part 1021ca and the deformation part 1021cc, extending in a diagonal direction with respect to the left-right direction of the vehicle seat Se.

The deformation part 1021cc is provided between the second main body part 1021cb and the third main body part 1021cd, bending the first shaft main body part 1021c inside the rod 1020.

The second shaft part 1022 includes a second end part 1022a, a second fixed part 1022b, and a second shaft main body part 1022c.

The second end part 1022a is the end on the base bracket 1010 side of the second shaft part 1022.

The second end part 1022a is attached to the second support part 1013 via the through hole 1013a, and is housed in the depressed shape of the second support part 1013, so it does not protrude from the base bracket 1010 to the vehicle body side.

The second fixed part 1022b fixes the second end part 1022a to the second support part 1013 by sandwiching the edge of the through hole 1013a in the plate thickness direction of the base main body part 1011.

The second fixed part 1022b is formed, for example, by crimping.

The second shaft main body part 1022c extends from the base bracket 1010 side towards the vehicle seat Se side. That is, the second shaft main body part 1022c extends parallel to the left-right direction of the vehicle seat Se.

In addition, the length of the portion protruding from the base bracket 1010 of the first shaft part 1021 is set to be longer than the length of the portion protruding from the base bracket 1010 of the second shaft part 1022.

The length of the portion protruding from the base bracket 1010 of the first shaft part 1021 is the length from the position in contact with the first support part 1012 of the first shaft part 1021 to the end on the connecting part 1023 side.

The length of the portion protruding from the base bracket 1010 of the second shaft part 1022 is the length from the position that contacts the second support part 1013 of the second shaft part 1022 to the end on the connecting part 1023 side.

The connecting part 1023 connects extending ends of the first shaft main body part 1021c and the second shaft main body part 1022c (end on opposite side of the base bracket 1010).

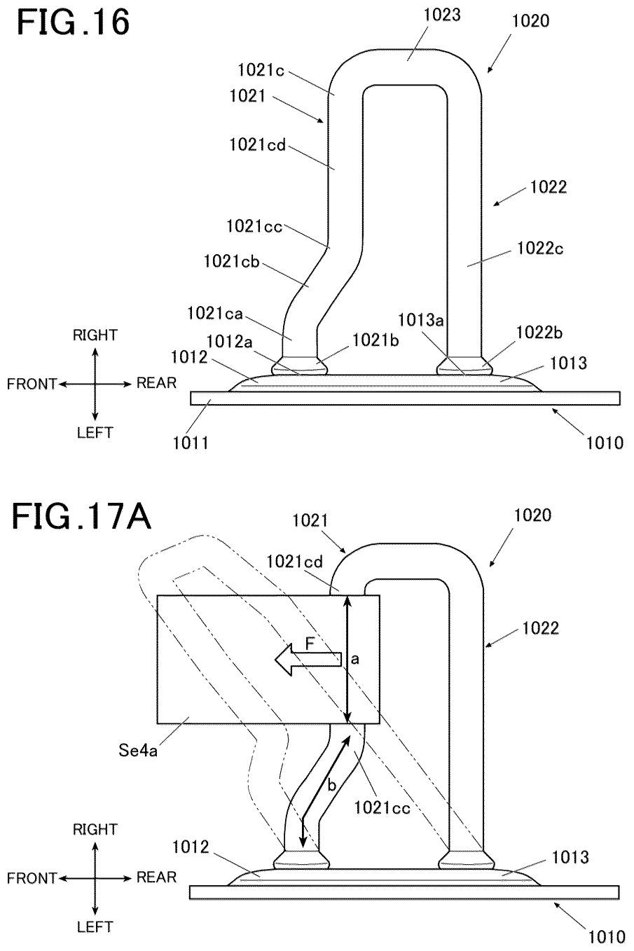

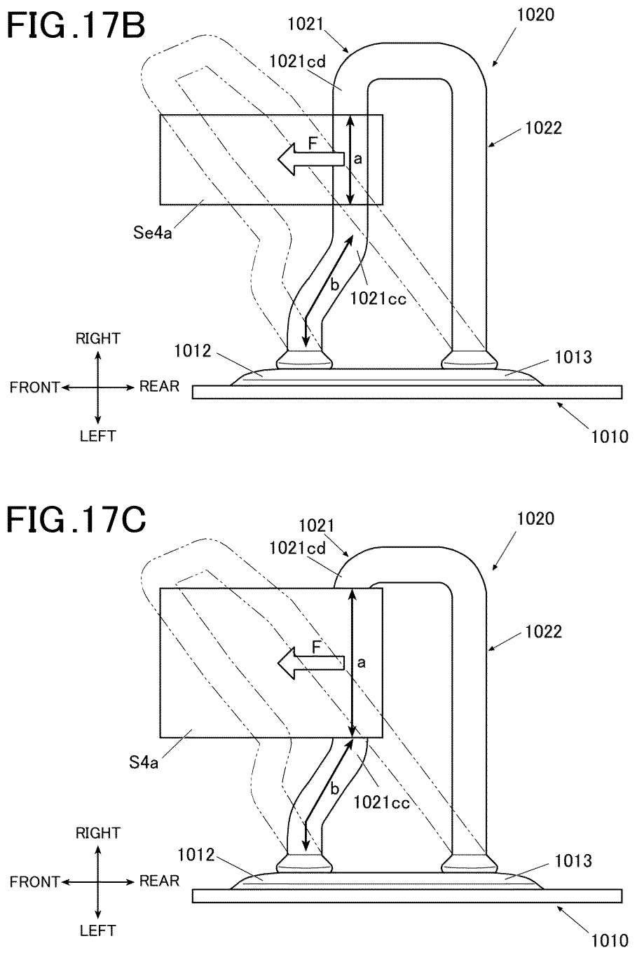

FIG. 17A shows how the rod 1020 of the striker 1001, constructed as described above, deforms under a load that exceeds a predetermined load.

The first shaft part 1021 of the rod 1020 engages with the lock member Se4a.

Specifically, as shown in FIG. 17A, the lock member Se4a engages with the third main body part 1021cd of the first shaft part 1021.

For example, when a frontal collision of the wheeled vehicle occurs, a load F caused by inertia acting on an upper body of the seated occupant restrained by the seat belt Se5 is input to the third main body part 1021cd via the lock member Se4a.

When the load F that is equal to or below the predetermined load is input to the third main body part 1021cd, the load F applied to the third main body part 1021cd acts to be supported by the first support part 1012 located in the forward direction of the vehicle seat Se than the third main body part 1021cd.

Specifically, the first support part 1012 is arranged in the forward direction of the vehicle seat Se, beyond the engagement part with the third main body part 1021cd and the lock member Se4a. As a result, the first support part 1012 functions like a brace due to this arrangement. Therefore, the first support part 1012 achieves a structure with higher support rigidity compared to when it is positioned further to the rear direction of the vehicle seat Se than the engagement part between the third main body part 1021cd and the lock member Se4a.

In other words, when the load applied to the striker 1001 is equal to or below the predetermined load, the first support part 1012 can efficiently support the rod 1020.

On the other hand, when the load F exceeding the predetermined load is input to the third main body part 1021cd, this acts in the direction in which the deformation part 1021cc extends, as shown by the two-dot dashed line in FIG. 17A, deforming so that the circumferences of the first shaft part 1021 and the second shaft part 1022 become equal. This allows the stress due to the load F to be distributed to the first support part 1012 and the second support part 1013.

In other words, the deformation part 1021cc makes it easier to deform the rod 1020, and this can suppress the rod 1020 from breaking due to stress caused by the load F.

In the conventional configuration without the deformation part in the rod, when the load F exceeding the predetermined load is input to the rod, the stress on the first support part 1012 is greater than that in this embodiment. Therefore, a reinforcement structure is required around the first support part 1012, leading to an increase in the number of parts and costs.

On the other hand, according to the present embodiment, since the rod 1020 includes the deformation part 1021cc, when the load F exceeding the predetermined load is input to the rod 1020, it is possible to deform the rod 1020 as shown by the two-dot chain line in FIG. 17A. As a result, some of the energy generated when the frontal collision of the wheeled vehicle occurs is consumed in the deformation of the rod 1020. Therefore, the shock can be absorbed by the seat locking device (lock unit Se4 and striker 1001), which can mitigate the shock experienced by the seated occupant.

As mentioned above, in this embodiment, the effect can be achieved by providing the rod 1020 with the deformation part 1021cc. In other words, it is possible to achieve the above effect without unnecessarily enlarging the seat locking device and without increasing parts such as reinforcing members.

In addition, as shown in FIG. 17A, the length of the engagement part between the third main body part 1021cd and the lock member Se4a is to be a, and the length from the deformation part 1021cc to the position where it contacts the first support part 1012 is to be b.

In the example shown in FIG. 17A, the lengths of a and b are equal.

In addition, regarding the lengths of a and b, as shown in FIG. 17B, b may be longer than a. Also, as shown in FIG. 17C, b may be shorter than a.

Next, the manufacturing method of the seat locking device (lock unit Se4 and striker 1001) is described. A worker first forms the rod 1020 to include the first shaft part 1021 including the deformation part 1021cc; the second shaft part 1022; and the connecting part 1023 (first process).

Next, the worker fixes the rod 1020 formed in the first process to the base bracket 1010 (second process).

The order of the first process and the second process may be reversed. That is, after fixing the rod 1020 to the base bracket 1010, the rod 1020 may be formed to include the first shaft part 1021 including the deformation part 1021cc; the second shaft part 1022; and the connecting part 1023.

As a result, the seat locking device including the striker 1001 is manufactured.

### Modification Example 1

Next, the modification example 1 of the above embodiment will be described.

The differences from the above embodiments are mainly described below.

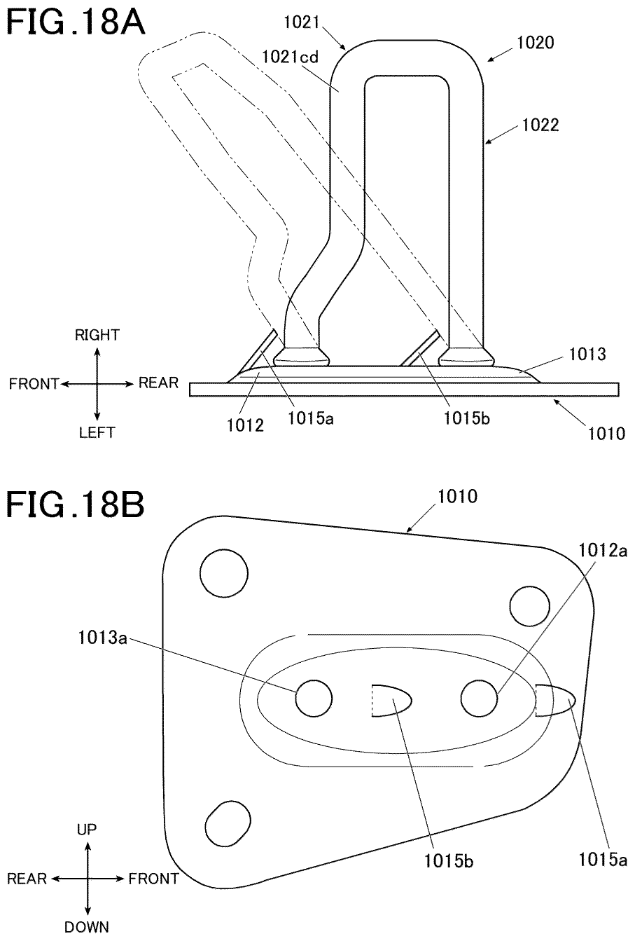

FIG. 18A and FIG. 18B show the striker 1001 of modification example 1.

FIG. 18A is a front view of the striker 1001. The two dotted chain line shown in FIG. 18A indicates that the load exceeding the predetermined load is input to the third main body part 1021cd, similar to FIG. 17A, and that the rod 1020 is in the deformed state.

FIG. 18B is a view of the striker 1001 from the right side of the vehicle seat Se. In FIG. 18B, the rod 1020 is omitted.

In the modification example 1, the base bracket 1010 further includes a first projecting portion 1015a (projecting portion) and a second projecting portion 1015b (projecting portion).

The first projecting portion 1015a is provided in the forward direction of the vehicle seat Se compared to the through hole 1012a.

The second projecting portion 1015b is provided in the forward direction of the vehicle seat Se compared to the through hole 1013a.

The first projecting portion 1015a and the second projecting portion 1015b according to this embodiment are formed by cutting out the base main body part 1011 of the base bracket 1010 in a U-shape, respectively. The broken line shown in FIG. 18B indicates the position where the first projecting portion 1015a and the second projecting portion 1015b are bent.

The first projecting portion 1015a and the second projecting portion 1015b may be formed by cutting the base main body part 1011 into a U-shape or M-shape, respectively. The angle to raise the first projecting portion 1015a can be any angle that can support the first shaft part 1021 of the deformed rod 1020, as shown in FIG. 18A.

The angle to raise the second projecting portion 1015b, can be any angle that can support the second shaft part 1022 of the deformed rod 1020, as shown in FIG. 18A.

In other words, the projecting portion (first projecting portion 1015a) is arranged in the direction in which the first shaft part 1021 falls when the load exceeding the predetermined load is input to the first shaft part 1021. In addition, the projecting portion (second projecting portion 1015b) is arranged in the direction in which the second axis 1022 falls when the load exceeding the predetermined load is input to the first shaft part 1021.

The first projecting portion 1015a and the second projecting portion 1015b, structured as described above, can support the first shaft part 1021 and the second shaft part 1022 when the rod 1020 is deformed. Therefore, it is possible to improve the strength of the striker 1001.

The first projecting portion 1015a and the second projecting portion 1015b may be formed by a separate member from the base bracket 1010.

Next, the manufacturing method of the seat locking device (lock unit Se4 and striker 1001) in modification example 1 is described.

The worker carries out the first process in the same manner as the above embodiment.

Next, the worker forms the first projecting portion 1015a and the second projecting portion 1015b on the base bracket 1010 (third process).

Next, the worker will carry out the second process in the same manner as the above embodiment.

The order of the first process, the third process, and the second process is not limited to the above example.

As a result, the seat locking device including striker 1001 of modification example 1 is manufactured.

### Modification Example 2

Next, the modification example 2 of the above embodiment will be described.

The differences from the above embodiments are mainly described below.

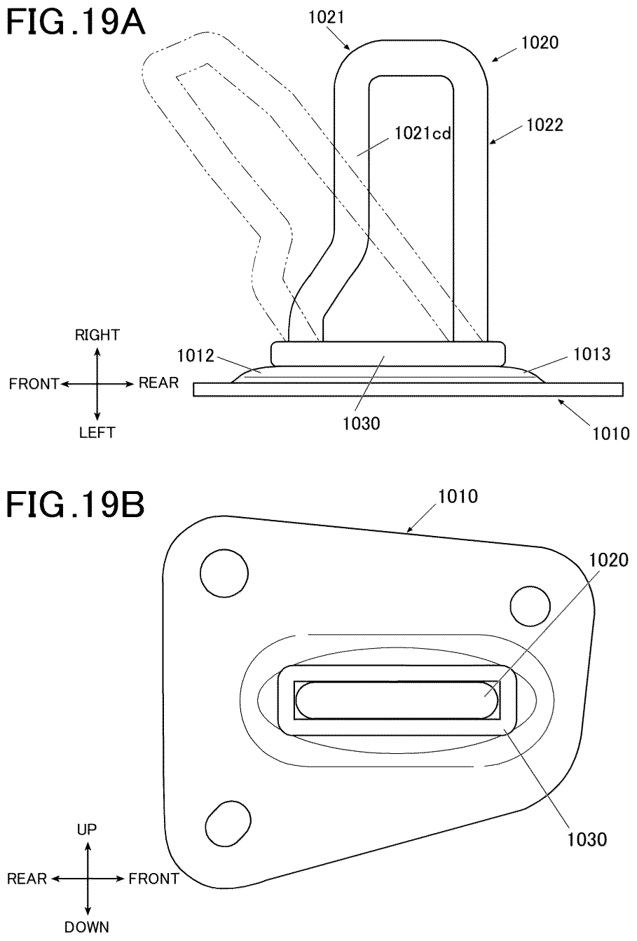

FIG. 19A and FIG. 19B show the striker 1001 of modification example 2.

FIG. 19A is a front view of striker 1001. The two dotted chain line shown in FIG. 19A indicates that the load exceeding the predetermined load is input to the third main body part 1021cd, similar to FIG. 18A, and that the rod 1020 is in the deformed state.

FIG. 19B is a view of the striker 1001 from the right side of the vehicle seat Se.

In modification example 2, the striker 1001 further includes a reinforcing member 1030.

The reinforcing member 1030 is configured to cover the circumferential surfaces of the first shaft part 1021 and the second shaft part 1022, and to be in contact with the first support part 1012 and the second support part 1013.

The reinforcing member 1030 is fixed to the base bracket 1010, for example, by welding.

The position where the reinforcing member 1030 is arranged is not limited to the examples shown in FIG. 19A and FIG. 19B, but it is preferable to be provided on the base bracket 1010 side rather than on the deformation part 1021cc. As a result, when a load exceeding the predetermined load is input to the third main body part 1021cd, this reinforces the first shaft part 1021 and the second shaft part 1022, while not inhibiting the rod 1020 from deforming due to the deformation part 1021cc.

Next, the manufacturing method of the seat locking device (lock unit Se4 and striker 1001) in modification example 2 is described.

The worker will carry out the first and second processes in the same manner as the above embodiment.

Next, the worker covers the circumferential surfaces of the first shaft part 1021 and the second shaft part 1022 with the reinforcing member 1030, and makes contact with the first support part 1012 and the second support part 1013 (fourth process).

Next, the worker fixes the reinforcing member 1030 to the base bracket 1010 (fifth step).

The order of the first and second processes is not limited to the above example.

As a result, the seat locking device including the striker 1001 of modification example 2 is manufactured.

As explained above, the seat locking device according to this embodiment includes the striker 1001 provided on the vehicle body, a lock unit Se4 that is provided on the vehicle seat Se and that holds the vehicle seat Se by engaging the striker 1001. The striker 1001 includes the base bracket 1010 that is attached to the vehicle body and the rod 1020 that is engaged by the lock unit Se4. The rod 1020 includes the first shaft part 1021, the second shaft part 1022, and the connecting part 1023 that connects the first shaft part 1021 and the second shaft part 1022. The first shaft part 1021 includes a deformation part 1021cc that deforms when the load exceeding the predetermined load is input to the first shaft part 1021. The base bracket 1010 includes the first support part 1012 that supports the first shaft part 1021 and the second support part 1013 that supports the second shaft part 1022. Therefore, in the vehicle seat Se, when the strong force is applied to pull the striker 1001 forward from the lock unit Se4 due to the load exceeding the predetermined load directed forward, the rod 1020 of the striker 1001 can absorb the load by deforming due to the deformation part 1021cc. In other words, it is possible to absorb shocks without increasing or enlarging the parts.

In the seat locking device according to the present embodiment, the lock unit Se4 is engaged with the first shaft part 1021 of the rod 1020, and the first support part 1012 is positioned in the front direction of the vehicle seat Se compared to the engagement part, which is the site where the lock unit Se4 is engaged with the first shaft part 1021.

Therefore, when the load on the striker 1001 is equal to or below the predetermined load, the first support part 1012 can efficiently support the rod 1020.

In the seat locking device according to the present embodiment, the lock unit Se4 is engaged with the first shaft part 1021 of the rod 1020, and the length of the engagement portion, where the lock unit Se4 is engaged with the first shaft part 1021, is equal to the length from the deformation part 1021cc of the first shaft part 1021 to the position where it contacts the first support part 1012.

Therefore, even in a configuration where the length of the engagement part of the lock unit Se4 and the first shaft part 1021 is equal to the length from the deformation part 1021cc in the first shaft part 1021 to the position where it contacts the first support part 1012, the rod 1020 of the striker 1001 can absorb the load by deforming.

In the seat locking device according to the present embodiment, the lock unit Se4 is engaged with the first shaft part 1021 of the rod 1020, and the length of the engagement portion, where the lock unit Se4 is engaged with the first shaft part 1021, is shorter than the length from the deformation part 1021cc of the first shaft part 1021 to the position where it contacts the first support part 1012. Therefore, even in a configuration where the length of the engagement part of the lock unit Se4 and the first shaft part 1021 is shorter than the length from the deformation part 1021cc in the first shaft part 1021 to the position where it contacts the first support part 1012, the rod 1020 of the striker 1001 can absorb the load by deforming.

In the seat locking device according to the present embodiment, the lock unit Se4 is engaged with the first shaft part 1021 of the rod 1020, and the length of the engagement portion, where the lock unit Se4 is engaged with the first shaft part 1021, is longer than the length from the deformation part 1021cc of the first shaft part 1021 to the position where it contacts the first support part 1012. Therefore, even in a configuration where the length of the engagement part of the lock unit Se4 and the first shaft part 1021 is longer than the length from the deformation part 1021cc in the first shaft part 1021 to the position where it contacts the first support part 1012, the rod 1020 of the striker 1001 can absorb the load by deforming.

In the seat locking device of the present embodiment, the base bracket 1010 is equipped with projecting portions (first projecting portion 1015a, second projecting portion 1015b), and the projecting portions are arranged in a direction where the first shaft part 1021 or the second shaft part 1022 falls when the load exceeding the predetermined load is input to the first shaft part 1021.

Therefore, when the rod 1020 of the striker 1001 is deformed, this can support the first shaft part 1021 or the second shaft part 1022 due to the projecting portion, thereby improving the strength of the striker 1001.

In addition, the seat locking device according to the present embodiment is equipped with the reinforcing member 1030 that covers the circumferential surfaces of the first shaft part 1021 and the second shaft part 1022, and the reinforcing member 1030 is positioned on the base bracket 1010 side, than the deformation part 1021cc.

Therefore, while reinforcing the first shaft part 1021 and the second shaft part 1022 with the reinforcing member 1030, the rod 1020 does not hinder deformation due to the deformation part 1021cc.

Next, the manufacturing method of the seat locking device according to the present embodiment is described. That is, the manufacturing method of the seat locking device including the striker 1001 provided on the vehicle body, a lock unit Se4 that is provided on the vehicle seat Se and that holds the vehicle seat Se by engaging the striker 1001. The striker 1001 includes the base bracket 1010 that is attached to the vehicle body and the rod 1020 that is engaged by the lock unit Se4. The rod 1020 includes the first shaft part 1021, the second shaft part 1022, and the connecting part 1023 that connects the first shaft part 1021 and the second shaft part 1022. The first shaft part 1021 includes a deformation part 1021cc that deforms when the load exceeding the predetermined load is input to the first shaft part 1021. The base bracket 1010 includes the first support part 1012 that supports the first shaft part 1021 and the second support part 1013 that supports the second shaft part 1022 is the manufacturing method including the first process that forms the rod 1020 and the second process that fixes the rod 1020 to the base bracket 1010.

Therefore, it is possible to manufacture the seat locking device so that in the vehicle seat Se, when the strong force is applied to pull the striker 1001 forward from the lock unit Se4 due to the load exceeding the predetermined load directed forward, the rod 1020 the striker 1001 can absorb the load by deforming due to the deformation part 1021cc. In other words, it is possible to manufacture a seat locking device that can absorb shocks without increasing the number of parts or making them larger.

In the manufacturing method of the seat locking device according to the present embodiment, the lock unit Se4 is engaged with the first shaft part 1021 of the rod 1020, and the first support part 1012 is positioned in the front direction of the vehicle seat Se compared to the engagement part, which is the site where the lock unit Se4 is engaged with the first shaft part 1021.

Therefore, it is possible to manufacture the seat locking device so that when the load on the striker 1001 is equal to or below the predetermined load, the first support part 1012 can efficiently support the rod 1020.

In the manufacturing method of the seat locking device according to the present embodiment, the lock unit Se4 is engaged with the first shaft part 1021 of the rod 1020, and the length of the engagement portion, where the lock unit Se4 is engaged with the first shaft part 1021, is equal to the length from the deformation part 1021cc of the first shaft part 1021 to the position where it contacts the first support part 1012.

Therefore, it is possible to manufacture the seat locking device with a configuration where the length of the engagement part of the lock unit Se4 and the first shaft part 1021 is equal to the length from the deformation part 1021cc in the first shaft part 1021 to the position where it contacts the first support part 1012, and the rod 1020 of the striker 1001 can absorb the load by deforming.

In the manufacturing method of the seat locking device according to the present embodiment, the lock unit Se4 is engaged with the first shaft part 1021 of the rod 1020, and the length of the engagement portion, where the lock unit Se4 is engaged with the first shaft part 1021, is shorter than the length from the deformation part 1021cc of the first shaft part 1021 to the position where it contacts the first support part 1012.

Therefore, it is possible to manufacture the seat locking device with a configuration where the length of the engagement part of the lock unit Se4 and the first shaft part 1021 is shorter than the length from the deformation part 1021cc in the first shaft part 1021 to the position where it contacts the first support part 1012, and the rod 1020 of the striker 1001 can absorb the load by deforming.

In the manufacturing method of the seat locking device according to the present embodiment, the lock unit Se4 is engaged with the first shaft part 1021 of the rod 1020, and the length of the engagement portion, where the lock unit Se4 is engaged with the first shaft part 1021, is longer than the length from the deformation part 1021cc of the first shaft part 1021 to the position where it contacts the first support part 1012.

Therefore, it is possible to manufacture the seat locking device with a configuration where the length of the engagement part of the lock unit Se4 and the first shaft part 1021 is longer than the length from the deformation part 1021cc in the first shaft part 1021 to the position where it contacts the first support part 1012, and the rod 1020 of the striker 1001 can absorb the load by deforming.

In addition, the manufacturing method of the seat locking device according to the present embodiment includes a third process 41 forming projecting portions (first projecting portion 1015a, second projecting portion 1015b) on the base bracket 1010, and the projecting portions are arranged in a direction in which the first shaft part 1021 or the second shaft part 1022 falls when the load exceeding the predetermined load is applied to the first shaft part 1021.

Therefore, it is possible to manufacture the seat locking device so that when the rod 1020 of the striker 1001 is deformed, this can support the first shaft part 1021 or the second shaft part 1022 due to the projecting portion, thereby improving the strength of the striker 1001.

In addition, the manufacturing method of the seat locking device according to the present embodiment includes a fourth step of covering the circumferential surfaces of the first shaft part 1021 and the second shaft part 1022 with the reinforcing member 1030, and the reinforcing member 1030 is arranged on the base bracket 1010 side than the deformation part 1021cc.

Therefore, it is possible to manufacture the seat locking device so that while reinforcing the first shaft part 1021 and the second shaft part 1022 with the reinforcing member 1030, the rod 1020 does not hinder deformation due to the deformation part 1021cc.

The embodiments applicable to the present invention are not limited to the embodiments described above and can be appropriately modified without departing from the spirit of the present invention.

For example, the present invention has been described using the vehicle seat Se installed in wheeled vehicles such as automobiles, but the present invention is also applicable to seats for vehicles other than wheeled vehicles such as ships and aircrafts.

In the above embodiment, the lock unit Se4 is attached on the upper part portion of the seat back Se1, but the configuration is not limited to this. The lock unit Se4 and the striker 1001 can be installed at designated positions on the vehicle body, such as passenger doors, vehicle seats, wheeled vehicle doors (like the back door of a one-box wheeled vehicle), a trunk, and hood. Either the lock unit Se4 or the striker 1001 can be installed on the moving side, while the other can be installed on the fixed side.

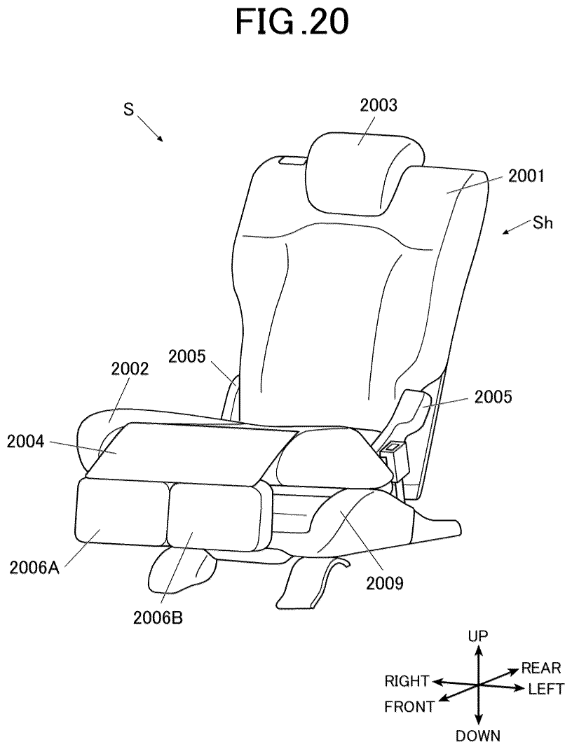

Embodiments Related to Wheeled Vehicle Seat Based on FIG. 20 to FIG. 47B, configurations of embodiments related to wheeled vehicle seats will be explained with reference to the drawings. However, the embodiments described below are intended to facilitate the understanding of the invention related to wheeled vehicle seats and do not limit the invention related to wheeled vehicle seats. That is, the invention related to wheeled vehicle seats can be modified and improved without deviating from its purpose, and of course, its equivalents are included in the invention related to wheeled vehicle seats.

In addition, the materials, shapes, and sizes of the seat components mentioned in the following description are merely one specific example and do not limit the invention related to wheeled vehicle seats.

The present embodiment has industrial applicability to wheeled vehicle seats.

[Background Art of Present Embodiment] Traditionally, a wheeled vehicle seat is known to have a detachable ottoman configuration, allowing the removed ottoman to be attached to a seat cushion or seat back. In this case, the ottoman can function as a passenger supporter.

For example, the international publication No. 2019/065773 describes an application of a detachable plate member for an ottoman equipped with a wheeled vehicle seat. Specifically, it is possible to prevent cargos placed on the wheeled vehicle seat from collapsing and to prevent passengers from colliding with each other during cornering by attaching the ottoman (plate member) to the seat back or seat cushion.

[Problem to be Solved by Present Embodiment] However, in the disclosed technology, users such as passengers of a wheeled vehicle had no way to determine whether the ottoman (plate member) is properly attached to the seat back or seat cushion. As a result, there was a possibility that even if the user considered that the ottoman was attached to the seat back or seat cushion, the ottoman was not properly installed.

The present embodiment has been conceived in light of the circumstances mentioned above, and aims to provide a wheeled vehicle seat in which the user can recognize whether a passenger supporter is properly installed.

[Solution to Problem] To solve the above problems, the wheeled vehicle seat according to Solution 1 includes, a first member and a second member as passenger supporters locked to a lock mechanism provided on a vehicle body or a wheeled vehicle seat, a first indicator indicating a locked state of the first member, and a second indicator indicating a locked state of the second member.

Solution 2 is the wheeled vehicle seat according to Solution 1, wherein,
the first member is provided on one side of the wheeled vehicle seat,
the second member is provided on the other side of the wheeled vehicle seat,
the first indicator is provided on one side of the wheeled vehicle seat, and
the second indicator is provided on the other side of the wheeled vehicle seat.

Solution 3 is the wheeled vehicle seat according to Solution 1, wherein,
the first indicator and the second indicator are provided adjacent to each other.

Solution 4 is the wheeled vehicle seat according to Solution 1, wherein,
a distance between the first indicator and the second indicator is shorter than a distance between the first member and the second member.

Solution 5 is the wheeled vehicle seat according to Solution 1,
further including a seat cushion,
wherein the first indicator and the second indicator are provided on the front side of the wheeled vehicle seat in the seat cushion, and on the central side inside the wheeled vehicle.

Solution 6 is the wheeled vehicle seat according to Solution 2, wherein,
the first indicator is covered by the first cover member,
the second indicator is covered by the second cover member.

Solution 7 is the wheeled vehicle seat according to Solution 3, wherein
the first indicator and the second indicator are covered with a common cover member.

Solution 8 is the wheeled vehicle seat according to Solution 1, further including,
a first connecting member that connects the first indicator and a first lock mechanism in which the first member is locked among the lock mechanism,
wherein, the first indicator includes,
a first display section that indicates the unlocked state of the first member and the first lock mechanism,
a second display section that indicates the locked state between the first member and the first lock mechanism, and
a biasing member that biases so that the first display section is displayed,
when the first member is locked to the first lock mechanism, the first connecting member is pulled toward the first lock mechanism side, thereby not displaying the first display section against the urging member, while displaying the second display section, and
a second connecting member that connects the second indicator and the second lock mechanism in which the second member is locked among the lock mechanisms,
wherein the second indicator includes,
a third display section that indicates an unlocked state of the second member and the second lock mechanism,
a fourth display section that indicates the locked state between the second member and the second lock mechanism, and
a biasing member that biases so that the third display section is displayed,
when the second member is locked to the second lock mechanism, the second connecting member is pulled toward the second lock mechanism side, thereby not displaying the third display section against the biasing member, while displaying the fourth display section.

Solution 9 is the wheeled vehicle seat according to Solution 1, wherein the first member and the second member are armrests.

Solution 10 is the wheeled vehicle seat according to Solution 1, wherein the first member and the second member are side supports.

[Effect of Solution] According to solution 1, it is possible to indicate the locked state of the lock mechanism of the first member and the second member, respectively. In other words, users such as passengers can recognize whether the passenger supporter (first member and second member) are properly installed.

According to solution 2, a positional relationship between the first member and the first indicator provided on one side, as well as the positional relationship between the second member and the second indicator provided on the other side are consistent. As a result, users can easily recognize the locked state of the first member and second member.

According to solution 3, the user can recognize both the first indicator and the second indicator at the same time.

According to solution 4, the first indicator and the second indicator are placed in a close region within a predetermined distance, allowing the user to recognize both the first indicator and second indicator at once.

According to solution 5, when checking the first indicator and the second indicator from the front direction of the wheeled vehicle seat, the user in the front direction of the wheeled vehicle seat can easily recognize the first indicator and the second indicator.

In the above case, for example, it is when checking the first indicator and second indicator provided in the wheeled vehicle seat which is a rear part seat from the driver's seat.

According to solution 6, it is possible to cover the first indicator and the second indicator with separate cover members.

According to solution 7, compared to a configuration where the first indicator and the second indicator are covered with separate cover members, it is possible to reduce the number of parts.

According to solution 8, the indicator can be made with a simple configuration.

According to solution 9, it is possible to indicate the locked state of the lock mechanism when the first member and the second member function as armrests.

According to solution 10, it is possible to indicate the locked state of the lock mechanism when the first member and the second member function as side supports.

[Contents of Embodiment Related to Wheeled Vehicle Seat] Below, as an example of a wheeled vehicle seat, we will describe a configuration example of a wheeled vehicle seat. However, this embodiment can also be applied to seats for vehicles other than wheeled vehicle seats, for example, seats mounted on a ship or an aircraft.

In addition, in the following description, “front-rear direction” refers to a front-rear direction of the wheeled vehicle seat (in other words, the front-rear direction of a seat body) and is the direction that coincides with the direction of travel during manual operation of the wheeled vehicle. The term “seat width direction” refers to a lateral width direction of the wheeled vehicle seat (in other words, the width direction of the seat body), and is the direction that coincides with the left-right direction as seen by a passenger seated in the wheeled vehicle seat. Also, the “up-down direction” refers to the vertical direction of the wheeled vehicle seat, which aligns with the vertical direction when the wheeled vehicle is traveling on a horizontal plane.

In addition, an “outer side of vehicle” in the seat width direction refers to the side that is closer to the outside of the vehicle body (more easily understood as the side closer to the nearest door), while the “inner side of vehicle” refers to the side that is closer to the inside of the vehicle body (more easily understood as the side farther from the nearest door).

First, the configuration of the wheeled vehicle seat S according to the present embodiment is described.

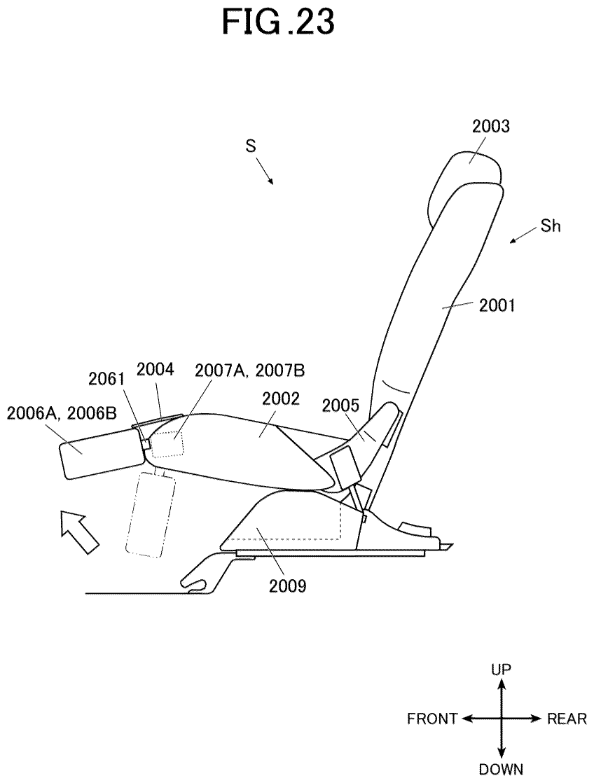

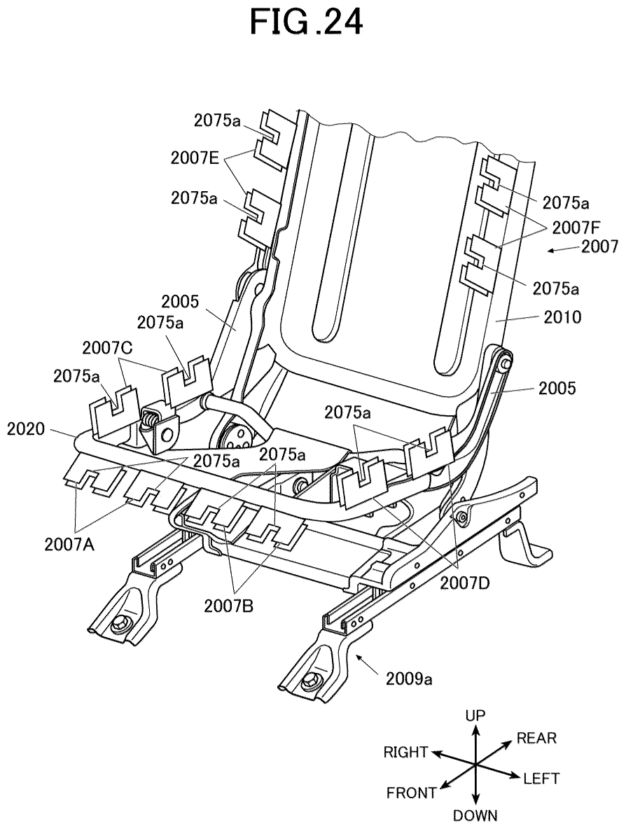

FIG. 20 to FIG. 22 are perspective views of a wheeled vehicle seat S. FIG. 23 is a side view of the wheeled vehicle seat S shown in FIG. 20. FIG. 24 is a diagram showing a seat frame (seat back frame 2010 and seat cushion frame 2020) that the wheeled vehicle seat S has.

The wheeled vehicle seat S is placed on a vehicle body floor and is the seat for the wheeled vehicle passenger to sit on. In this embodiment, the wheeled vehicle seat S is used as a rear seat corresponding to the rear part seat of the wheeled vehicle. However, this is not limited to this, and the wheeled vehicle seat S can also be used as a middle seat in a second row or a rear seat in a third row in wheeled vehicles equipped with three rows of seats in the front-rear direction.

The wheeled vehicle seat S includes a seat body Sh that forms its main body, a supporter 2009a, and a base cover 2009, as shown in FIG. 20 to FIG. 24.

The supporter 2009a is fixed on the vehicle body floor and supports the seat back 2001.

The base cover 2009 is positioned below the seat body Sh and covers the supporter 2009a from above.

The seat body Sh is equipped with a seat back 2001, a seat cushion 2002, and a headrest 2003, as shown in FIG. 20 to FIG. 23.

The seat back 2001 supports a lower back and back of a passenger seated in the seat (hereinafter referred to as a seated occupant).

The seat back 2001 includes a metal seat back frame 2010 that forms a skeleton of the seat back 2001, a cushion pad (not shown), and a cover.

The seat back frame 2010 is covered with a cushion pad made of relatively soft resin foam such as urethane foam.

The cushion pad of the seat back 2001 is covered by a cover made of leather, woven fabric, etc.

The seat cushion 2002 supports buttocks and thighs of the seated occupant.

The seat cushion 2002 is equipped with a metal seat cushion frame 2020 that forms the skeleton of the seat cushion 2002, the cushion pad (not shown), and the cover.

The seat cushion frame 2020 is covered with a cushion pad made of relatively soft resin foam such as urethane foam. The cushion pad of the seat cushion 2002 is covered by a cover made of leather, woven fabric, etc. similar to the Seat back 2001.

The seat cushion 2002 is connected at its rear end to the lower end of the seat back 2001 by the connecting member 2005.

In addition, the wheeled vehicle seat S includes a surface member 2004, a detachable first member 2006A and a second member 2006B, and a lock mechanism 2007.

In the examples shown in FIG. 20 and FIG. 23, the first member 2006A and the second member 2006B function as an ottoman serving as a passenger supporter. A mode of the wheeled vehicle seat S shown in FIG. 20 and FIG. 23 is set to an ottoman specification mode.

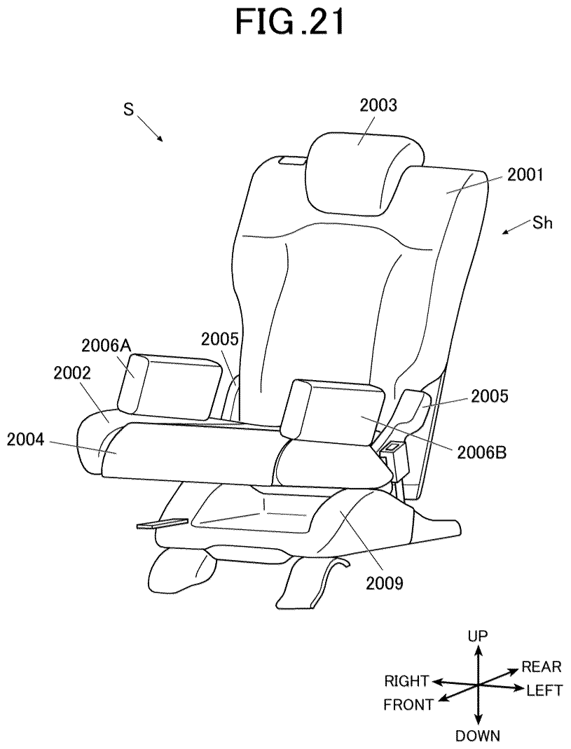

In the example shown in FIG. 21, the first member 2006A and the second member 2006B function as armrests as passenger supporters. A mode of the wheeled vehicle seat S shown in FIG. 21 is set to an armrest specification mode.

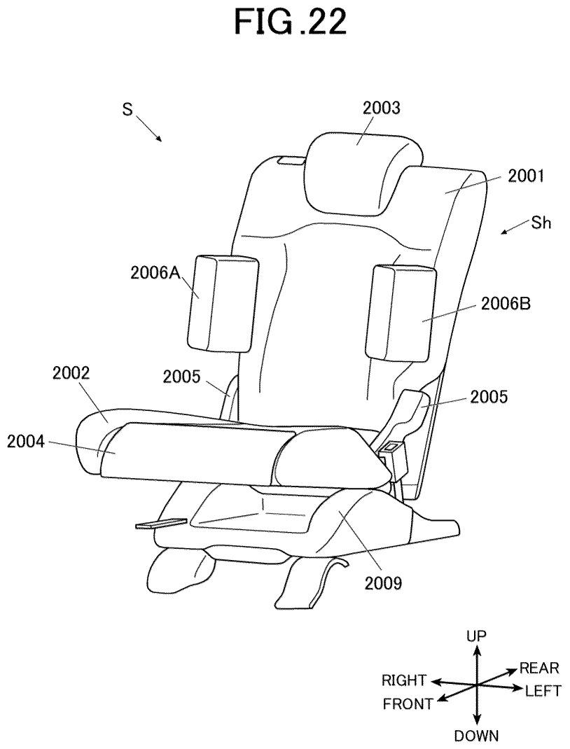

In the example shown in FIG. 22, the first member 2006A and the second member 2006B function as side supports as passenger supporters. A mode of the wheeled vehicle seat S shown in FIG. 22 is set to a side support specification mode.

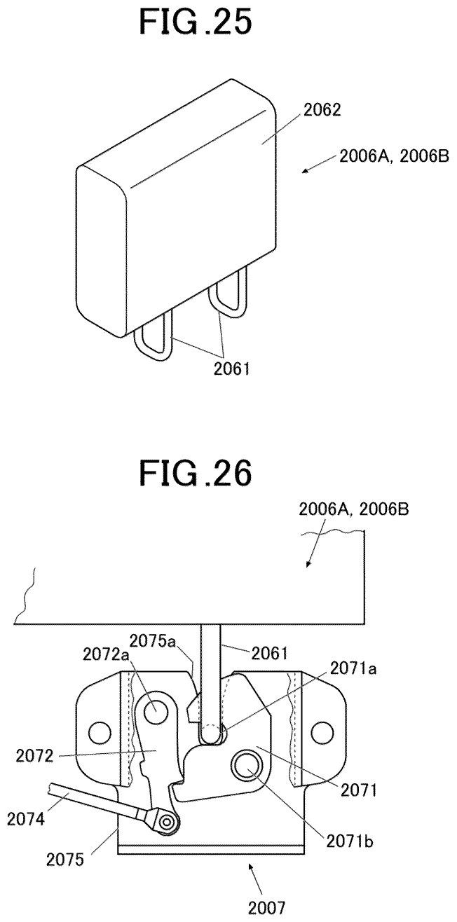

The first member 2006A and the second member 2006B each have a connecting part 2061 and a cushion part 2062, as shown in FIG. 25.

The connecting part 2061 is a U-shaped striker for connecting to the lock mechanism 2007.

In this embodiment, the first member 2006A and the second member 2006B each have two U-shaped strikers, as shown in FIG. 25.

The cushion part 2062 is equipped with a metal frame (not shown), a cushion pad that covers the frame (not shown), and a cover that covers the cushion pad.

The lock mechanism 2007 includes a latch 2071, a ratchet 2072, a connecting member 2074, a base plate 2075, and so on, as shown in FIG. 26.

The base plate 2075 includes an entrance groove 2075a into which the connecting part 2061 of the first member 2006A or the second member 2006B enters. The entrance groove 2075a includes an opening only in one side of its length direction. The base plate 2075 is rotatably attached to the latch 2071 by the rotation axis 2071b. The latch 2071 is biased in the clockwise direction in FIG. 26 by an unillustrated biasing member such as a tension coil spring.

The latch 2071 includes an engagement groove 2071a that abuts and engages with the connecting part 2061 of the first member 2006A or the second member 2006B.

The ratchet 2072 is configured to be rotatable around the rotation axis 2072a with respect to the base plate 2075.

The ratchet 2072 is a component that maintains a locked state by engaging with the latch 2071 and maintains an unlocked state by disengaging from the latch 2071.

In the unlocked state, when the connecting part 2061 is inserted into the entrance groove 2075a of the base plate 2075, the connecting part 2061 comes into contact with the inner circumference of the engagement groove 2071a of the latch 2071, and the latch 2071 rotates counterclockwise in FIG. 26 against the elasticity of the urging member (not shown), engaging with the ratchet 2072 and becoming the locked state. Then, the rotation of latch 2071 is regulated by ratchet 2072.

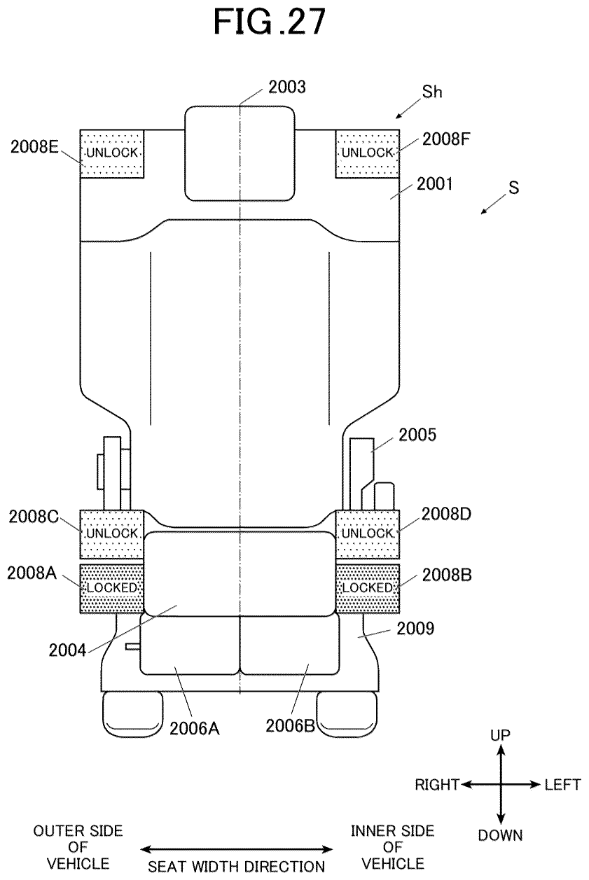

The connecting member 2074 is connected at one end to the ratchet 2072, and the other end is connected to the indicator 2008 (see FIG. 27 to FIG. 31A and FIG. 31B) mentioned later, serving as a member that conveys the operation of the ratchet 2072 to the indicator 2008.

As the connecting member 2074, for example, cables, rods, etc. are used.

The lock mechanism 2007 includes the lock mechanisms 2007A to 2007F shown in FIG. 24.

The lock mechanisms 2007A to 2007F are fixed to the seat back frame 2010 or the seat cushion frame 2020, as shown in FIG. 24.

Specifically, in the ottoman specification mode, the lock mechanism 2007A that connects to the connecting part 2061 of the first member 2006A is fixed to the right side of the front part of the seat cushion frame 2020, on the side opposite to where the entrance groove 2075a is formed.

In the ottoman specification mode, the lock mechanism 2007B that connects to the connecting part 2061 of the second member 2006B is fixed on the left side of the front part of the seat cushion frame 2020, on the side opposite to where the entrance groove 2075a is formed.

The lock mechanisms 2007A and 2007B are fixed to the front of the pipe frame, which is the seat cushion frame 2020, as shown in FIG. 24.

In addition, the lock mechanism 2007C that connects to the connecting part 2061 of the first member 2006A in the armrest specification mode is fixed to the right part of the seat cushion frame 2020 on the side opposite to where the entrance groove 2075a is formed.

In the armrest specification mode, the lock mechanism 2007D that connects to the connecting part 2061 of the second member 2006B is fixed to the left part of the seat cushion frame 2020 on the side opposite to where the entrance groove 2075a is formed.

The lock mechanisms 2007C and 2007D are fixed to the upper surface of the pipe frame, which is the seat cushion frame 2020, as shown in FIG. 24.

In addition, the lock mechanism 2007E that connects to the connecting part 2061 of the first member 2006A in the side support specification mode is fixed to the right part of the seat back frame 2010 on the side opposite to where the entrance groove 2075a is formed.

In the side support specification mode, the lock mechanism 2007F that connects to the connecting part 2061 of the second member 2006B is fixed to the left part of the seat back frame 2010 on the side opposite to where the entrance groove 2075a is formed.

The lock mechanisms 2007E and 2007F are fixed to the front of the pipe frame, which is the seat back frame 2010, as shown in FIG. 24.

In other words, the first member 2006A is connected to the lock mechanism 2007A, the lock mechanism 2007C, or the lock mechanism 2007E. That is, the first member 2006A is provided on one side (right side) of the wheeled vehicle seat S.

In addition, the second member 2006B is connected to the lock mechanism 2007B, the lock mechanism 2007D, or the lock mechanism 2007F. That is, the second member 2006B is provided on the other side (left side) of the wheeled vehicle seat S.

In the ottoman specification mode, the first member 2006A connected to the lock mechanism 2007A and the second member 2006B connected to the lock mechanism 2007B may be configured to change the angle with respect to the seat cushion 2002, as shown in FIG. 23.

The surface member 2004 is made of materials similar to covers such as leather and woven fabric.

In the ottoman specification mode, the surface member 2004 is fixed to be replaceable by known methods such as fasteners (flat, linear), with one end attached to the seat cushion 2002 and the other end attached to the first member 2006A and the second member 2006B, as shown in FIG. 20 and FIG. 23. In this case, the surface member 2004 makes it so that the connection portion between the connecting part 2061 and the lock mechanism 2007 is not visible from the upward and forward directions.

In addition, in the armrest specification mode and the side support specification mode, the surface member 2004 is fixed at one end and the other end to the seat cushion 2002 in a replaceable manner by known methods such as a fastener (flat, linear) as shown in FIG. 21 and FIG. 22.

In addition, the wheeled vehicle seat S includes an indicator 2008 as shown in FIG. 27 to FIG. 30.

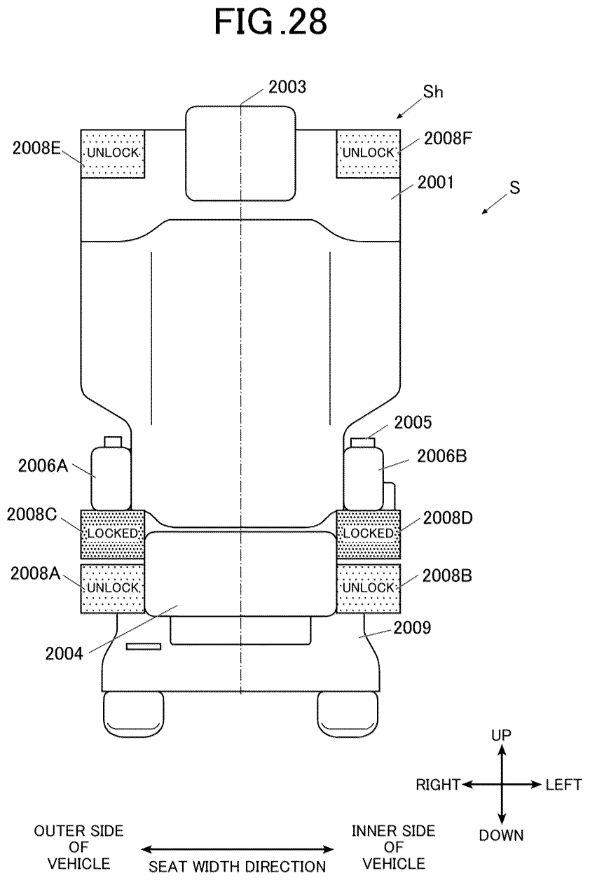

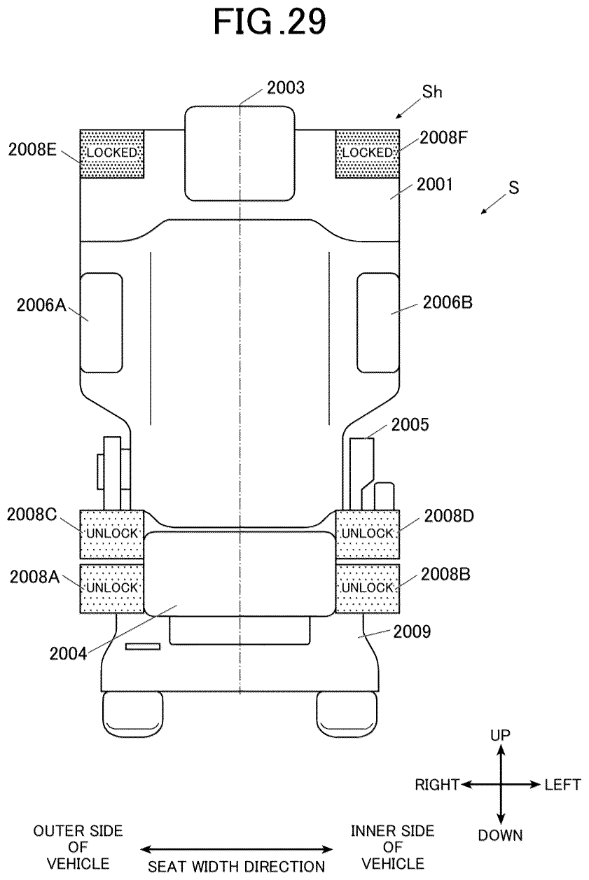

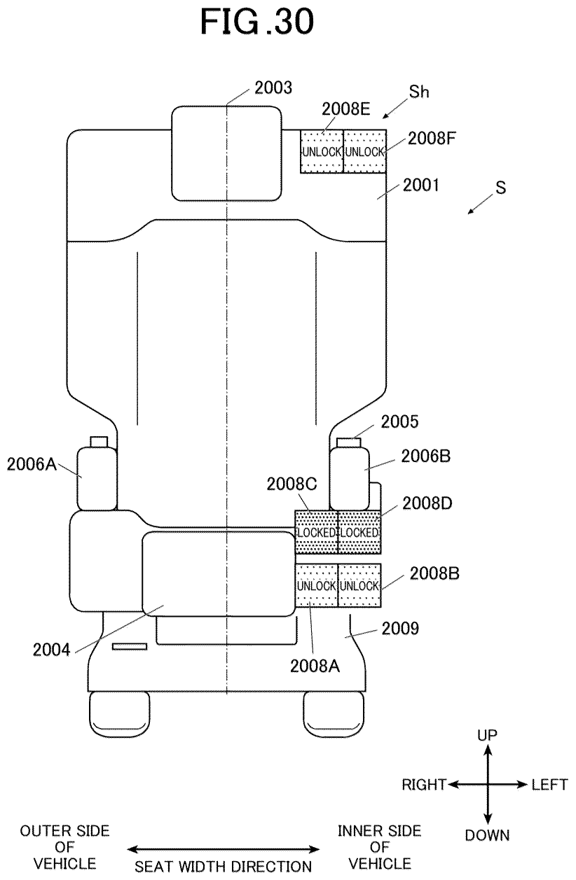

FIG. 27 is a front view of the wheeled vehicle seat S in the ottoman specification mode shown in FIG. 20. FIG. 28 is a front view of the wheeled vehicle seat S in the armrest specification mode shown in FIG. 21. FIG. 29 is a front view of the wheeled vehicle seat S in the side support specification mode shown in FIG. 22. FIG. 30 is another example of the front view of the wheeled vehicle seat S in the armrest specification mode shown in FIG. 21.

In FIG. 27 to FIG. 30, the right side of the wheeled vehicle seat S is defined as the outer side of the vehicle in the seat width direction, and the left side of the wheeled vehicle seat S is defined as the inner side of the vehicle in the seat width direction.

The indicator 2008 includes indicators 2008A to 2008F, as shown in FIG. 27 to FIG. 30.

The indicator 2008A indicates whether the connecting part 2061 of the first member 2006A and the lock mechanism 2007A are properly connected.

In the examples shown in FIG. 27 to FIG. 29, the indicator 2008A is provided on the right side of the seat cushion 2002.

In addition, the indicator 2008B shows whether the connecting part 2061 of the second member 2006B and the lock mechanism 2007B are properly connected.

In the examples shown in FIG. 27 to FIG. 29, the indicator 2008B is provided on the left side of the seat cushion 2002.

In addition, the indicator 2008C shows whether the connecting part 2061 of the first member 2006A and the lock mechanism 2007C are properly connected.

In the examples shown in FIG. 27 to FIG. 29, the indicator 2008C is provided on the right side of the seat cushion 2002 and above the indicator 2008A.

In addition, the indicator 2008D shows whether the connecting part 2061 of the second member 2006B and the lock mechanism 2007D are properly connected.

In the examples shown in FIG. 27 to FIG. 29, the indicator 2008D is provided on the left side of the seat cushion 2002 and above the indicator 2008B.

In addition, the indicator 2008E shows whether the connecting part 2061 of the first member 2006A and the lock mechanism 2007E are properly connected.

In the examples shown in FIG. 27 to FIG. 29, the indicator 2008E is provided on the right side of the seat back 2001.

In addition, the indicator 2008F shows whether the connecting part 2061 of the second member 2006B and the lock mechanism 2007F are properly connected.

In the examples shown in FIG. 27 to FIG. 29, the indicator 2008F is provided on the left side of the seat back 2001.

In other words, the first indicators (indicator 2008A, indicator 2008C, indicator 2008E) are provided on one side (right side) of the wheeled vehicle seat S.

In addition, the second indicators (indicator 2008B, indicator 2008D, indicator 2008F) are provided on the other side (left side) of the wheeled vehicle seat S.

Therefore, the positional relationship between the first member 2006A provided on one side and the first indicator, as well as the positional relationship between the second member 2006B provided on the other side and the second indicator, are consistent. As a result, users can easily recognize the locked state of the first member 2006A and the second member 2006B.

In addition, the indicators 2008A to 2008D are provided on the front part of the seat cushion 2002. The indicator 2008E and the indicator 2008F are provided on the front part of the seat back 2001. As a result, users such as drivers can easily see the display of indicators 2008A to 2008F from the front direction of the wheeled vehicle seat S.

The position where the indicator 2008 is set is not limited to the above example. The indicator 2008 may be provided on the front part below the seat back 2001 or on the front part of the base cover 2009. In this case, users such as drivers can easily see the display of indicators 2008A to 2008F from the front direction of the wheeled vehicle seat S.

In addition, at least two of the indicators 2008 among the indicators 2008A to 2008F may be provided adjacent to each other on the wheeled vehicle seat S.

In other words, the first indicator and second indicator among the indicators 2008A to 2008F are provided adjacent to each other.

FIG. 30 shows a front view of a wheeled vehicle seat S in the armrest specification mode, where the first indicator and the second indicator are provided adjacent to each other.

In the example shown in FIG. 30, the indicator 2008A and the indicator 2008B are adjacent, the indicator 2008C and the indicator 2008D are adjacent, and the indicator 2008E and the indicator 2008F are adjacent, all provided on the wheeled vehicle seat S.

This allows users to recognize both the first indicator and the second indicator at the same time.

In addition, at least two of the indicators 2008 among the indicators 2008A to 2008F may be provided on the wheeled vehicle seat S at a spacing shorter than the distance between the first member 2006A and the second member 2006B. In other words, the distance between the first indicator and the second indicator of the indicators 2008A to 2008F provided on the wheeled vehicle seat S is shorter than the distance between the first member 2006A and the second member 2006B.

As a result, the first indicator and the second indicator are placed in a close region within a predetermined distance, allowing the user to recognize both the first indicator and second indicator at once.

In the example shown in FIG. 30, the indicators 2008A to 2008F are provided on the inner side of the vehicle in the wheeled vehicle seat S.

That is, the first indicator and the second indicator are provided on the front side of the wheeled vehicle seat S in the seat cushion 2002, and on the central side (inner side of the vehicle) of the wheeled vehicle.

As a result, users such as drivers can easily see the display of indicators 2008A to 2008F from the front direction of the wheeled vehicle seat S.

Next, the display of the indicator 2008 will be described.

The indicator 2008 displays “LOCKED” when the connecting part 2061 and the lock mechanism 2007 are properly connected.

On the other hand, the indicator 2008 displays “UNLOCK” when the connecting part 2061 and the lock mechanism 2007 are not connected.

In the example shown in FIG. 27, the connecting part 2061 of the first member 2006A and the lock mechanism 2007A are properly connected, so the indicator 2008A displays “LOCKED.”

In addition, since the connecting part 2061 of the second member 2006B and the lock mechanism 2007B are properly connected, the indicator 2008B displays “LOCKED.”

Since the lock mechanism 2007C to 2007F is not connected to the connecting part 2061, the indicators 2008C to 2008F display “UNLOCK.”

In the examples shown in FIG. 28 and FIG. 30, the connecting part 2061 of the first member 2006A and the lock mechanism 2007C are properly connected, so the indicator 2008C displays “LOCKED.”

In addition, since the connecting part 2061 of the second member 2006B and the lock mechanism 2007D are properly connected, the indicator 2008D displays “LOCKED.”

Since the lock mechanisms 2007A, 2007B, 2007E, and 2007F are not connected to the connecting part 2061, the indicators 2008A, 2008B, 2008E, and 2008F display “UNLOCK.”

In the example shown in FIG. 29, the connecting part 2061 of the first member 2006A and the lock mechanism 2007E are properly connected, so the indicator 2008E displays “LOCKED.”

In addition, since the connecting part 2061 of the second member 2006B and the lock mechanism 2007F are properly connected, the indicator 2008F displays “LOCKED.”

Since the lock mechanism 2007A to 2007D is not connected to the connecting part 2061, the indicators 2008A to 2008D display “UNLOCK”.

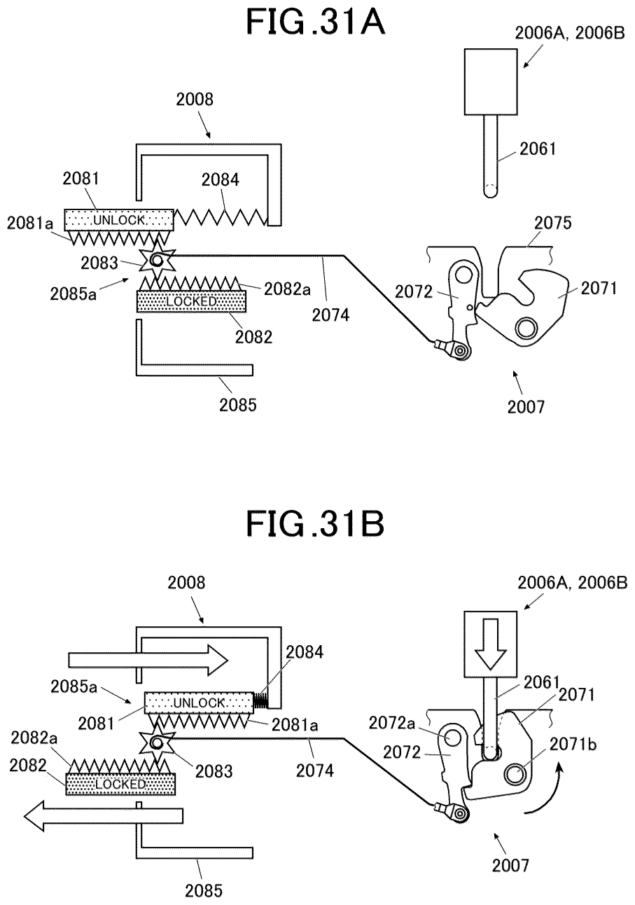

Next, FIG. 31A shows a schematic diagram of the lock mechanism 2007 in an unlocked state without the connecting part 2061 being connected, and the indicator 2008. In addition, FIG. 31B shows a schematic diagram of the lock mechanism 2007 in the locked state with the connecting part 2061 connected, and the indicator 2008.

The indicator 2008 includes an unlock display section 2081, a lock display section 2082, a rotating gear 2083, a biasing member 2084 made of spring or rubber, and a cover member 2085, as shown in FIG. 31A and FIG. 31B.

The cover member 2085 covers at least a part of the unlock display section 2081 and the lock display section 2082.

The cover member 2085 further covers the rotating gear 2083 and the urging member 2084.

The unlock display section 2081 is a component that displays “UNLOCK” to indicate that the connecting part 2061 and the lock mechanism 2007 are not connected.

The lock display section 2082 is a component that displays “LOCKED” to indicate that the connecting part 2061 and the lock mechanism 2007 are properly connected.

The unlock display section 2081 includes a driven gear 2081a on the lock display section 2082 side.

The lock display section 2082 includes a driven gear 2082a on the unlock display section 2081 side.

The driven gear 2081a and driven gear 2082a are each engaged with the rotating gear 2083, which is supported by a shaft in a region covered by the cover member 2085.

The unlock display section 2081 is biased in the direction of exiting from the opening 2085a of the cover member 2085 to the region outside the region covered by the cover member 2085 by the biasing member 2084 arranged in the region covered by the cover member 2085. That is, the urging member 2084 urges the unlock display section 2081 in the direction where “UNLOCK” is displayed by the unlock display section 2081.

The connecting member 2074 connected to the ratchet 2072 is connected to the rotating gear 2083 so that when pulled on the ratchet 2072 side, it rotates the rotating gear 2083 clockwise.

In the state where the unlock display section 2081 shown in FIG. 31A is outside the region covered by the cover member 2085, as shown in FIG. 31B, when the connecting part 2061 engages with the latch 2071 of the lock mechanism 2007, the latch 2071 rotates counterclockwise around the rotation axis 2071b.

Then, by rotating counterclockwise around the rotation axis 2071b, the latch 2071 engages with the ratchet 2072, and together, the ratchet 2072 rotates counterclockwise around the rotation axis 2072a. As a result, the connecting member 2074 is pulled toward the lock mechanism 2007 side, causing the rotating gear 2083 to rotate clockwise.

At this time, the rotation operation of the rotating gear 2083 is transmitted to the driven gear 2081a, and the unlock display section 2081 is housed in the region covered by the cover member 2085 against the urging force of the urging member 2084.

Then, the rotation operation of the rotating gear 2083 is transmitted to the driven gear 2082a, and the lock display section 2082 exits the region covered by the cover member 2085 from the opening 2085a.

In the locked state where the connecting part 2061 is engaged by the latch 2071 shown in FIG. 31B, the lock mechanism 2007 continuously pulls the connecting member 2074 towards the lock mechanism 2007 side, so the lock display section 2082 remains outside the region covered by the cover member 2085. In other words, the lock display section 2082 continues to show “LOCKED.”

If the connecting part 2061 is not properly engaged with the latch 2071, the lock display section 2082 does not extend beyond the region covered by the cover member 2085, so “LOCKED” is not displayed.

As a result, the user (such wheeled vehicle passengers) can recognize that even if they intend to attach the first member 2006A or the second member 2006B to the lock mechanism 2007, the connecting part 2061 is not properly engaged with the latch 2071.

In addition, a case is described in which the user pushes the lock display section 2082 in the direction to be stored in the region covered by the cover member 2085, while the lock display section 2082 shown in FIG. 31B is in a state of being outside the region covered by the cover member 2085.

In this case, the lock display section 2082 is stored in the region covered by the cover member 2085, so “LOCKED” is not displayed.

In addition, as the lock display section 2082 is housed in the region covered by the cover member 2085, the rotating gear 2083 rotates counterclockwise.

Then, by rotating the rotating gear 2083 counterclockwise, the biasing member 2084 exerts a biasing force, and the unlock display section 2081 exits the region covered by the cover member 2085 from the opening 2085a, resulting in the display of “UNLOCK.”

In addition, by the rotating gear 2083 rotating counterclockwise, the connecting member 2074 is pulled toward the rotating gear 2083 side, causing the ratchet 2072 to rotate clockwise around the rotation axis 2072a. Then, when the ratchet 2072 detaches from the latch 2071, the latch rotates clockwise around the rotation axis 2071b, releasing the connecting part 2061. This allows the removal of the connecting part 2061 from the lock mechanism 2007.

The configuration of the lock mechanism 2007 and the indicator 2008 is not limited to the above example. For example, by making the engagement between the latch 2071 and ratchet 2072 looser, it may be configured so that the user can remove the connecting part 2061 from the lock mechanism 2007 without having to push the lock display section 2082 into the region covered by the cover member 2085.

In other words, the wheeled vehicle seat S is equipped with a first connecting member (connecting member 2074) that connects the first indicator (indicators 2008A, 2008C, 2008E) and the first lock mechanism (lock mechanisms 2007A, 2007C, 2007E) in which the first member 2006A of the lock mechanism 2007 is locked.

The first indicator includes a first display section (unlock display section 2081) that displays the unlocked state between the first member 2006A and the first lock mechanism, a second display section (lock display section 2082) that displays the locked state between the first member 2006A and the first lock mechanism, and a biasing member 2084 that biases the first display section to be displayed. Then, when the first member 2006A is locked to the first lock mechanism, the first connecting member is pulled toward the first lock mechanism side, and the first indicator does not display the first display section against the biasing member 2084, while displaying the second display section.

In addition, the wheeled vehicle seat S includes a second connecting member (connecting member 2074) that connects the second indicator (indicators 2008B, 2008D, 2008F) and the second lock mechanism (lock mechanisms 2007B, 2007D, 2007F) in which the second member 2006B of the lock mechanism 2007 is locked.

The second indicator includes the third display section (unlock display section 2081) that displays the unlocked state between the second member 2006B and the second lock mechanism, the fourth display section (lock display section 2082) that displays the locked state between the second member 2006B and the second lock mechanism, and the biasing member 2084 that biases the third display section to be displayed.

Then, when the second member 2006B is locked to the second lock mechanism, the second connecting member is pulled toward the second lock mechanism side, and the second indicator does not display the third display section against the biasing member 2084, while displaying the fourth display section.

Next, the arrangement structure of the connecting member 2074 is described.

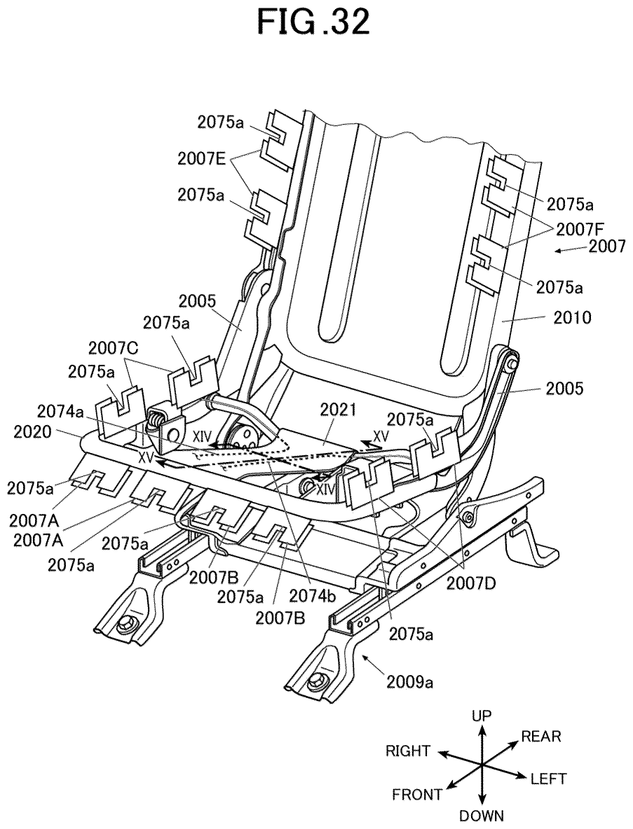

FIG. 32 shows the arrangement structure of the first connecting member 2074a and the second connecting member 2074b, which are connecting members 2074.

As shown in FIG. 32, the seat cushion frame 2020 includes a pressure receiving member 2021.

The pressure receiving member 2021 is a component made of metal or resin plate material that bears the load of the passenger seated on the wheeled vehicle seat S.

In the example shown in FIG. 32, the first connecting member 2074a connects the indicator 2008C and the lock mechanism 2007C where the first member 2006A is locked. In addition, the second connecting member 2074b connects the indicator 2008D and the lock mechanism 2007D that locks the second member 2006B.

Some parts of the first connecting member 2074a and the second connecting member 2074b are arranged on the downward direction side surface (back surface) of the pressure receiving member 2021. In FIG. 32, the parts arranged on the back surface of the pressure receiving member 2021 of the first connecting member 2074a and the second connecting member 2074b are indicated by dashed lines.

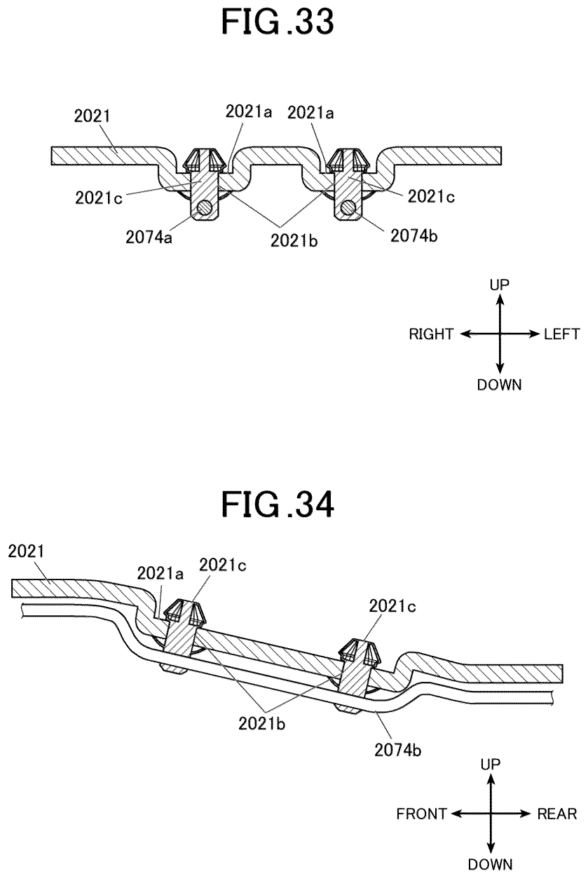

FIG. 33 shows a cross-sectional view at the cross-section line XIV-XIV shown in FIG. 32. FIG. 34 shows a cross-sectional view at the cross-section line XV-XV shown in FIG. 32.

As shown in FIG. 33 and FIG. 34, the pressure receiving member 2021 has two depressed parts 2021a elongated in the front-rear direction and formed in parallel in the left-right direction.

In the depressed part 2021a, two clip engaging holes 2021b are formed in parallel in the front-rear direction. The number of clip engaging holes 2021b is not limited to the examples shown in FIG. 33 and FIG. 34.

Clips 2021c attached to the first connecting member 2074a or the second connecting member 2074b are each press-fitted into the clip engaging holes 2021b. As a result, the first connecting member 2074a and the second connecting member 2074b are attached to the back surface of the pressure receiving member 2021. At this time, the clip 2021c is press-fitted from the back surface of the pressure receiving member 2021, and the clip 2021c protrudes on the surface of the pressure receiving member 2021 (upward direction side surface).

The height of the portion protruding upward from the surface of the pressure receiving member 2021 of the clip 2021c is approximately equal to the depth of the depressed part 2021a.

As shown in FIG. 34, the pressure receiving member 2021 is provided to incline downward from the front direction to the rear direction.

The first connecting member 2074a and the second connecting member 2074b attached by clip 2021c are arranged along the back surface of the pressure receiving member 2021, which is inclined downward from the front direction to the rear direction. In other words, by placing the first connecting member 2074a and the second connecting member 2074b in the space below the pressure receiving member 2021, it is possible to make effective use of the space below the pressure receiving member 2021.

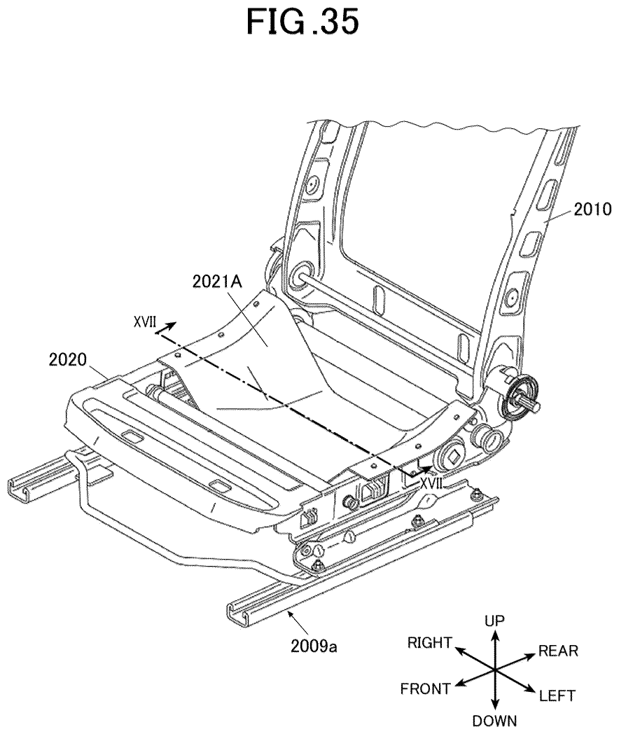

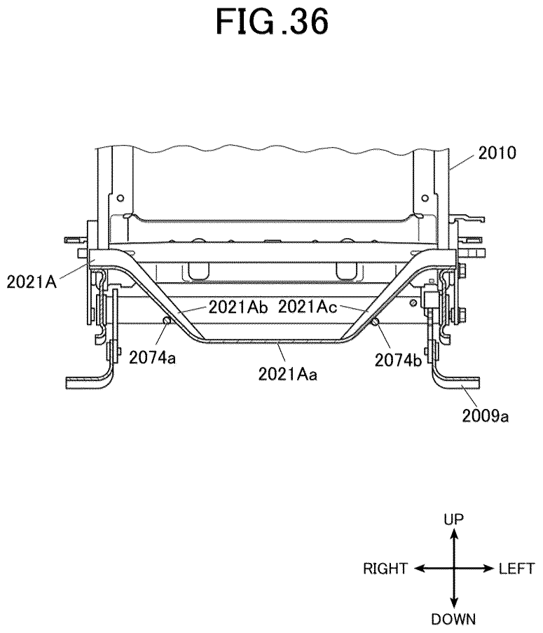

In addition, FIG. 35 shows another example of the seat frame (seat back frame 2010 and seat cushion frame 2020) that the wheeled vehicle seat S has. FIG. 36 shows a cross-sectional view at the cross-section line XVII-XVII shown in FIG. 35. In FIG. 35, the lock mechanism 2007 is omitted.

In the examples shown in FIG. 35 and FIG. 36, the seat cushion frame 2020 includes a pressure receiving member 2021A.

The pressure receiving member 2021A is a member formed by press molding a plate-like member made of metal such as iron or aluminum, or a member made of resin such as FRP (fiber-reinforced plastic). As shown in FIG. 36, the pressure receiving member 2021A includes a concave shape downward and is configured to support the buttocks of the passenger seated on the wheeled vehicle seat S with the entire pressure receiving member 2021A.

More specifically, the pressure receiving member 2021A includes a bottom 2021Aa provided at a lower height than other parts at the center in the left-right direction. In addition, the pressure receiving member 2021A includes an inclined part 2021Ab that slopes upward to the right from the right side of the bottom 2021Aa. In addition, the pressure receiving member 2021A includes an inclined part 2021Ac that slopes upward to the left from the left side of the bottom 2021Aa.

As shown in FIG. 36, the first connecting member 2074a is attached to the back surface (downward direction side) of the inclined part 2021Ab.

In addition, the second connecting member 2074b is attached to the back surface (downward direction side surface) of the inclined part 2021Ac.

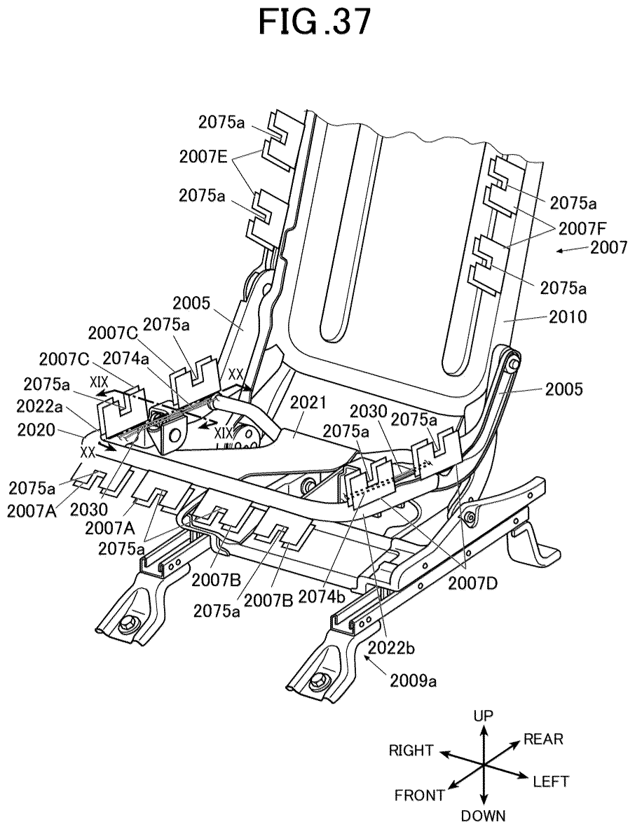

FIG. 37 shows another example of the arrangement structure of the first connecting member 2074a and the second connecting member 2074b.

As shown in FIG. 37, the seat cushion frame 2020 is equipped with a side frame 2022a on the right side and a side frame 2022b on the left side.

The side frames 2022a and 2022b are components that are basically symmetrical in structure and are provided extending in the front-rear direction of the seat.

As shown in FIG. 37, the first connecting member 2074a is arranged along the inside (left side) of the side frame 2022a, and the second connecting member 2074b is arranged along the inside (right side) of the side frame 2022b.

In FIG. 37, the part that is positioned in a non-visible location of the second connecting member 2074b is indicated by a dashed line.

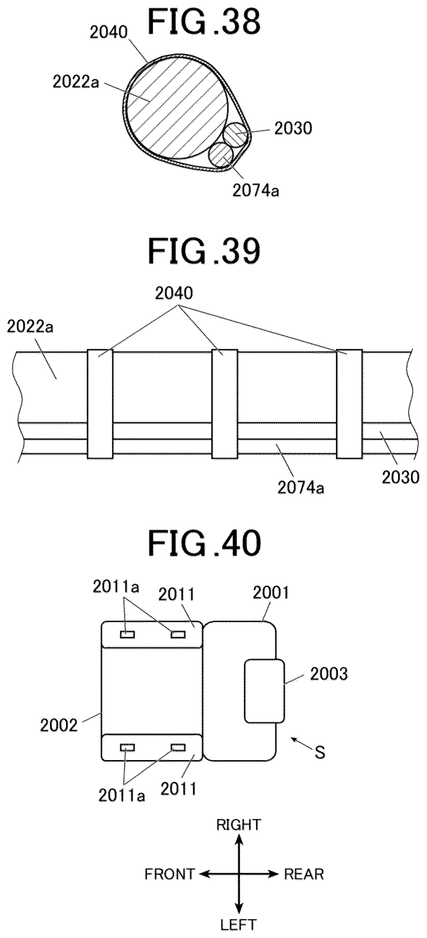

FIG. 38 shows a cross-sectional view at the cross-section line XIX-XIX shown in FIG. 37. FIG. 39 shows a cross-sectional view at the cross-section line XX-XX shown in FIG. 37.

As shown in FIG. 38 and FIG. 39, the first connecting member 2074a is arranged along the side frame 2022a together with a harness 2030 for electrical equipment, and is fixed to the side frame 2022a by the connecting member 2040.

The harness 2030 for electrical equipment is, for example, a harness for the seat heater provided in the wheeled vehicle seat S.

The connecting member 2040 is, for example, a tie band. In addition, the second connecting member 2074b is arranged along the side frame 2022b together with the harness 2030 for electrical equipment, in the same manner as the first connecting member 2074a, and is fixed to the side frame 2022b by the connecting member 2040.

In this way, the first connecting member 2074a and the second connecting member 2074b can be arranged together with other harnesses such as the harness 2030 for electrical equipment. Therefore, it is possible to reduce the risk of the first connecting member 2074a and the second connecting member 2074b causing interference with other parts.

The cover member 2085 shown in FIGS. 31A and 31B may be provided for each indicator 2008A to 2008F, or in cases where the indicators 2008 are arranged adjacent to each other, it may be provided as a common cover member covering multiple indicators 2008.

That is, when the cover member 2085 is provided for each of the indicators 2008A to 2008F, the first indicator among the indicators 2008A to 2008F is covered by the first cover member, and the second indicator among the indicators 2008A to 2008F is covered by the second cover member.

In addition, when the cover member 2085 is provided as a common cover member that covers multiple indicators 2008, the first indicator (for example, indicator 2008A) and the second indicator (for example, indicator 2008B) among the indicators 2008A to 2008F are covered by the common cover member.

In the above embodiment, one of the two strikers (connecting part 2061) held by the first member 2006A or the second member 2006B engages with the latch 2071 of the lock mechanism 2007, and an example is shown in the indicator 2008 connected to the lock mechanism 2007, indicating whether the connecting part 2061 and the lock mechanism 2007 are properly connected, but this is not limited to that.

The wheeled vehicle seat S may be equipped with the lock mechanism 2007 that connects to the two strikers (connecting part 2061) held by the first member 2006A and the second member 2006B, as well as the indicator 2008 connected to each lock mechanism 2007. In other words, the wheeled vehicle seat S may be equipped with two lock mechanisms 2007 and two indicators 2008 corresponding to the first member 2006A or the second member 2006B.

Alternatively, the wheeled vehicle seat S is equipped with the lock mechanism 2007 that connects to each of the two strikers (connecting part 2061) possessed by the first member 2006A or the second member 2006B, and the two lock mechanisms 2007 are configured to operate in conjunction, and it may also be configured to have one indicator 2008 connected to the two interlinked lock mechanisms 2007.

In addition, the indicator 2008 is not limited to the configuration of being physically connected to the lock mechanism 2007 by the connecting member 2074 as described above. The indicator 2008 may be electrically connected to the lock mechanism 2007.

In addition, the wheeled vehicle seat S may be equipped with a notification section that informs users such as the wheeled vehicle passengers whether the connecting part 2061 of the first member 2006A or the second member 2006B and the lock mechanism 2007 are properly connected by voice.

In addition, the wheeled vehicle seat S may include a configuration that does not include the indicator 2008 and includes the above notification section.

In addition, the wheeled vehicle seat S includes a mounting part cover 2011, as shown in FIG. 40. FIG. 40 is a view of the wheeled vehicle seat S from above.

The mounting part cover 2011 is provided on the seat cushion 2002 in the ottoman specification mode and the armrest specification mode. In other words, the mounting part cover 2011 is positioned between the seat cushion 2002 and the first member 2006A or the second member 2006B when the first member 2006A or the second member 2006B is connected to the lock mechanism 2007.

In addition, the mounting part cover 2011 is provided on the seat back 2001 in the side support specification mode. In other words, the mounting part cover 2011 is positioned between the seat back 2001 and the first member 2006A or the second member 2006B when the first member 2006A or the second member 2006B is connected to the lock mechanism 2007.

In addition, the mounting part cover 2011 includes a mounting hole 2011a for inserting the connecting part 2061 of the first member 2006A or the second member 2006B.

When connecting the connecting part 2061 of the first member 2006A or the second member 2006B to the lock mechanism 2007, the mounting hole 2011a serves as a marker (guide), thereby improving the workability of mounting the first member 2006A or the second member 2006B.

The orientation of the connecting part 2061 (striker) for the cushion part 2062 in the first member 2006A or the second member 2006B is not limited to the example shown in FIG. 25. The orientation of the mounting hole 2011a for the mounting part cover 2011 is not limited to the example shown in FIG. 40.

The orientation of the mounting hole 2011a may be in a direction corresponding to the orientation of the striker (connecting part 2061) possessed by the first member 2006A or the second member 2006B.

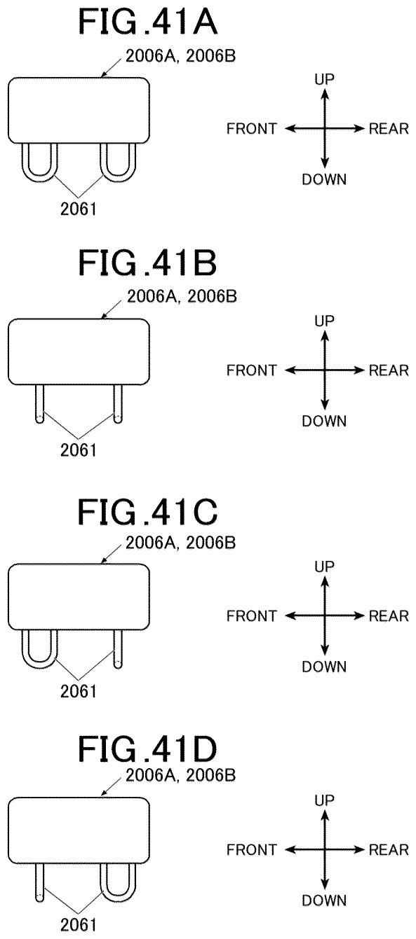

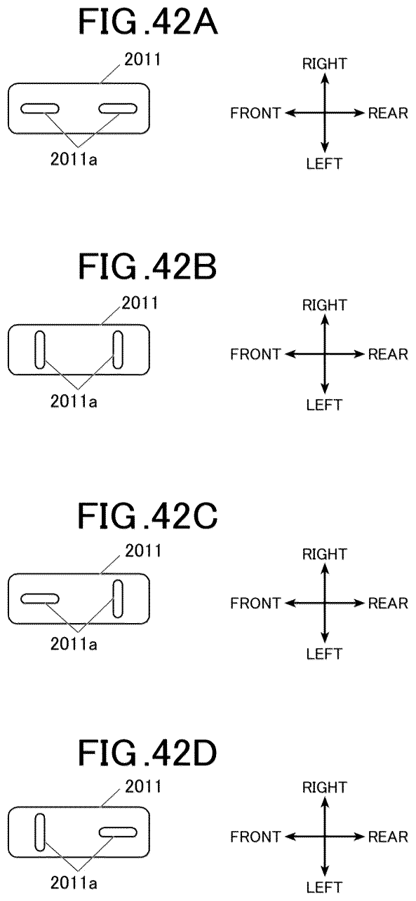

FIG. 41A to FIG. 41D show examples of the first member 2006A and the second member 2006B. FIG. 42A to FIG. 42D show examples of the mounting part cover 2011 corresponding to the orientation of the striker (connecting part 2061) of the first member 2006A and the second member 2006B shown in FIG. 41A to FIG. 41D.

As shown in FIG. 41A, when the two connecting parts 2061 of the first member 2006A and the second member 2006B have a U-shape in side view (when viewed from the left-right direction), as shown in FIG. 42A, the elongated direction of the two mounting holes 2011a included in the mounting part cover 2011 is in the front-rear direction.

In this case, the mounting part cover 2011 can be miniaturized in the left-right direction.

In addition, as shown in FIG. 41B, when the two connecting parts 2061 of the first member 2006A and the second member 2006B have a U-shaped configuration when viewed from the front (when viewed from the front-rear direction), as shown in FIG. 42B, the elongated direction of the two mounting holes 2011a of the mounting part cover 2011 is in the left-right direction.

In this case, the mounting part cover 2011 can be miniaturized in the front-rear direction.

In addition, as shown in FIG. 41C and FIG. 41D, one of the connecting parts 2061 of the first member 2006A and the second member 2006B has a U-shape when viewed from the side (from the left-right direction), while the other connecting part 2061 has a U-shape when viewed from the front (from the front-rear direction).

In this case, when the connecting part 2061 is locked to the lock mechanism 2007, the connecting part 2061 is positioned in the front-rear direction and the left-right direction. Therefore, it is possible to suppress rattling in the lock mechanism 2007 of the connecting part 2061.

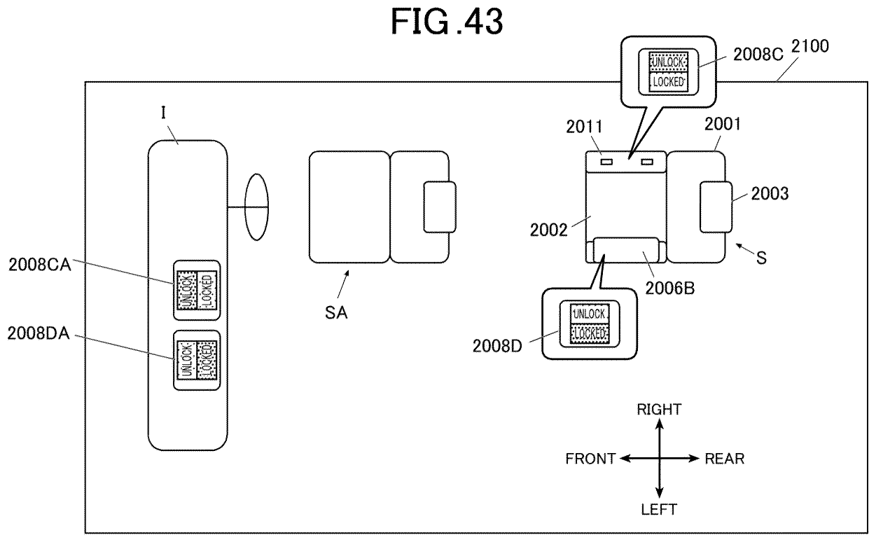

In addition, as shown in FIG. 43, the instrument panel I of the wheeled vehicle 2100 equipped with the wheeled vehicle seat S may be provided with the indicator 2008. The wheeled vehicle seat SA installed in wheeled vehicle 2100 is the driver's seat.

In the example shown in FIG. 43, the first member 2006A is not provided on the wheeled vehicle seat S, and the second member 2006B is provided as the left armrest of the wheeled vehicle seat S. In this case, as shown in FIG. 43, the indicator 2008C displays “UNLOCK” and the indicator 2008D displays “LOCKED.”

In addition, the indicators 2008CA and 2008DA are provided on the instrument panel I.

The indicator 2008CA is physically or electrically connected to the indicator 2008C provided on the wheeled vehicle seat S via wires or cables, and they operate in conjunction.

Therefore, the indicator 2008CA displays “UNLOCK” just like the indicator 2008C.

In addition, the indicator 2008DA is physically or electrically connected to the indicator 2008D provided on the wheeled vehicle seat S via wires or cables, and they operate in conjunction.

Therefore, the indicator 2008DA will display “LOCKED” just like the indicator 2008D.

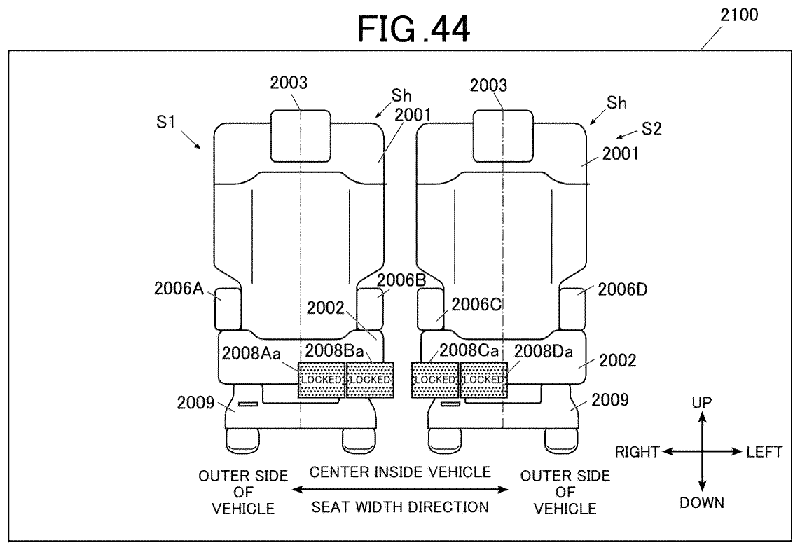

In addition, as shown in FIG. 44, the wheeled vehicle 2100 may be equipped with a first wheeled vehicle seat S1 and a second wheeled vehicle seat S2.

The first wheeled vehicle seat S1, like the wheeled vehicle seat S, has the seat body Sh, the surface member 2004, the connecting member 2005, the detachable first member 2006A and second member 2006B, the lock mechanism 2007, the indicator 2008, the base cover 2009, the supporter 2009a, and the mounting part cover 2011.

Specifically, the first wheeled vehicle seat S1 has an indicator 2008Aa (first indicator) that is the indicator 2008 and that shows whether the connecting part 2061 of the first member 2006A and the lock mechanism 2007 are properly connected.

In addition, the first wheeled vehicle seat S1 has an indicator 2008Ba (second indicator) that is an indicator 2008 and that shows whether the connecting part 2061 of the second member 2006B and the lock mechanism 2007 are properly connected.

As shown in FIG. 44, the first member 2006A is provided on one side (right side) of the first wheeled vehicle seat S1.

The second member 2006B is provided on the other side (left side) of the first wheeled vehicle seat S1.

In addition, the indicator 2008Aa (first indicator) is provided on the front side of the seat cushion 2002 of the first wheeled vehicle seat S1, and is located on the central side within the wheeled vehicle, on one side (right side) of the first wheeled vehicle seat S1, compared to the indicator 2008Ba (second indicator).

In addition, the indicator 2008Ba (second indicator) is provided on the front side of the seat cushion 2002 of the first wheeled vehicle seat S1, and is located on the central side of the wheeled vehicle, on the opposite side (left side) of the first wheeled vehicle seat S1 compared to the indicator 2008Aa (first indicator).

In addition, the second wheeled vehicle seat S2 includes the seat body Sh, the surface member 2004, the connecting member 2005, the detachable third member 2006C and fourth member 2006D, the lock mechanism 2007, the indicator 2008, the base cover 2009, the supporter 2009a, and the mounting part cover 2011. The third member 2006C and the fourth member 2006D have the same configuration as the first member 2006A and the second member 2006B.

Specifically, the second wheeled vehicle seat S2 has the indicator 2008Ca (the third indicator) that is the indicator 2008 and that shows whether the connecting part 2061 of the third member 2006C and the lock mechanism 2007 are properly connected.

In addition, the second wheeled vehicle seat S2 has an indicator 2008Da (fourth indicator) that is an indicator 2008 and that shows whether the connecting part 2061 of the fourth member 2006D and the lock mechanism 2007 are properly connected.

As shown in FIG. 44, the third member 2006C is provided on one side (right side) of the second wheeled vehicle seat S2.

The fourth member 2006D is provided on the other side (left side) of the second wheeled vehicle seat S2.

In addition, the indicator 2008Ca (third indicator) is provided on the front side of the seat cushion 2002 of the second wheeled vehicle seat S2, and is located on the central side within the wheeled vehicle, on one side (right side) of the second wheeled vehicle seat S2, compared to the indicator 2008Da (fourth indicator).

In addition, the indicator 2008Da (fourth indicator) is provided on the front side of the seat cushion 2002 of the second wheeled vehicle seat S2, and is located on the central side within the wheeled vehicle, on the opposite side (left side) of the second wheeled vehicle seat S2 compared to the indicator 2008Ca (third indicator).

With the above configuration, users such as drivers can recognize the first indicator, second indicator, third indicator, and fourth indicator from the front direction of the wheeled vehicle seat S all at once.

The lock mechanism 2007 may be provided on the vehicle body of the wheeled vehicle 2100. In this case, the first member 2006A, the second member 2006B, the third member 2006C, and the fourth member 2006D are connected to the lock mechanism 2007 provided on the vehicle body.

In other words, the wheeled vehicle 2100 is equipped with the first wheeled vehicle seat S1 including the first member 2006A and the second member 2006B as passenger supporters that are locked to the lock mechanism 2007 provided on the vehicle body or the first wheeled vehicle seat S1, the first indicator (indicator 2008Aa) indicating the locked state of the first member 2006A, and the second indicator (indicator 2008Ba) indicating the locked state of the second member 2006B.

Further, the wheeled vehicle 2100 is equipped with the second wheeled vehicle seat S2 including the third member 2006C and the fourth member 2006D as passenger supporters that are locked to the lock mechanism 2007 provided on the vehicle body or the second wheeled vehicle seat S2, the third indicator (indicator 2008Ca) indicating the locked state of the third member 2006C, and the fourth indicator (indicator 2008Da) indicating the locked state of the second member 2006D.

The first member 2006A is provided on one side of the first wheeled vehicle seat S1, while the third member 2006C is provided on one side of the second wheeled vehicle seat S2.

Then, the second member 2006B is provided on the other side of the first wheeled vehicle seat S1, and the fourth member 2006D is provided on the other side of the second wheeled vehicle seat S2.

The first indicator (indicator 2008Aa) is provided on one side of the first wheeled vehicle seat S1 than the second indicator (indicator 2008Ba). The third indicator (indicator 2008Ca) is provided on one side of the second wheeled vehicle seat S2 than the fourth indicator (indicator 2008Da).

The second indicator (indicator 2008Ba) is provided on the other side of the first wheeled vehicle seat S1 than the first indicator (indicator 2008Aa). The fourth indicator (indicator 2008Da) is provided on the other side of the second wheeled vehicle seat S2 than the third indicator (indicator 2008Ca).

The first indicator (indicator 2008Aa), the second indicator (indicator 2008Ba), the third indicator (indicator 2008Ca), and the fourth indicator (indicator 2008Da) are provided on the front side of the seat cushion 2002 and in the central part of the wheeled vehicle.

Next, the manufacturing method of the wheeled vehicle seat S will be described.

The worker first installs the lock mechanism 2007 on the wheeled vehicle seat S (first process).

Next, the worker provides the first indicator (indicators 2008A, 2008C, 2008E) indicating the locked state of the first member 2006A, and the second indicator (indicators 2008B, 2008D, 2008F) indicating the locked state of the second member 2006B on the wheeled vehicle seat S (second process).

The order of the first and second processes is not limited to the above example.

Then, the worker provides the first member 2006A on one side of the wheeled vehicle seat S (for example, the right side) and provides the second member 2006B on the other side of the wheeled vehicle seat S (for example, the left side) (third process).

In the second process, the worker installs the first indicator on one side of the wheeled vehicle seat S and the second indicator on the other side of the wheeled vehicle seat S.

In the second process, the worker may place the first indicator and the second indicator adjacent to each other.

In the second process, the worker may set the first indicator and the second indicator so that the distance between them is shorter than the distance between the first member 2006A and the second member 2006B.

In the second process, the worker may install the first indicator and the second indicator on the front side of the seat cushion provided by the wheeled vehicle seat S, and also on the central side inside the wheeled vehicle.

In the second process, the worker provides the first indicator covered by the first cover member (cover member 2085) and the second indicator covered by the second cover member (cover member 2085).

In the second process, the worker may provide the first indicator and the second indicator covered with a common cover member.

In the second process, the worker provides, to the wheeled vehicle seat S, the first connecting member (connecting member 2074) that connects the first indicator to the first lock mechanism (lock mechanisms 2007A, 2007C, 2007E) of the lock mechanism 2007, where the first member 2006A is locked.

The first indicator includes the first display section (unlock display section 2081) that shows the unlocked state between the first member 2006A and the first lock mechanism, the second display section (lock display section 2082) that shows the locked state between the first member 2006A and the first lock mechanism, and the biasing member 2084 that biases the first display section to be displayed.

Then, when the first member 2006A is locked to the first lock mechanism, the first connecting member is pulled toward the first lock mechanism side, and the first indicator does not display the first display section against the biasing member 2084, while displaying the second display section.

In the second process, the worker provides, to the wheeled vehicle seat S, the second connecting member (connecting member 2074) that connects the second indicator to the second lock mechanism (lock mechanisms 2007B, 2007D, 2007F) of the lock mechanism, where the second member 2006B is locked.

The second indicator includes the third display section (unlock display section 2081) that displays the unlocked state between the second member 2006B and the second lock mechanism, the fourth display section (lock display section 2082) that displays the locked state between the second member 2006B and the second lock mechanism, and the biasing member 2084 that biases the third display section to be displayed.

Then, when the second member 2006B is locked to the second lock mechanism, the second connecting member is pulled toward the second lock mechanism side, and the second indicator does not display the third display section against the biasing member 2084, while displaying the fourth display section.

In the third process, the worker may provide the first member 2006A and the second member 2006B to function as armrests.

In the third process, the worker may provide the first member 2006A and the second member 2006B to function as side supports.

As a result, the wheeled vehicle seat S is manufactured.

The worker may provide the lock mechanism 2007 on the vehicle body. In this case, the worker connects the first member 2006A and the second member 2006B to the lock mechanism 2007 provided on the vehicle body.

As explained above, the wheeled vehicle seat S in this embodiment includes the first member 2006A and the second member 2006B as passenger supporters that are locked to the lock mechanism 2007 provided on the vehicle body or wheeled vehicle seat S, the first indicator (indicators 2008A, 2008C, 2008E) indicating the locked state of the first member 2006A, and the second indicator (indicators 2008B, 2008D, 2008F) indicating the locked state of the second member 2006B. Therefore, it is possible to indicate the locked state of the lock mechanism 2007 for the first member 2006A and the second member 2006B, respectively. In other words, users such as passengers can recognize whether the crew supporters (first member 2006A and second member 2006B) are properly installed.

In the wheeled vehicle seat S of this embodiment, the first member 2006A is provided on one side of the wheeled vehicle seat S, and the second member 2006B is provided on the other side of the wheeled vehicle seat S. The first indicator (indicators 2008A, 2008C, 2008E) is provided on one side of the wheeled vehicle seat S, and the second indicator (indicators 2008B, 2008D, 2008F) is provided on the other side of the wheeled vehicle seat S.

Therefore, the positional relationship between the first member 2006A provided on one side and the first indicator, as well as the positional relationship between the second member 2006B provided on the other side and the second indicator, are consistent. As a result, users can easily recognize the locked state of the first member 2006A and the second member 2006B.

In the wheeled vehicle seat S of this embodiment, the first indicators (indicators 2008A, 2008C, 2008E) and the second indicators (indicators 2008B, 2008D, 2008F) are provided adjacent to each other.

This allows users to recognize both the first indicator and the second indicator at the same time.

In the wheeled vehicle seat S of this embodiment, the distance between the first indicator (indicators 2008A, 2008C, 2008E) and the second indicator (indicators 2008B, 2008D, 2008F) is shorter than the distance between the first member 2006A and the second member 2006B.

As a result, the first indicator and the second indicator are placed in a close region within a predetermined distance, allowing the user to recognize both the first indicator and second indicator at once.

In this embodiment, the wheeled vehicle seat S is equipped with the seat cushion 2002, and the first indicators (indicators 2008A, 2008C, 2008E) and the second indicators (indicators 2008B, 2008D, 2008F) are provided on the front side of the wheeled vehicle seat S in the seat cushion 2002, and are located on the central side of the wheeled vehicle.

As a result, when checking the first and second indicators from the front direction of the wheeled vehicle seat S, the user in front of the wheeled vehicle seat S can easily recognize the first and second indicators.

In the above case, for example, it is when checking the first indicator and second indicator provided in the wheeled vehicle seat S which is a rear part seat from the driver's seat.

In other words, users such as drivers can easily see the display of the first and second indicators.

In the wheeled vehicle seat S of this embodiment, the first indicator (indicators 2008A, 2008C, 2008E) is covered by the first cover member (cover member 2085), and the second indicator (indicators 2008B, 2008D, 2008F) is covered by the second cover member (cover member 2085).

Therefore, it is possible to cover the first indicator and the second indicator with separate cover members 2085.

In the wheeled vehicle seat S of this embodiment, the first indicators (indicators 2008A, 2008C, 2008E) and the second indicators (indicators 2008B, 2008D, 2008F) are covered by a common cover member.

As a result, it is possible to reduce the number of parts compared to a configuration where the first and second indicators are covered with separate cover members.

In this embodiment, the wheeled vehicle seat S is equipped with the first connecting member (connecting member 2074) that connects the first indicator (indicators 2008A, 2008C, 2008E) and the first lock mechanism (lock mechanisms 2007A, 2007C, 2007E) in which the first member 2006A is locked by the lock mechanism 2007. The first indicator includes a first display section (unlocked display section 2081) that indicates the unlocked state of the first member 2006A and the first lock mechanism, and a second display section (locked display section 2082) that indicates the locked state of the first member 2006A and the first lock mechanism, as well as a biasing member 2084 that biases the first display section to be displayed. When the first member 2006A is locked to the first lock mechanism, the first connecting member is pulled toward the first lock mechanism side, thereby not displaying the first display section against the biasing member 2084 while displaying the second display section. The wheeled vehicle seat S is equipped with the second connecting member (connecting member 2074) that connects the second indicator (indicators 2008B, 2008D, 2008F) to the second lock mechanism (lock mechanisms 2007B, 2007D, 2007F) in which the second member 2006B is locked by the lock mechanism 2007, and includes a third display section (unlocked display section 2081) that indicates the unlocked state of the second member 2006B and the second lock mechanism, a fourth display section (locked display section 2082) that indicates the locked state of the second member 2006B and the second lock mechanism, and a biasing member 2084 that biases the third display section to be displayed. When the second member 2006B is locked to the second lock mechanism, the second connecting member is pulled toward the second lock mechanism side, thereby not displaying the third display section against the biasing member 2084 while displaying the fourth display section.

Therefore, the indicator 2008 can be configured simply.

In the wheeled vehicle seat S of this embodiment, the first member 2006A and the second member 2006B are armrests.

This allows for showing the locked state of the lock mechanism 2007 when the first member 2006A and the second member 2006B function as armrests.

In the wheeled vehicle seat S of this embodiment, the first member 2006A and the second member 2006B are side supports.

This allows for the locked state of the lock mechanism 2007 when the first member 2006A and the second member 2006B function as side supports to be shown respectively.

Next, the manufacturing method of the wheeled vehicle seat S according to the present embodiment is described. That is, a method for manufacturing a wheeled vehicle seat S including, the first member 2006A and the second member 2006B as passenger supporters locked to the lock mechanism 2007 provided on the vehicle body or wheeled vehicle seat S, the first indicator (indicators 2008A, 2008C, 2008E) indicating the locked state of the first member 2006A, and the second indicator (indicators 2008B, 2008D, 2008F) indicating the locked state of the second member 2006B, is the method including a first step of providing the lock mechanism 2007 on the wheeled vehicle seat S, and a second step of providing the first indicator and the second indicator on the wheeled vehicle seat S.

Therefore, in the wheeled vehicle seat S, the locked state of the lock mechanism 2007 for the first member 2006A and the second member 2006B can be indicated respectively. In other words, it is possible to manufacture a wheeled vehicle seat S that allows users, such as passengers, to recognize whether the passenger supporters (first member 2006A and second member 2006B) are properly installed.

In the manufacturing method of the wheeled vehicle seat S in this embodiment, the first member 2006A is provided on one side of the wheeled vehicle seat S, and the second member 2006B is provided on the other side of the wheeled vehicle seat S. The first indicator (indicators 2008A, 2008C, 2008E) is provided on one side of the wheeled vehicle seat S, and the second indicator (indicators 2008B, 2008D, 2008F) is provided on the other side of the wheeled vehicle seat S.

Therefore, in the wheeled vehicle seat S, the positional relationship between the first member 2006A provided on one side and the first indicator, and the positional relationship between the second member 2006B provided on the other side and the second indicator are aligned. As a result, the user can manufacture the wheeled vehicle seat S that makes it easy to recognize the locked state of the first member 2006A and the second member 2006B.

In the manufacturing method of the wheeled vehicle seat S in this embodiment, the first indicators (indicators 2008A, 2008C, 2008E) and the second indicators (indicators 2008B, 2008D, 2008F) are provided adjacent to each other.

This allows the user to manufacture the wheeled vehicle seat S that can recognize both the first and second indicators at the same time.

In the manufacturing method of the wheeled vehicle seat S in this embodiment, the distance between the first indicator (indicator 2008A, 2008C, 2008E) and the second indicator (indicator 2008B, 2008D, 2008F) is shorter than the distance between the first member 2006A and the second member 2006B.

As a result, in the wheeled vehicle seat S, the first indicator and the second indicator are arranged in a nearby area within a predetermined distance. Therefore, the user can manufacture the wheeled vehicle seat S that can recognize both the first and second indicators at the same time.

In the manufacturing method of the wheeled vehicle seat S in this embodiment, the wheeled vehicle seat S is equipped with the seat cushion 2002, and the first indicators (indicators 2008A, 2008C, 2008E) and the second indicators (indicators 2008B, 2008D, 2008F) are provided on the front side of the wheeled vehicle seat S in the seat cushion 2002, and are located in the central side of the wheeled vehicle.

As a result, when checking the first and second indicators from the front direction of the wheeled vehicle seat S, the user in front of the wheeled vehicle seat S can easily recognize the first and second indicators.

In the above case, for example, it is when checking the first indicator and second indicator provided in the wheeled vehicle seat S which is a rear part seat from the driver's seat.

In other words, it is possible to manufacture the wheeled vehicle seat S that allows users such as drivers to easily see the display of the first and second indicators.

In the manufacturing method of the wheeled vehicle seat S of this embodiment, the first indicator (indicators 2008A, 2008C, 2008E) is covered by the first cover member (cover member 2085), and the second indicator (indicators 2008B, 2008D, 2008F) is covered by the second cover member (cover member 2085).

This allows for the manufacturing of the wheeled vehicle seat S that is configured to cover the first indicator and the second indicator with separate cover members 2085.

In the manufacturing method of the wheeled vehicle seat S of this embodiment, the first indicators (indicators 2008A, 2008C, 2008E) and the second indicators (indicators 2008B, 2008D, 2008F) are covered by a common cover member.

As a result, compared to a configuration where the first and second indicators are covered with separate cover members, it is possible to manufacture the wheeled vehicle seat S with fewer parts.

In the manufacturing method of the wheeled vehicle seat S of this embodiment, the wheeled vehicle seat S is equipped with the first connecting member (connecting member 2074) that connects the first indicator (indicators 2008A, 2008C, 2008E) and the first lock mechanism (lock mechanisms 2007A, 2007C, 2007E) in which the first member 2006A is locked by the lock mechanism 2007. The first indicator includes a first display section (unlocked display section 2081) that indicates the unlocked state of the first member 2006A and the first lock mechanism, and a second display section (locked display section 2082) that indicates the locked state of the first member 2006A and the first lock mechanism, as well as a biasing member 2084 that biases the first display section to be displayed. When the first member 2006A is locked to the first lock mechanism, the first connecting member is pulled toward the first lock mechanism side, thereby not displaying the first display section against the biasing member 2084 while displaying the second display section. The wheeled vehicle seat S is equipped with the second connecting member (connecting member 2074) that connects the second indicator (indicators 2008B, 2008D, 2008F) to the second lock mechanism (lock mechanisms 2007B, 2007D, 2007F) in which the second member 2006B is locked by the lock mechanism 2007, and includes a third display section (unlocked display section 2081) that indicates the unlocked state of the second member 2006B and the second lock mechanism, a fourth display section (locked display section 2082) that indicates the locked state of the second member 2006B and the second lock mechanism, and a biasing member 2084 that biases the third display section to be displayed. When the second member 2006B is locked to the second lock mechanism, the second connecting member is pulled toward the second lock mechanism side, thereby not displaying the third display section against the biasing member 2084 while displaying the fourth display section.

Therefore, the wheeled vehicle seat S can be manufactured with the indicator 2008 being a simple structure.

In addition, in the manufacturing method of the wheeled vehicle seat S in this embodiment, the first member 2006A and the second member 2006B are armrests.

This allows for the manufacturing of the wheeled vehicle seat S that can respectively show the locked state of the lock mechanism 2007 when the first member 2006A and the second member 2006B function as armrests.

In addition, in the manufacturing method of the wheeled vehicle seat S in this embodiment, the first member 2006A and the second member 2006B are side supports.

This allows for the manufacturing of the wheeled vehicle seat S that can respectively show the locked state of the lock mechanism 2007 when the first member 2006A and the second member 2006B function as side supports.

The embodiments applicable to the invention related to wheeled vehicle seats are not limited to the embodiments described above and can be appropriately modified without departing from the spirit of the invention related to wheeled vehicle seats.

For example, in the above embodiment, the first member 2006A is provided on the right side of the wheeled vehicle seat S, and the second member 2006B is provided on the left side of the wheeled vehicle seat S, but this is not limited to that.

The first member 2006A may be provided on the upper side of the wheeled vehicle seat S, while the second member 2006B may be provided on the lower side of the wheeled vehicle seat S.

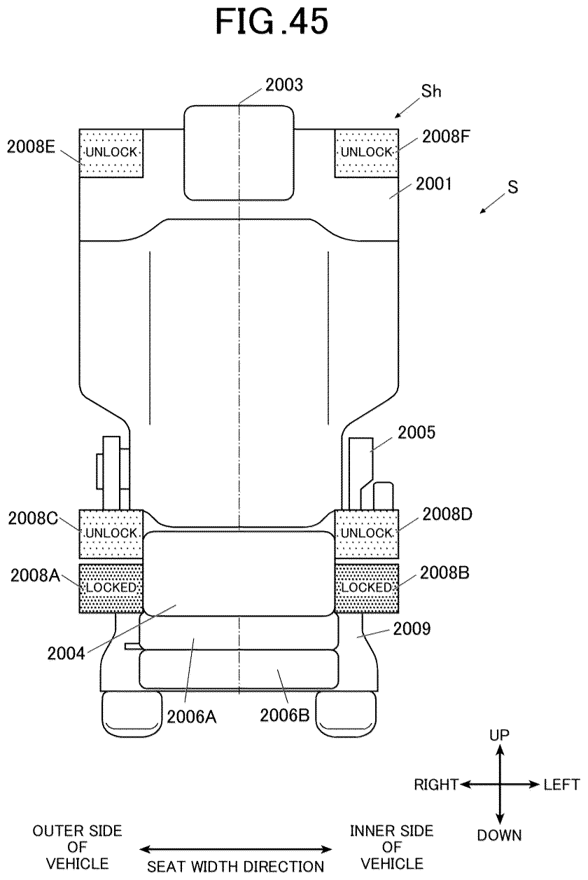

FIG. 45 shows the front view of the wheeled vehicle seat S in the ottoman specification mode in this case.

In addition, the first member 2006A may be provided on the front side of the wheeled vehicle seat S, and the second member 2006B may be provided on the rear side of the wheeled vehicle seat S.

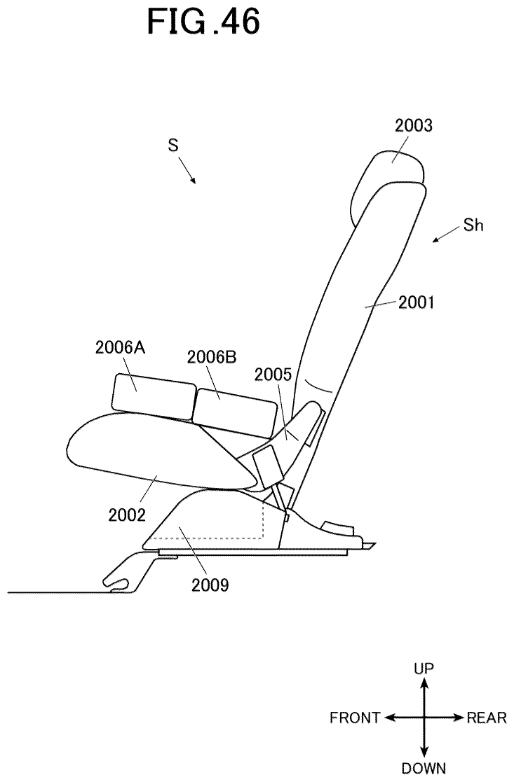

FIG. 46 shows a side view of the wheeled vehicle seat S in armrest specification mode in this case.

In addition, in the above embodiment, the seat back frame 2010 and the seat cushion frame 2020 are described as being pipe frames, but this is not limiting.

The seat back frame 2010 and the seat cushion frame 2020 may be a plate-shaped side frame.

In this case, the lock mechanism 2007 is fixed to the upper surface (or side) of the side frame.

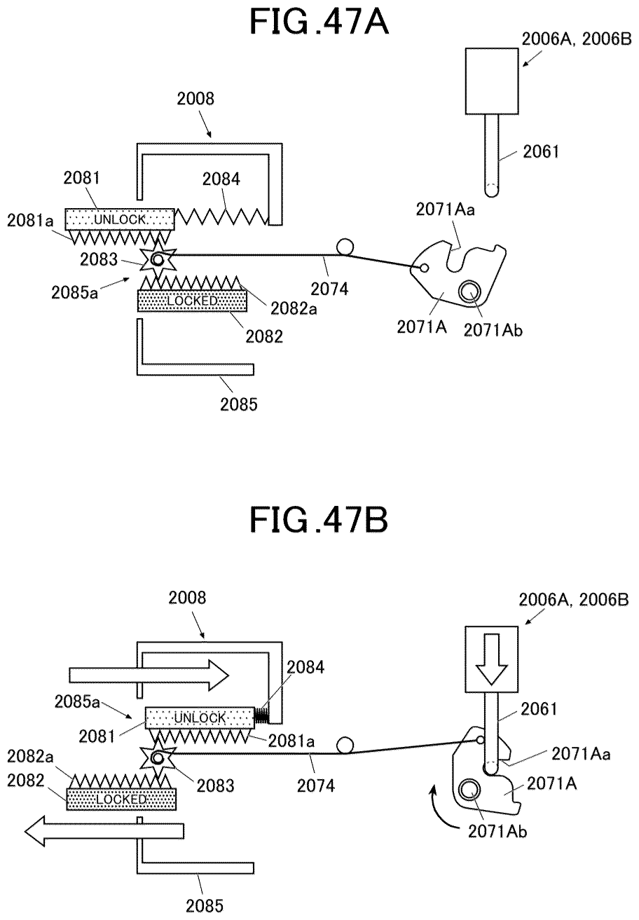

In addition, FIG. 47A shows another example of the lock mechanism 2007 in an unlocked state where the connecting part 2061 is not connected, and the indicator 2008. In addition, FIG. 47B shows another example of the lock mechanism 2007 in a locked state with the connecting part 2061 connected, and the indicator 2008.

In the examples shown in FIG. 47A and FIG. 47B, the lock mechanism 2007 includes a latch 2071A connected to the connecting member 2074.

From the unlocked state shown in FIG. 47A, when the connecting part 2061 is inserted into the engagement groove 2071Aa of the latch 2071A as shown in FIG. 47B, the latch 2071A rotates clockwise around the rotation axis 2071Ab. By rotating the latch 2071A around the rotation axis 2071Ab in a clockwise direction, the connecting member 2074 is pulled towards the latch 2071A side, causing the rotating gear 2083 to rotate clockwise.

At this time, the rotation operation of the rotating gear 2083 is transmitted to the driven gear 2081a, and the unlock display section 2081 is housed in the region covered by the cover member 2085 against the urging force of the urging member 2084.

Then, the rotation operation of the rotating gear 2083 is transmitted to the driven gear 2082a, and the lock display section 2082 exits the area covered by the cover member 2085 from the opening 2085a, displaying “LOCKED.”

### [4] Embodiments Related to Vehicle Seat

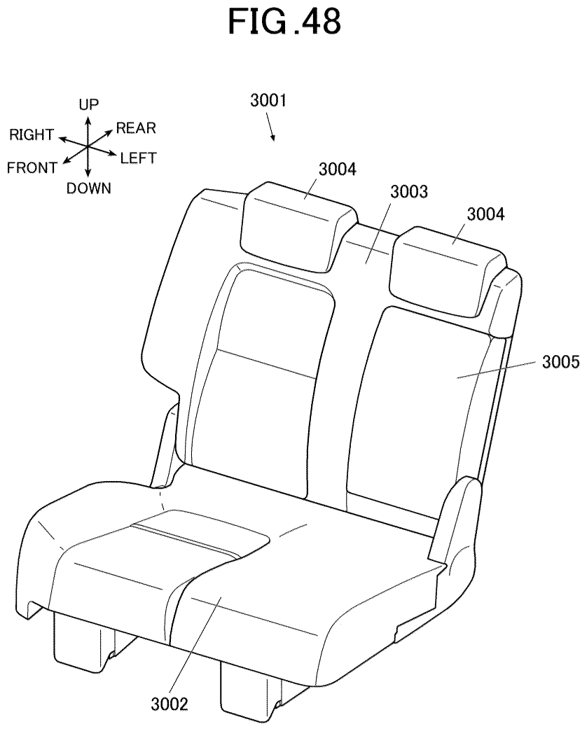

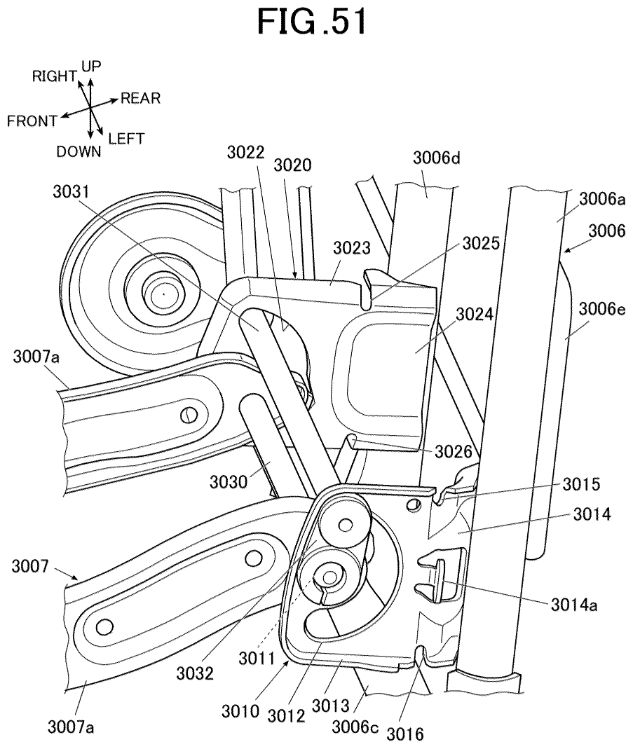

Hereinafter, an embodiment of a vehicle seat will be described with reference to FIG. 48 to FIG. 52. Various limitations that are technically preferable to implement the present invention are added to the embodiments described below. However, the scope of the present invention is not limited to the embodiments and the illustrated examples described below.

The present embodiment has industrial applicability to vehicle seats.

[Background Art of Present Embodiment] Conventionally, vehicle seats are known that are installed in various vehicles, including automobiles, with a space behind the vehicle seat, such as a rear seat or a luggage compartment. The vehicle seat of JP 2001-112576 includes a configuration in which an armrest is held by an armrest bracket joined to a seat back frame. A pin that serves as a rotation axis is provided on the side surface of the armrest so as to protrude laterally, and the armrest bracket is formed with a cutout into which the pin is inserted. The pin can be inserted and removed through a cutout in the armrest bracket, and with this, the armrest can be easily attached and detached from the seat back.

[Problem to be Solved by Present Embodiment] In a case of a vehicle seat installed with a space behind it, if a predetermined load is input from the rear space to the seat back, for example, when a person or luggage bumps into it, the seat back frame may deform. If the seat back frame is deformed in this way, this may also affect the armrest bracket joined to the seat back frame and a mounting state of the armrest held by this armrest bracket.

The present embodiment has been made in consideration of the above circumstances, and an object of the present invention is to prevent the armrest from becoming detached when a predetermined load is input to the seat back frame.

[Solution to Problem] In order to solve the above problems, a vehicle seat according to Solution 1 includes,
a seat back used as a backrest, and
an armrest provided on the seat back so as to be rotatable between a position along the seat back and a position deployed forward,
wherein the armrest includes an armrest frame that serves as a skeleton,
the seat back includes a seat back frame which serves as the skeleton, and an armrest bracket which is joined to the seat back frame and which holds the armrest frame, the armrest frame is rotatably attached to the armrest bracket via a rotating shaft,
the armrest bracket includes,
a rotating shaft hole through which the rotating shaft is inserted,
a regulating part that regulates a rotation range of the armrest frame,
a deformation part provided between the rotating shaft hole and the regulating part, and a joint portion of the armrest bracket to the seat back frame, and
the deformation part deforms so as to follow the armrest when the armrest moves in a case that a predetermined load is applied to the seat back frame.

Solution 2 is the vehicle seat according to Solution 1,
wherein the armrest bracket further includes a first reinforcing part provided on each of one and other sides of the deformation part to reinforce the armrest bracket.

Solution 3 is the vehicle seat according to Solution 2,
wherein the first reinforcing part is a flange formed along an edge of the armrest bracket.

Solution 4 is the vehicle seat according to Solution 2,
wherein the armrest bracket further includes a second reinforcing part that is provided at a position facing the deformation part and that reinforces the armrest bracket.

Solution 5 is the vehicle seat according to Solution 4,
wherein the deformation part and the second reinforcing part are disposed adjacent to each other in an up-down direction.

Solution 6 is the vehicle seat according to Solution 4,
wherein the deformation part includes an upper side deformation part provided on an upper part of the armrest bracket and a lower side deformation part provided on a lower part of the armrest bracket, and
the upper side deformation part and the lower side deformation part are arranged on a same straight line.

Solution 7 is the vehicle seat according to Solution 6,
wherein the second reinforcing part is provided between the upper side deformation part and the lower side deformation part.

Solution 8 is a vehicle seat according to any one of Solutions 1 to 7,
wherein the armrest bracket includes a first bracket that holds one end of the armrest frame in a width direction, and a second bracket that holds the other end of the armrest frame in the width direction, and
the deformation part provided on the first bracket and the deformation part provided on the second bracket are disposed at different positions in a seat front-rear direction.

[Effect of Solution] According to solution 1, when a predetermined load is applied to the seat back frame and the armrest moves, the deformation part of the armrest bracket deforms to follow the armrest, thereby preventing the armrest from detaching from the armrest bracket.

According to solution 2, the position of the armrest bracket where the deformation part is provided becomes easily deformed, making it easier to prevent the armrest from becoming detached from the armrest bracket.

According to solution 3, the rigidity of the armrest bracket can be improved with a relatively simple structure.

According to solution 4, the position of the armrest bracket where the deformation part is provided becomes more easily deformed, making it much easier to prevent the armrest from becoming detached from the armrest bracket.

According to solution 5, the deformation part and the second reinforcing part are aligned vertically, so that the position of the armrest bracket where the deformation part is provided is more likely to deform. It also becomes easier to tune the deformation of the armrest bracket in the up-down direction.

According to solution 6, since the upper side deformation part and the lower side deformation part are arranged on the same straight line, the armrest bracket is easily deformed around the area where the upper side deformation part and the lower side deformation part are arranged.

According to solution 7, the upper side deformation part, the second reinforcing part, and the lower side deformation part are aligned vertically, making the upper and lower parts of the armrest bracket even more susceptible to deformation. It also becomes easier to tune the deformation of the armrest bracket in the up-down direction.

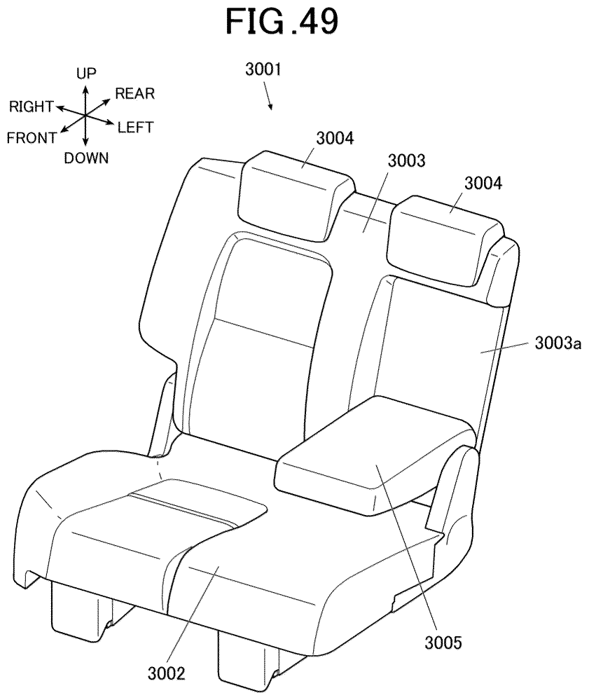

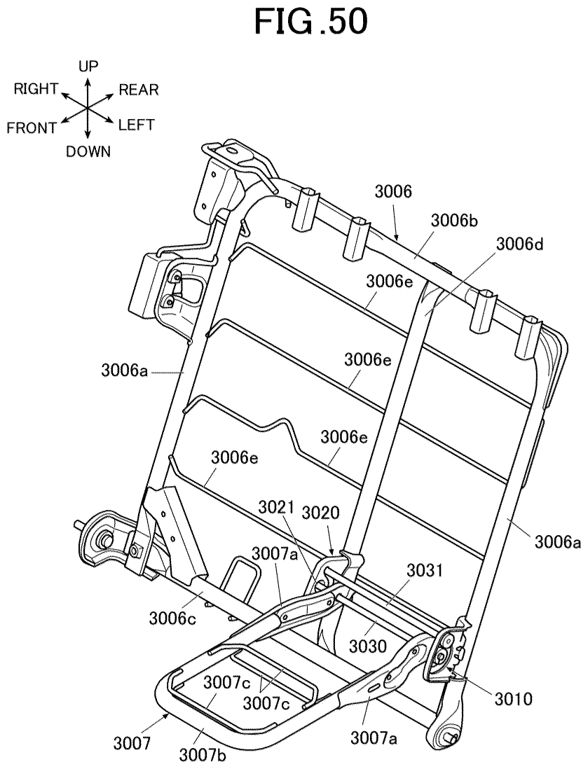

According to solution 8, adjustments can be made so that the amount of deformation is different between the first bracket and the second bracket, making it easier to tune the amount of movement in the width direction when a predetermined load is applied to the seat back frame and the armrest moves.

[Contents of Embodiment Related to Vehicle Seat] In FIG. 48 and FIG. 49, reference numeral 3001 denotes a vehicle seat on which a person sits. This vehicle seat 3001 is a seat to be installed on a floor of the vehicle body of a passenger vehicle. However, the present invention is not limited to this, and may be a seat in other automobiles such as a bus or truck, or a seat in vehicles other than automobiles such as a train, ship, or aircraft.

The vehicle seat 3001 is a two-seater bench seat, and in this embodiment is provided to the rear of the driver's seat. In addition, it is assumed that the seat is provided to be aligned in the left-right direction with a single-seater seat (not shown). In other words, when the vehicle seat 3001 is installed in the vehicle, a single seat (not shown) is arranged adjacent to the vehicle seat 3001 to form a three-seater seat. However, the present invention is not limited to this, and the vehicle seat 3001 may be a three-seater bench seat.

Further, the vehicle seat 3001 of this embodiment is installed on the vehicle body in a state in which a certain amount of space is formed behind it. The space behind the vehicle seat 3001 is, for example, a space formed between the vehicle seat 3001 and a rear seat, or a luggage compartment.

Such a vehicle seat 3001 includes a seat cushion 3002 supporting a person's buttocks and thighs, a seat back 3003 serving as a backrest whose lower end is supported by the seat cushion 3002, two headrests 3004 provided on the seat back 3003 to support the person's head, and armrests 3005 provided on the seat back 3003 to support the person's arms when the seat back 3003 is deployed forward.

In addition, when the two-seater vehicle seat 3001 of this embodiment and a one-seater vehicle seat are arranged side by side to form a three-seater seat, the armrest 3005 is used as a backrest for the seat located in the middle.

The vehicle seat 3001 is composed of a seat frame that serves as a skeleton of the vehicle seat 3001, a cushion pad provided on the seat frame, and a cover that covers the cushion pad and the seat frame.

The seat frame includes a cushion frame that forms the skeleton of the seat cushion 3002, a seat back frame 3006 that forms the skeleton of the seat back 3003, a headrest frame and pillar that form the skeleton of the headrest 3004, and an armrest frame 3007 that forms the skeleton of the armrest 3005.

The seat back 3003 includes a depressed part 3003a formed at a position where the armrest 3005 is provided. The armrest 3005 is stored in such depressed part.

The depressed part 3003a is formed by providing a cushion pad in the seat back frame 3006, avoiding the position where the armrest 3005 is disposed. In other words, when the cushion pad is provided on the seat back frame 3006, it is provided in a position that avoids the position where the armrest 3005 is located, and the area where the cushion pad is not provided is made into the depressed part 3003a in which the armrest 3005 is stored.

As shown in FIG. 48 and FIG. 49, the armrest 3005 is provided on the seat back 3003 so as to be rotatable between a position along the seat back 3003 and a position deployed forward.

That is, the armrest 3005 is disposed along the seat back 3003 and is used as the backrest together with the seat back 3003, and is used as the armrest when deployed forward. For this reason, the armrest frame 3007 is provided with the cushion pad that encases the armrest frame 3007, and is then covered with the cover. As a result, the cushion pad functions as a shock-absorbing material whether the armrest 3005 is used as the backrest or the armrest.

As shown in FIG. 50 to FIG. 52, the seat back frame 3006, which forms the skeleton of the seat back 3003, includes a roughly U-shaped main frame consisting of left and right back side frames 3006a and an upper frame 3006b, a lower frame 3006c suspended between the lower ends of the main frames, a center frame 3006d suspended between the upper frame 3006b and the lower frame 3006c, and a plurality of pressure receiving members 3006e suspended between the left and right back side frames 3006a and the center frame 3006d. The center frame 3006d is disposed at a position slightly to the left side of the center of the upper frame 3006b and the lower frame 3006c in the longitudinal direction.

The armrest frame 3007, which forms the skeleton of the armrest 3005, includes left and right side frames 3007a, a generally U-shaped upper frame 3007b, and a plurality of pressure receiving members 3007c spanning between the left and right frames of the upper frame 3007b, as shown in FIG. 50 to FIG. 52.

The armrest frame 3007 is supported by a plurality of armrest brackets 3010 and 3020 joined to the seat back frame 3006.

More specifically, the plurality of armrest brackets include a first bracket 3010 located on the left side and holding the left end of the armrest frame 3007, and a second bracket 3020 located on the right side and holding the right end of the armrest frame 3007. That is, the armrest frame 3007 is held by a pair of left and right armrest brackets 3010 and 3020.

The first bracket 3010 is joined by welding or the like to the right side surface at the lower end of the back side frame 3006a located on the left side, and the second bracket 3020 is joined by welding or the like to the left side surface at the lower end of the center frame 3006d.

The armrest frame 3007 is rotatably attached to the left and right armrest brackets 3010 and 3020 via a rotating shaft 3030 and a stopper member 3031.

The rotating shaft 3030 and the stopper member 3031 are both rods formed in a cylindrical shape. The rotating shaft 3030 and the stopper member 3031 are provided to span between the left and right armrest brackets 3010, 3020.

The rotating shaft 3030 and the stopper member 3031 are disposed parallel to each other, and both ends in the longitudinal direction are connected to each other by a connecting part 3032. As a result, the stopper member 3031 operates in conjunction with the rotating shaft 3030 and moves in an arc as the rotating shaft 3030 rotates.

First, the first bracket 3010 is formed by processing a metal plate, and protrudes toward the front of the seat from the lower end of the back side frame 3006a located on the left side.

At the tip end in a protruding direction, a rotating shaft hole 3011 is formed to penetrate through such protruding part. The left end of the rotating shaft 3030 is inserted through the rotating shaft hole 3011. Adjacent to the rotating shaft hole 3011, an arc-shaped regulating hole 3012 is formed to similarly penetrate the above protruding part. A stopper member 3031 is inserted through the regulating hole 3012.

The regulating hole 3012 is formed in a substantial C-shape extending from above to below the rotating shaft hole 3011. When the stopper member 3031 abuts against the upper edge of the regulating hole 3012, the armrest 3005 is deployed forward, and when the stopper member 3031 abuts against the lower edge of the regulating hole 3012, the armrest 3005 is stored in a depressed part 3003a.

In this embodiment, the stopper member 3031 is inserted into the regulating hole 3012 and the rotation range of the armrest frame 3007 is regulated by the stopper member 3031 contacting the upper and lower edges of the regulating hole 3012, but the configuration is not limited to this. The rotation range of the armrest frame 3007 may be regulated by other configurations. For example, the rotation range of the armrest frame 3007 may be restricted by contacting an upper side bump and a lower side bump protruding from the right side surface of the first bracket 3010 with the end of the armrest frame 3007.

The first bracket 3010 is provided with a first reinforcing part 3013 from the upper edge, via the front edge, and to the lower edge.

The first reinforcing part 3013 according to the present embodiment is a flange. That is, the upper edge, the front edge, and the lower edge of the first bracket 3010 are bent to form the flange 3013. The flange 3013 functions as a reinforcing part that improves the rigidity of the first bracket 3010.

In this embodiment, the first reinforcing part 3013 is the flange, but the configuration is not limited to this. The first bracket 3010 may be reinforced by providing a rib, a bead, or the like.

The flange 3013 is not formed on the rear edge of the first bracket 3010, but a second reinforcing part 3014 is formed on the rear end side of the first bracket 3010, which bulges the rear end of the first bracket 3010 to the left side. The second reinforcing part 3014 bulges out to the left side, and therefore the right side surface is depressed. In other words, the second reinforcing part 3014 forms unevenness on the rear end side of the first bracket 3010, and the rigidity of the first bracket 3010 is improved by this uneven structure.

The second reinforcing part 3014 also functions as a joint surface for the back side frame 3006a, and the portion that comes into contact with the back side frame 3006a is joined by welding or the like.

In addition, together with the second reinforcing part 3014, the first reinforcing part 3013 is also joined to the back side frame 3006a by welding or the like. That is, the site of the flange as the first reinforcing part 3013 that is located on the rear end side of the upper edge and lower edge of the first bracket 3010 is formed in an arc shape along the outer peripheral surface of the back side frame 3006a and contacts the outer peripheral surface of the back side frame 3006a. Therefore, the site in contact with the outer peripheral surface of the back side frame 3006a is joined by welding or the like.

In addition, a cut-and-raised part 3014a used for attaching the cushion pad or the cover is formed in the center of the location of the first bracket 3010 where the second reinforcing part 3014 is formed.

The first bracket 3010 is formed with deformation parts 3015 and 3016 that deform to follow the armrest 3005 when the armrest 3005 moves in a case that a predetermined load is applied to the seat back frame 3006. In this embodiment, the deformation parts 3015 and 3016 are disposed between the rotating shaft hole 3011 and the regulating hole 3012 of the first bracket 3010, and the joint portion of the first bracket 3010 with the back side frame 3006a.

The specified load refers to the load received from the rear space side of the vehicle seat 3001, and refers to the load that occurs, for example, when luggage or the like in the rear space collides with the seat back 3003 of the vehicle seat 3001 during a frontal collision of the vehicle.

The deformation part in this embodiment includes an upper side deformation part 3015 provided on the upper part of the first bracket 3010 and a lower side deformation part 3016 provided on the lower part of the first bracket 3010.

The upper side deformation part 3015 is a cutout part formed by cutting out the upper edge of the first bracket 3010, and is cut out to be formed in a generally U-shape downward from the upper edge of the first bracket 3010. Such upper side deformation part 3015 divides the flange 3013, which is the first reinforcing part 3013 formed on the upper edge of the first bracket 3010, into front and rear portions. In other words, the first reinforcing part 3013 is provided on both the front and rear sides of the upper side deformation part 3015.

In addition, the upper side deformation part 3015 faces the second reinforcing part 3014. In other words, the second reinforcing part 3014 is disposed ahead the direction extending from the upper side deformation part 3015. That is, the second reinforcing part 3014 is provided adjacent and below the upper side deformation part 3015.

The lower side deformation part 3016 is a cutout part formed by cutting out the lower edge of the first bracket 3010, and is cut out to be formed in a generally U-shape upward from the lower edge of the first bracket 3010. Such lower side deformation n part 3016 divides the flange 3013, which is the first reinforcing part 3013 formed on the lower edge of the first bracket 3010, into front and rear portions. In other words, the first reinforcing part 3013 is provided on both the front and rear sides of the lower side deformation part 3016.

In addition, the lower side deformation part 3016 faces the second reinforcing part 3014. In other words, the second reinforcing part 3014 is disposed ahead the direction extending from the lower side deformation part 3016. That is, the second reinforcing part 3014 is provided adjacent and above the lower side deformation part 3016.

In short, the second reinforcing part 3014 is provided between the upper side deformation part 3015 and the lower side deformation part 3016.

Moreover, the upper side deformation part 3015 and the lower side deformation part 3016 are disposed on the same straight line. The straight line here is an imaginary straight line that extends approximately parallel to the back side frame 3006a. That is, the arrangement direction of the upper side deformation part 3015 and the lower side deformation part 3016 is approximately parallel to the length direction of the back side frame 3006a.

In other words, the distance from the position of the back side frame 3006a (the joint portion of the first bracket 3010 with the seat back frame 3006) to the upper side deformation part 3015 and the distance from the position of the back side frame 3006a to the lower side deformation part 3016 are approximately equal.

Next, the second bracket 3020 will be described. However, since the second bracket 3020 has a similar configuration to the first bracket 3010, a description of the common elements will be omitted or simplified.

The second bracket 3020 is formed by processing a metal plate, and protrudes toward the front of the seat from the lower end of the center frame 3006d.

At the tip end in the protruding direction, a rotating shaft hole 3021 is formed to penetrate through such protruding part. The right end of the rotating shaft 3030 is inserted through the rotating shaft hole 3021. Adjacent to the rotating shaft hole 3021, an arc-shaped regulating hole 3022 is formed to similarly penetrate the above protruding part. A stopper member 3031 is inserted through the regulating hole 3022. When the stopper member 3031 abuts against the upper edge of the regulating hole 3022, the armrest 3005 is deployed forward, and when the stopper member 3031 abuts against the lower edge of the regulating hole 3022, the armrest 3005 is stored in the depressed part 3003a.

The second bracket 3020 is provided with a first reinforcing part 3023 from the upper edge, via the front edge, and to the lower edge. The first reinforcing part 3023 according to the present embodiment is the flange.

The flange 3023 is not formed on the rear edge of the second bracket 3020, but a second reinforcing part 3024 is formed on the rear end side of the second bracket 3020, which bulges the rear end of the second bracket 3020 to the right side. Since the second reinforcing part 3024 bulges out to the right side, the left side is depressed, and this uneven structure improves the rigidity of the second bracket 3020. The second reinforcing part 3024 also functions as a joint surface for the back side frame 3006a, and the portion that comes into contact with the center frame 3006d is joined by welding or the like.

In addition, together with the second reinforcing part 3024, the first reinforcing part 3023 is also joined to the back side frame 3006a by welding or the like. That is, the site of the flange as the first reinforcing part 3023 that is located on the rear end side of the upper edge and lower edge of the second bracket 3020 is formed in an arc shape along the outer peripheral surface of the center frame 3006d and contacts the outer peripheral surface of the center frame 3006d. Therefore, the site in contact with the outer peripheral surface of the center frame 3006d is joined by welding or the like.

The second bracket 3020 is formed with deformation parts 3025 and 3026 that deform to follow the armrest 3005 when the armrest 3005 moves in a case that a predetermined load is applied to the seat back frame 3006. In this embodiment, the deformation parts 3025, 3026 are disposed between the rotating shaft hole 3021 and the regulating hole 3022 of the second bracket 3020, and the joint portion of the second bracket 3020 with the center frame 3006d.

The deformation part in this embodiment includes an upper side deformation part 3025 provided on the upper part of the second bracket 3020 and a lower side deformation part 3026 provided on the lower part of the second bracket 3020.

The upper side deformation part 3025 is a cutout part formed by cutting out the upper edge of the second bracket 3020 in an approximately U-shape, and divides the flange 3023, which is the first reinforcing part 3023 formed on the upper edge of the second bracket 3020, into front and rear portions. In other words, the first reinforcing part 3023 is provided on both the front and rear sides of the upper side deformation part 3025.

In addition, the upper side deformation part 3025 faces the second reinforcing part 3024, and the second reinforcing part 3024 is provided adjacent and below the upper side deformation part 3025.

The lower side deformation part 3026 is a cutout part formed by cutting out the lower edge of the second bracket 3020 in an approximately U-shape, and divides the flange 3023, which is the first reinforcing part 3023 formed on the lower edge of the second bracket 3020, into front and rear portions. In other words, the first reinforcing part 3023 is provided on both the front and rear sides of the lower side deformation part 3026.

In addition, the lower side deformation part 3026 faces the second reinforcing part 3024, and the second reinforcing part 3024 is provided adjacent and above the lower side deformation part 3026.

In short, the second reinforcing part 3024 is provided between the upper side deformation part 3025 and the lower side deformation part 3026.

Moreover, the upper side deformation part 3025 and the lower side deformation part 3026 are disposed on the same straight line. The straight line here is an imaginary straight line that extends approximately parallel to the center frame 3006d. In other words, the arrangement direction of the upper side deformation part 3025 and the lower side deformation part 3026 is approximately parallel to the length direction of the center frame 3006d.

In other words, the distance from the position of the center frame 3006d (the joint portion of the second bracket 3020 with the seat back frame 3006) to the upper side deformation part 3025 and the distance from the position of the center frame 3006d to the lower side deformation part 3026 are approximately equal.

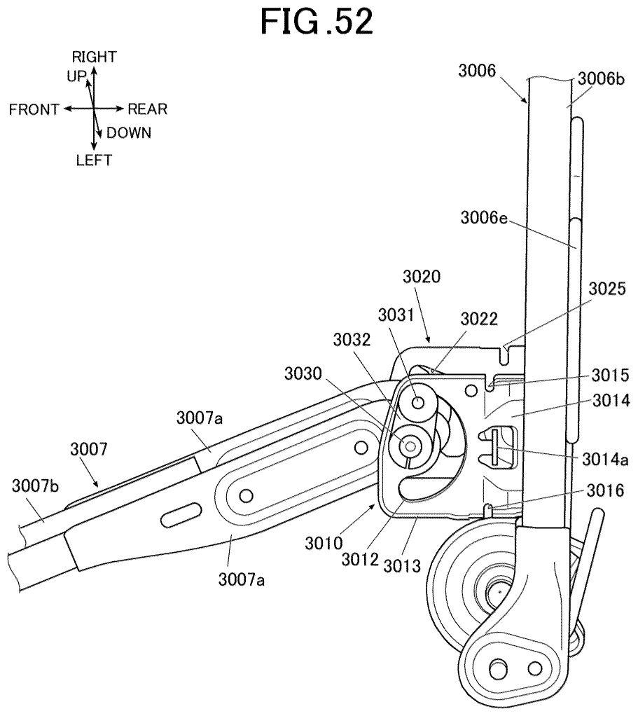

In the vehicle seat 3001 configured as described above, the upper side deformation part 3015 and the lower side deformation part 3016 provided on the first bracket 3010, and the upper side deformation part 3025 and the lower side deformation part 3026 provided on the second bracket 3020 are arranged at different positions in the front-rear direction of the seat, as shown in FIG. 52. That is, the upper side deformation part 3015 and the lower side deformation part 3016 provided on the first bracket 3010 are located to the front than the upper side deformation part 3025 and the lower side deformation part 3026 provided on the second bracket 3020.

In other words, the positions of the upper side deformation part 3015 and the lower side deformation part 3016 relative to the seat back frame 3006 (back side frame 3006a) and the positions of the upper side deformation part 3025 and the lower side deformation part 3026 relative to the seat back frame 3006 (center frame 3006d) are such that the upper side deformation part 3015 and the lower side deformation part 3016 are located more forward. To explain in more detail, if the above-mentioned virtual straight line connecting the upper side deformation part 3015 and the lower side deformation part 3016 in the first bracket 3010 is defined as a first straight line, and the above-mentioned virtual straight line connecting the upper side deformation part 3025 and the lower side deformation part 3026 in the second bracket 3020 is defined as a second straight line, in this embodiment, the positions of the first straight line and the second straight line relative to the seat back frame 3006 are different in the front-rear direction of the seat.

When a predetermined load is input and the first bracket 3010 and the second bracket 3020 are deformed, the deformation occurs from each of the deformation parts 3015, 3016 and 3025, 3026 as starting points. In addition, since the first bracket 3010 and the second bracket 3020 are joined to the seat back frame 3006 by welding or the like, the base end sides are less likely to deform. Therefore, when the first bracket 3010 and the second bracket 3020 are deformed, the sites located to the front of the deformation parts 3015, 3016, 3025, and 3026 move relative to the sites located to the rear of the deformation parts 3015, 3016, 3025, and 3026. When the first bracket 3010 and the second bracket 3020 deform in this manner, the upper side deformation part 3015 and the lower side deformation part 3016 provided on the first bracket 3010 are located to the front of the upper side deformation part 3025 and the lower side deformation part 3026 provided on the second bracket 3020, so that the amount that the first bracket 3010 deforms is less than the second bracket 3020, and the amount that the second bracket 3020 deforms is more than the first bracket 3010. In other words, since it is possible to know in advance how the left and right armrest brackets 3010, 3020 will deform, it is possible to plan in advance the amount of movement of the armrest 3005 that moves when a predetermined load is applied to the seat back frame 3006. Therefore, the amount of movement of the armrest 3005 when the armrest 3005 moves can be tuned in advance and controlled to a certain extent.

The amount of movement of the armrest 3005 when the armrest 3005 moves can be tuned in advance not only by changing the position of each deformation part 3015, 3016 and 3025, 3026 in the first bracket 3010 and the second bracket 3020, but also by changing the cutout length and shape of each deformation part 3015, 3016 and 3025, 3026. Furthermore, in this embodiment, the deformation parts 3015, 3016 and 3025, 3026 are formed on the top and bottom of the first bracket 3010 and the second bracket 3020, but a configuration in which the deformation parts 3015 (3016) and 3025 (3026) are formed on either the top or bottom may also be adopted.

In this embodiment, the armrest frame 3007 is held by the left and right armrest brackets 3010, 3020, but the number of armrest brackets may be one. The armrest 3005 shown in FIG. 48 and FIG. 49 is used as a backrest, so its dimension in the left-right width direction is set to be long, but if it is used only to support a person's arms, the dimension in the left-right width direction may be shorter (narrower). When such a narrow armrest is used in the vehicle seat, the number of armrest brackets may be one. In this case, it goes without saying that the armrest frame, which is the skeleton of the armrest, is also configured to correspond to the single armrest bracket.

In the vehicle seat 3001 configured as described above, when a predetermined load is input to the seat back frame 3006 from the rear space, the armrest 3005 held by the armrest brackets 3010, 3020 will move as the seat back frame 3006 deforms.

In such a case, the armrest brackets 3010 and 3020 are deformed first from the deformation parts 3015, 3016 and 3025, 3026 that deform so as to follow the movement of the armrest 3005. In other words, the deformation parts 3015, 3016 and 3025, 3026 are the weakest points (weakened parts) of the armrest brackets 3010, 3020, and serve as the starting points for deformation of the armrest brackets 3010, 3020. Furthermore, by deforming the armrest brackets 3010, 3020 in this manner, strong forces associated with the deformation of the seat back frame 3006 are less likely to be applied to the rims of the rotating shaft holes 3011, 3021 through which the rotating shaft 3030 is inserted, and to the rims of the regulating holes 3012, 3022 through which the stopper member 3031 is inserted. Therefore, the armrest frame 3007 that forms the skeleton of the armrest 3005 is less likely to detach from the armrest brackets 3010 and 3020.

According to this embodiment, the following excellent effects are obtained.

That is, the armrest brackets 3010, 3020 which are joined to the seat back frame 3006 and hold the armrest frame 3007 include rotating shaft holes 3011, 3021 through which the rotating shaft 3030 is inserted, regulating parts 3012, 3022 which regulate the rotation range of the armrest frame 3007, and deformation parts 3015, 3016 and 3025, 3026 provided between the rotating shaft holes 3011, 3021 and the regulating parts 3012, 3022, and the joint portions of the armrest brackets 3010, 3020 with respect to the seat back frame 3006. Since the deformation parts 3015, 3016 and 3025, 3026 deform to follow the armrest 3005 when the armrest 3005 moves in a case that a predetermined load is applied to the seat back frame 3006, when the armrest 3005 moves in a case that a predetermined load is applied to the seat back frame 3006, the deformation parts 3015, 3016 and 3025, 3026 of the armrest brackets 3010, 3020 deform to follow the armrest 3005, thereby preventing the armrest 3005 from detaching from the armrest brackets 3010, 3020.

In addition, the armrest brackets 3010, 3020 further include first reinforcing parts 3013, 3023 provided on one side and the other side of the deformation parts 3015, 3016 and 3025, 3026 to reinforce the armrest brackets 3010, 3020. This makes it easier for the armrest brackets 3010, 3020 to deform at the positions where the deformation parts 3015, 3016 and 3025, 3026 are provided, making it easier to prevent the armrest 3005 from detaching from the armrest brackets 3010, 3020.

Furthermore, since the first reinforcing parts 3013, 3023 are flanges formed along the edges of the armrest brackets 3010, 3020, the rigidity of the armrest brackets 3010, 3020 can be improved with a relatively simple structure.

In addition, the armrest brackets 3010, 3020 further include second reinforcing parts 3014, 3024 that are provided at positions opposite the deformation parts 3015, 3016 and 3025, 3026 and reinforce the armrest brackets 3010, 3020. This makes the positions of the armrest brackets 3010, 3020 where the deformation parts 3015, 3016 and 3025, 3026 are provided even more susceptible to deformation, making it even easier to prevent the armrest 3005 from detaching from the armrest brackets 3010, 3020.

Furthermore, since the deformation parts 3015, 3016, 3025, 3026 and the second reinforcing parts 3014, 3024 are arranged adjacent to each other in the up-down direction, the deformation parts 3015, 3016, 3025, 3026 and the second reinforcing parts 3014, 3024 are lined up vertically, making the positions of the armrest brackets 3010, 3020 where the deformation parts 3015, 3016, 3025, 3026 are provided even more susceptible to deformation. In addition, it becomes easier to tune the deformation of the armrest brackets 3010, 3020 in the up-down direction.

In addition, the deformation parts 3015, 3016 and 3025, 3026 have upper side deformation parts 3015, 3025 provided on the upper part of the armrest brackets 3010, 3020, and lower side deformation parts 3016, 3026 provided on the lower part of the armrest brackets 3010, 3020, and since the upper side deformation parts 3015, 3025 and the lower side deformation parts 3016, 3026 are arranged on the same straight line, the armrest brackets 3010, 3020 are easily deformed around the areas where the upper side deformation parts 3015, 3025 and the lower side deformation parts 3016, 3026 are arranged.

In addition, since the second reinforcing parts 3014, 3024 are provided between the upper side deformation parts 3015, 3025 and the lower side deformation parts 3016, 3026, the upper side deformation parts 3015, 3025, the second reinforcing parts 3014, 3024, and the lower side deformation parts 3016, 3026 are aligned vertically, making the upper and lower parts of the armrest brackets 3010, 3020 even easier to deform. In addition, it becomes easier to tune the deformation of the armrest brackets 3010, 3020 in the up-down direction.

In addition, the armrest brackets 3010, 3020 include a first bracket 3010 that holds one widthwise end of the armrest frame 3007, and a second bracket 3020 that holds the other widthwise end of the armrest frame 3007. Since the deformation parts 3015, 3016 provided on the first bracket 3010 and the deformation parts 3025, 3026 provided on the second bracket 3020 are arranged at different positions in the front-rear direction of the seat, adjustments can be made so that the first bracket 3010 and the second bracket 3020 have different amounts of deformation, making it easier to tune the amount of movement in the width direction when a predetermined load is applied to the seat back frame 3006 and the armrest 3005 moves.

### Industrial Applicability

The present invention has industrial applicability to seat back frames.

### REFERENCE SIGNS LIST

11, 12 headrest frame
13, 14 armrest bracket
15, 15B first belt guide
151 arm part
152, 152D insertion part
16 second belt guide
161 arm part
162, 162E insertion part
17 tether member
18 set bracket
20, 20A, 20C pipe frame
21 to 24 first to fourth pipe members
211 left frame part
212 right frame part
213 upper frame part
221 flat part
231A, 231C, 232A, 232C bending part
30 panel frame
32 opening
33 undulating connecting part
34 cutout
35 cutout
40, 40G support bracket
41 support part
42 connecting part
421 reinforcing part
43 volt
50 mounting bracket
51 mounting surface
52 cutout
100, 100A, 100C to 100G seat back frame
301 flange part
311 first reinforcing part
311a through hole
312 first joint reinforcing part
313 periphery reinforcing part
314 second joint reinforcing part
315 step reinforcing part
316 third joint reinforcing part
317 fourth joint reinforcing part
318 fifth joint reinforcing part
319 second reinforcing part
421 reinforcing part
B seat belt retractor
B1 seat belt
B2 insertion guide
B3 center
P1 to P4 first to fourth sites

1. A seat back frame comprising:
a first belt guide through which a seat belt reeled out from a seat belt retractor is inserted; and
a second belt guide which is separate from the first belt guide, and through which the seat belt reeled out from the seat belt retractor is inserted.

2. The seat back frame according to claim 1,
further comprising a pipe frame,
wherein the first belt guide and the second belt guide are attached along a pipe peripheral surface of the pipe frame.

3. The seat back frame according to claim 2, wherein,
the first belt guide and the second belt guide are both made of a U-shaped wire,
the first belt guide and the second belt guide are both attached such that one end and the other end of the wire are attached along a pipe peripheral surface of the pipe frame, and
in a case that one side of the seat back frame is to be front and the other side is to be rear, an insertion part of the seat belt of the first belt guide extends to a front side than a center of the seat belt retractor, and the insertion part of the seat belt of the second belt guide does not extend to the front side than the center of the seat belt retractor.

4. The seat back frame according to claim 2, wherein,
the first belt guide and the second belt guide are both made of a U-shaped wire,
in a case that one side of the seat back frame is to be front and the other side is to be rear, the first belt guide and the second belt guide are both attached such that one end and the other end of the wire are attached along a pipe peripheral surface of the pipe frame, and
an end of the first belt guide on a side of the insertion part of the seat belt extends to a front side from an upper part of the pipe peripheral surface of the pipe frame, and an end of the second belt guide on the side of the insertion part of the seat belt extends to a front side from a lower part of the pipe peripheral surface of the pipe frame.

5. The seat back frame according to claim 4, wherein the first belt guide and the second belt guide are made of members having the same shape.

6. The seat back frame according to claim 2, wherein,
the pipe frame is provided along an outer edge of the seat back frame,
a connecting member is disposed along an up-down direction on an inner side of the pipe frame, and
the connecting member is bent so as to bypass the first belt guide or the second belt guide, and an upper end of the connecting member is connected to the pipe frame.

7. The seat back frame according to claim 2, wherein the first belt guide and the second belt guide are formed as a single integrated member.

8. The seat back frame according to claim 2,
further comprising a panel frame joined to the pipe frame,
wherein the panel frame includes an evacuation part to avoid the first belt guide and the second belt guide with respect to a mounting part of the first belt guide and the second belt guide in the pipe frame.
